(19) United States
(12) Patent Application Publication
(10) Pub. No.: US 2026/0329055 A1
(43) Pub. Date: Oct. 22, 2026

(54) OPTICAL SYSTEM AND CAMERA MODULE

(71) Applicant: LG INNOTEK CO., LTD., Seoul (KR)

(72) Inventors: Sung Jin PARK, Seoul (KR); Chang Gyun SON, Seoul (KR); Jun Young LIM, Seoul (KR); Se Yeon CHOI, Seoul (KR)

(21) Appl. No.: 19/104,333

(22) PCT Filed: Aug. 11, 2023
(86) PCT No.: PCT/KR2023/011979

§ 371 Date: Feb. 17, 2025

(30) Foreign Application Priority Data
Aug. 16, 2022 (KR) 10-2022-0102329

(51) Int. Cl. G02B 13/00; G02B 1/04; G02B 3/00; G02B 7/02; G02B 9/64; G03B 17/12; G03B 30/00

(52) U.S. Cl. CPC G02B 13/0045; G02B 1/041; G02B 7/025; G02B 9/64; G02B 13/006; G03B 17/12; G03B 30/00; G02B 2003/0093

(57) ABSTRACT

The optical system disclosed in the embodiment of the invention includes first to seventh lenses aligned along an optical axis from an object side toward a sensor side, a refractive power of the first lens is negative and a composite refractive power of the third to seventh lenses is positive, the first lens has a meniscus shape convex toward the sensor side on the optical axis, a center thickness of the first lens is larger than a center thickness of each of the second to seventh lenses, the first to seventh lenses include a plurality of aspherical lenses, each of the plurality of aspherical lenses can have a meniscus shape convex toward the object side on the optical axis.

### CROSS-REFERENCE TO RELATED APPLICATIONS

This application is the U.S. national stage application of International Patent Application No. PCT/KR2023/011979, filed Aug. 11, 2023, which claims the benefit under 35 U.S.C. § 119 of Korean Application No. 10-2022-0102329, filed Aug. 16, 2022, the disclosures of each of which are incorporated herein by reference in their entirety.

### TECHNICAL FIELD

An embodiment relates to an optical system for improved optical performance and a camera module comprising same.

### BACKGROUND ART

ADAS (Advanced Driving Assistance System) is an advanced driver assistance system for assisting the driver to drive and is composed of sensing the situation in front, determining the situation based on the sensed result, and controlling the behavior of the vehicle based on the situation determination. For example, the ADAS sensor device detects a vehicle ahead and recognizes a lane. Then, when the target lane or target speed and the target in front are determined, the vehicle's ESC (Electrical Stability Control), EMS (Engine Management System), MDPS (Motor Driven Power Steering), etc. are controlled. Typically, ADAS may be implemented as an automatic parking system, a low-speed city driving assistance system, a blind spot warning system, and the like. The sensor devices for sensing the forward situation in ADAS are a GPS sensor, a laser scanner, a front radar, and a lidar, and the most representative is a front camera for photographing the front of the vehicle.

These cameras can be placed outside or inside the vehicle to detect the surroundings of the vehicle. In addition, the cameras can be placed inside the vehicle to detect the situations of the driver and passengers. For example, the camera can photograph the driver at a location adjacent to the driver and detect the driver's health status, whether he or she is drowsy, whether he or she is drinking, etc. In addition, the camera can photograph the passenger at a location adjacent to the passenger and detect whether the passenger is sleeping, health status, etc., and provide the driver with information about the passenger.

Especially, the most important element for the camera module to obtain an image is an imaging lens that forms an image. Recently, interest in high efficiency such as high image quality and high resolution is increasing, and research on an optical system including plurality of lenses is being conducted in order to realize this. However, there is a problem that the characteristics of the optical system change when the camera is exposed to harsh environments, such as high temperature, low temperature, moisture, and high humidity, outside or inside the vehicle. In this case, the camera has a problem that it is difficult to uniformly derive excellent optical characteristics and aberration characteristics. Therefore, a new optical system and camera that can solve the above-described problems are required.

### DISCLOSURE

### Technical Problem

An embodiment of the invention provides an optical system and a camera module with improved optical characteristics. The embodiment provides an optical system and a camera module that inhibits changes in optical characteristics in low-temperature to high-temperature environments and has excellent optical performance.

An embodiment of the invention provides a camera module in which an inner barrel is dually disposed in at least a portion of an outer barrel. An embodiment provides a camera module having heterogeneous barrels disposed around different lenses, for example, a first barrel in contact with an outer surface of at least one lens and a second barrel in contact with an outer surface of at least one lens.

An embodiment of the invention may provide a camera module having a first barrel in contact with an outer surface of a lens of a first material and a second barrel in contact with an outer surface of a lens different from the first material. The embodiment of the invention may provide a camera module having a first barrel in contact with an outer surface of a plurality of lenses adjacent to an object side and a second barrel in contact with an outer surface of a lens adjacent to a sensor side. An embodiment of the invention can provide a camera module in which a second barrel of a second material is arranged on the sensor side of a first barrel of a first material, and lenses are stacked within the first and second barrels.

An embodiment of the invention can provide a mobile device and a vehicle having a camera module.

### Technical Solution

An optical system according to an embodiment of the invention comprises first to seventh lenses aligned along an optical axis from an object side toward a sensor side, wherein a refractive power of the first lens is negative, and a composite refractive power of the third to seventh lenses is positive, the first lens has a meniscus shape convex toward the sensor side on the optical axis, a center thickness of the first lens is greater than a center thickness of each of the second to seventh lenses, and the first to seventh lenses include a plurality of aspherical lenses, and each of the plurality of aspherical lenses may have a meniscus shape convex toward the object side on the optical axis.

According to an embodiment of the invention, an effective diameter of the first lens may be greater than effective diameters of the fourth to seventh lenses. An aperture stop may be disposed on a periphery between the second lens and the third lens. The plurality of aspherical lenses may be disposed closer to an image sensor than the aperture stop. The first to seventh lenses are made of glass, and a number of lenses having spherical object-side and sensor-side surfaces may be at least twice a number of lenses having aspherical object-side and sensor-side surfaces. The first to fifth lenses may be spherical lenses. The sensor-side surface of the fourth lens and the object-side surface of the fifth lens may be bonded.

According to an embodiment of the invention, the center distance between an i-th lens and an i+1 lens is CGi, the center thickness of the i-th lens is CTi, and a value of CTi/CGi may be minimum when i is 2. The value of CTi/CGi may be maximum when i is 1.

According to an embodiment of the invention, a center thickness of the first lens is CT1, and an optical axis distance from a center of the object-side surface of the first lens to a surface of the image sensor is TTL, and the following Equation may satisfy: 0<CT1/TTL<0.25. The center thickness of the first lens is CT1, the center distance between the second and third lenses is CG2, and the following Equation may satisfy: 2<CT1/CG2<5.

A camera module according to an embodiment of the invention comprises: an image sensor; and first to seventh lenses aligned along an optical axis from an object side toward a sensor side; an aperture stop disposed between spherical lenses among the first to seventh lenses; an optical filter disposed between the seventh lens and the image sensor, wherein the first lens has a meniscus shape convex toward the sensor side on the optical axis, the first and seventh lenses have negative refractive power, a composite refractive power of the third to seventh lenses is positive, and a cemented lens of the second to seventh lenses is disposed between the aperture stop and the seventh lens and is bonded to each other, wherein the cemented lens has a convex object-side surface and a concave sensor-side surface on the optical axis, and the first to seventh lenses include a plurality of aspherical lenses, and the plurality of aspherical lenses are arranged closer to the image sensor than the aperture stop, and the object-side surface and the sensor-side surface of the first to fifth lenses may have spherical shapes.

According to the invention, the aperture stop is disposed on a periphery between the second lens and the third lens, and the object-side surface and the sensor-side surface of the sixth and seventh lenses may have aspherical shapes.

A camera module according to an embodiment of the invention comprises a first lens group having a plurality of lenses; a second lens group having at least one lens; a first barrel disposed around the first lens group; and a second barrel disposed between the first barrel and the second lens group, wherein the lenses of the first lens group and the lenses of the second lens group are aligned on an optical axis, and the first barrel and the second barrel are made of different materials, and the materials of the first lens group and the lenses of the second lens group are different from each other, and the lens material of the second lens group may be the same material as the material of the second barrel.

According to an embodiment of the invention, the second barrel and the lens material of the second lens group may be a plastic material. The first barrel may be made of aluminum, the second barrel may be made of plastic, and at least two or more lenses disposed on the object side among the lenses disposed inside the first barrel may be made of glass, and the lenses disposed inside the second barrel may include two plastic lenses. A cemented lens is included between the glass lenses and the plastic lenses, wherein an object-side lens in the cemented lens is spaced apart from the inner surface of the first barrel, the sensor-side lens in the cemented lens is in contact with the inner surface of the second barrel, and the cemented lens may be made of glass. A vehicle or a portable terminal according to an embodiment of the invention may include the camera module disclosed above.

### Advantageous Effects

The optical system and camera module according to the embodiment may have improved optical characteristics. Specifically, in the optical system according to the embodiment, a plurality of lenses may have set thicknesses, refractive powers, and distances with adjacent lenses. Accordingly, the optical system and camera module according to the embodiment may have improved MTF characteristics, aberration control characteristics, resolution characteristics, etc. in a set field of view range, and may have good optical performance in the periphery of the field of view.

In addition, the optical system and camera module according to the embodiment may have good optical performance in a temperature range of low temperature (about −20 ° C to −40 ° C) to high temperature (85 ° C to 105 ° C). Specifically, a plurality of lenses included in the optical system may have set materials, refractive powers, and refractive indices. Accordingly, even when the focal length of each lens changes due to a change in refractive index according to a change in temperature, the lenses may mutually compensate for each other. That is, the optical system may effectively perform distribution of refractive power in a temperature range of low temperature to high temperature, and inhibit or minimize changes in optical characteristics in a temperature range of low temperature to high temperature. Therefore, the optical system and camera module according to the embodiment can maintain improved optical characteristics in various temperature ranges.

In addition, the optical system and camera module according to the embodiment can satisfy the set field of view and implement excellent optical characteristics by mixing an aspherical lens and a spherical lens. As a result, the optical system can provide a slimmer vehicle camera module. Therefore, the optical system and camera module can be provided for various applications and devices, and can have excellent optical characteristics even in a harsh temperature environment, for example, when exposed to the outside of a vehicle or inside a vehicle at high temperatures in the summer.

According to the embodiment of the invention, a camera module can be provided that can maintain resolution according to temperature changes by stacking lenses in a heterogeneous barrel.

That is, a camera module having a heterogeneous barrel can minimize stress and decenter of a plastic lens according to temperature changes. A camera module can be provided that can maintain resolution according to temperature changes and suppress temperature deformation by providing heterogeneous lenses in a heterogeneous barrel. It can improve the optical reliability of the camera module and improve the reliability of a vehicle camera device having a camera module.

### DESCRIPTION OF DRAWINGS

FIG. 1 is a side cross-sectional view of an optical system according to the first embodiment and a camera module having the same.

FIG. 2 is a side cross-sectional view for explaining the relationship between the n-th and n-1th lenses according to FIG. 1.

FIG. 3 is a table showing lens characteristics of the optical system of FIG. 1.

FIG. 4 is a table showing aspherical coefficients of lenses in the optical system of FIG. 1.

FIG. 5 is a table showing thicknesses of each lens and spacing between adjacent lenses in the optical system of FIG. 1.

FIG. 6 is a table showing CRA (Chief ray angle) data at room temperature, low temperature, and high temperature according to the position of the image sensor in the optical system of FIG. 1.

FIG. 7 is a graph showing data on the diffraction MTF (Modulation Transfer Function) of the optical system of FIG. 1 at room temperature.

FIG. 8 is a graph showing data on the diffraction MTF of the optical system of FIG. 1 at low temperature.

FIG. 9 is a graph showing data on the diffraction MTF of the optical system of FIG. 1 at high temperature.

FIG. 10 is a graph showing data on the aberration characteristics of the optical system of FIG. 1 at room temperature.

FIG. 11 is a graph showing data on the aberration characteristics of the optical system of FIG. 1 at low temperature.

FIG. 12 is a graph showing data on the aberration characteristics of the optical system of FIG. 1 at high temperature.

FIG. 13 is a side cross-sectional view of an optical system according to the second embodiment and a camera module having the same.

FIG. 14 is a table showing lens characteristics of the optical system of FIG. 13.

FIG. 15 is a table showing aspherical coefficients of lenses in the optical system of FIG. 13.

FIG. 16 is a table showing the thickness of each lens of the optical system of FIG. 13 and the spacing between adjacent lenses.

FIG. 17 is a table showing CRA data at room temperature, low temperature, and high temperature according to the position of the image sensor in the optical system of FIG. 13.

FIG. 18 is a graph showing data on the diffraction MTF of the optical system of FIG. 13 at room temperature.

FIG. 19 is a graph showing data on the aberration characteristics of the optical system of FIG. 13 at room temperature.

FIG. 20 is a graph showing relative illuminance according to the height of the image sensor according to an embodiment.

FIG. 21 is an example of a cross-sectional side view of a camera module according to a third embodiment of the invention.

FIG. 22 is a drawing showing a sensor-side area of the first barrel in the camera module of FIG. 21.

FIG. 23 is a drawing explaining the combination of the second barrel and the sensor-side lenses of the camera module of FIG. 22.

FIG. 24 is a drawing explaining the second barrel of FIG. 22.

FIGS. 25(A) and 25(B) are examples of combining lenses to the second barrel of FIG. 22.

FIG. 26 is another example of the second barrel in the camera module of FIG. 21.

FIG. 27 is a drawing explaining a first gap G1 between the outermost side of the second barrel and the inner side of the first barrel in the camera module of the third embodiment of the invention.

FIG. 28 is a drawing explaining a second gap G2 between the object-side surface of the second barrel and the sensor-side lens having a different material from the second barrel in the camera module of the third embodiment of the invention.

FIG. 29 is a drawing explaining a third gap G3 between the outer surface of the second barrel and the first barrel in the camera module of the third embodiment of the invention.

FIGS. 30(A)-31(D) are drawings explaining a process of combining the camera module of FIG. 21.

FIG. 32 is an example of a vehicle having an optical system according to an embodiment of the invention.

### BEST MODE

Hereinafter, preferred embodiments of the invention will be described in detail with reference to the accompanying drawings. A technical spirit of the invention is not limited to some embodiments to be described, and may be implemented in various other forms, and one or more of the components may be selectively combined and substituted for use within the scope of the technical spirit of the invention. In addition, the terms (including technical and scientific terms) used in the embodiments of the invention, unless specifically defined and described explicitly, may be interpreted in a meaning that may be generally understood by those having ordinary skill in the art to which the invention pertains, and terms that are commonly used such as terms defined in a dictionary should be able to interpret their meanings in consideration of the contextual meaning of the relevant technology.

The terms used in the embodiments of the invention are for explaining the embodiments and are not intended to limit the invention. In this specification, the singular forms also may include plural forms unless otherwise specifically stated in a phrase, and in the case in which at least one (or one or more) of A and (and) B, C is stated, it may include one or more of all combinations that may be combined with A, B, and C. In describing the components of the embodiments of the invention, terms such as first, second, A, B, (a), and (b) may be used. Such terms are only for distinguishing the component from other component, and may not be determined by the term by the nature, sequence or procedure etc. of the corresponding constituent element. And when it is described that a component is “connected”, “coupled” or “joined” to another component, the description may include not only being directly connected, coupled or joined to the other component but also being “connected”, “coupled” or “joined” by another component between the component and the other component. In addition, in the case of being described as being formed or disposed “above (on)” or “below (under)” of each component, the description includes not only when two components are in direct contact with each other, but also when one or more other components are formed or disposed between the two components. In addition, when expressed as “above (on)” or “below (under)”, it may refer to a downward direction as well as an upward direction with respect to one element.

In the description of the invention, “object-side surface” may refer to a surface of the lens facing the object side with respect to the optical axis OA, and “sensor-side surface” may refer to a surface of the lens facing the imaging surface (image sensor) with respect to the optical axis. A convex surface of the lens may mean a convex shape on the optical axis or paraxial region, and a concave surface of the lens may mean a concave shape on the optical axis or paraxial region.

A curvature radius, center thickness, and distance between lenses described in the table for lens data may mean values on the optical axis, and the unit is mm. The vertical direction may mean a direction perpendicular to the optical axis, and an end of the lens or the lens surface may mean the end or edge of the effective region of the lens through which the incident light passes. The size of the effective diameter on the lens surface may have a measurement error of up to +0.4 mm depending on the measurement method. The near-axis region refers to a very narrow region near the optical axis, and is a region where the distance a light ray falls from the optical axis OA is almost 0. Hereinafter, the optical axis may include the center of each lens or a very narrow region near the optical axis.

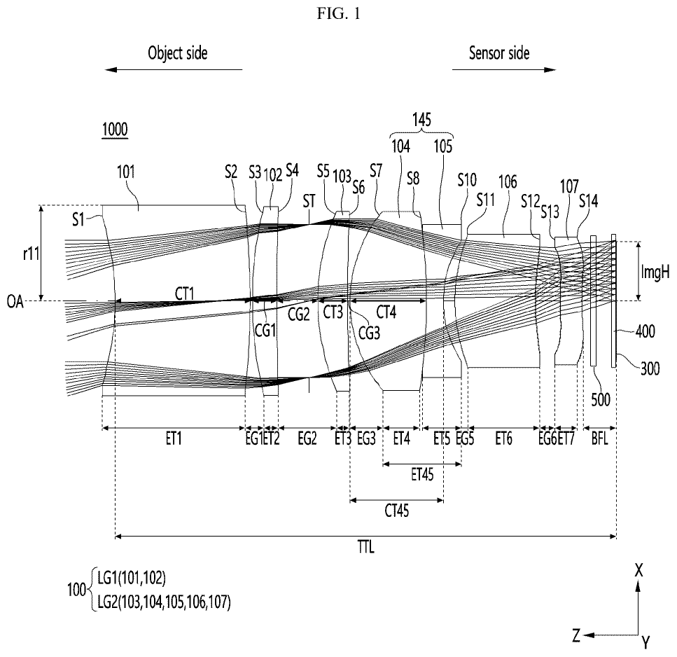

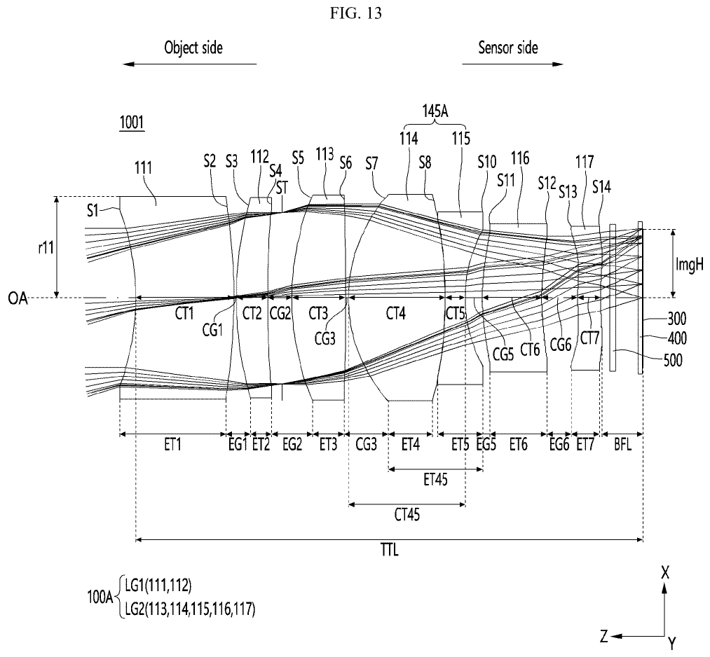

As shown in FIG. 1 and FIG. 13, the optical system 1000 and 1001 according to the first and second embodiments of the invention may include a plurality of lens groups LG1 and LG2. In detail, each of the plurality of lens groups LG1 and LG2 includes at least one lens. For example, the optical system 1000 and 1001 may include a first lens group LG1 and a second lens group LG2 sequentially arranged along the optical axis OA from the object side toward the image sensor 300. The number of lenses of each of the first lens group LG1 and the second lens group LG2 may be different from each other. The number of lenses of the second lens group LG2 may be greater than the number of lenses of the first lens group LG1, and may be, for example, more than four times or more than five times the number of lenses of the first lens group LG1.

The first lens group LG1 may include at least one lens. The first lens group LG1 may have three or less lenses. The first lens group LG1 may preferably include one or two lenses. The second lens group LG2 may include two or more lenses. The second lens group LG2 may include four or more lenses, and preferably five lenses. The optical system 1000 and 1001 may include n lenses, the n-th lens may be the last lens, and the n−1th lens may be the lens closest to the last lens. The n is an integer greater than or equal to 5, for example, 5 to 8.

When the first lens group LG1 is two lenses on the object side and the second lens group LG2 is the remaining lenses, the composite focal length of the first lens group LG1 can be defined as F_LG1, and when the composite focal length of the second lens group LG2 is F_LG2, the following condition in an absolute value satisfies: F_LG2<F_LG1, and the first embodiment may satisfy: F_LG1>0, F_LG2>0, and the second embodiment may satisfy: F_LG1<0 and F_LG2>0. In contrast, when the first lens group LG1 is a single lens on the object side and the second lens group LG2 is the remaining lenses, the focal length of the first lens group LG1 may be defined as F_LG1, and when the composite focal length of the second lens group LG2 is F_LG2, the following condition satisfies: |F_LG2|<|F_LG1|, and may satisfy: F_LG1<0 and F_LG2>0.

At least one or all of the lenses of the first lens group LG1 may include a glass lens. At least one or all of the lenses of the second lens group LG2 may include a glass lens. Such a glass material has a small amount of expansion and contraction change due to external temperature change, and the surface is not easily scratched, so that surface damage can be inhibited. The second lens group LG2 may include four or more glass lenses, and may include, for example, four to seven glass lenses. The lenses of the first and second lens groups LG1 and LG2 may all be glass lenses, and the lenses of the glass materials have a smaller amount of expansion and contraction due to temperature change than those of the plastic materials, and can inhibit deterioration of optical characteristics through heat compensation. As another example, one or two lenses closest to the image sensor 300 among the lenses of the second lens group LG2 may be made of plastic or may be provided as aspherical lenses.

The lenses of the first lens group LG1 may be spherical lenses. The lenses of the second lens group LG2 may include at least one aspherical lens and two or more spherical lenses. The aspherical lens is a lens whose object-side surface and the sensor-side surface are aspherical, and the spherical lens is a lens whose object-side surface and the sensor-side surface are spherical. The number of spherical lenses in the second lens group LG2 may be greater than the number of aspherical lenses. The aspherical lenses may inhibit spherical aberration within the optical system 1000 and 1001, and since aberration does not occur even if the effective diameter increases, the camera module may be miniaturized and made lighter. The lenses of the second lens group LG2 may include at least one non-mold material and at least one mold material. The aspherical lens may be a glass mold material. For example, in the second lens group LG2, the number of lenses of the glass non-mold material may be greater than the number of lenses of the glass mold material. The non-mold material and the mold material may both be glass materials, and the non-mold lens is a lens that is finely processed without injection molding, and the mold lens is an injection molded lens.

In the optical system 1000 and 1001, the lenses of the glass material are arranged, and since the rate of change in shrinkage and expansion due to temperature change is smaller than that of the plastic material, heat compensation is possible within the lens barrel, and deterioration of optical characteristics due to temperature change can be suppressed. In addition, since the lenses of the glass material include at least two or more aspherical lenses, the occurrence of various aberrations can be suppressed. Among the lenses of the optical system 1000 and 1001, the lens having the maximum Abbe number may be positioned in the second lens group LG2, and the lens having the maximum refractive index may be positioned in the first lens group LG1. The maximum Abbe number may be 65 or greater, and the maximum refractive index may be 1.8 or greater. The lens having the maximum Abbe number may reduce chromatic dispersion, and the lens having the maximum refractive index may increase chromatic dispersion of incident light, and the center thickness may be thinner than the edge thickness. The lens having the maximum effective diameter in the optical system 1000 and 1001 may be a lens close to the object side. Preferably, the lens having the maximum effective diameter may be a glass lens. The effective diameter of each lens may be the diameter of an effective region on which effective light is incident from each lens, and is an average of the effective diameter on the object side and the effective diameter on the sensor side. An embodiment of the invention can reduce the weight of a camera module, provide a more cost-effective manufacturing cost, and suppress deterioration of optical characteristics due to temperature changes by further mixing an aspherical lens into the optical system 1000 and 1001. Each of the lenses may include an effective region and an ineffective region. The effective region may be an area through which light incident on each of the lenses passes. That is, the effective region may be defined as an effective region or an effective diameter in which the incident light is refracted to implement optical characteristics. The ineffective region may be arranged around the effective region. The ineffective region may be a region in which effective light is not incident on the plurality of lenses. That is, the ineffective region may be a region unrelated to the optical characteristics. In addition, an end of the ineffective region may be a region fixed to a lens barrel (not shown) that accommodates the lens.

Within the optical system 1000 and 1001, TTL (Total top length) may be more than twice as long as the ImgH, for example, more than twice and less than 15 times. Preferably, the following condition may satisfy: 4<TTL/ImgH≤10. The TTL (Total track length) is a distance from the center of the object-side surface of the first lens to the surface of the image sensor 300 in the optical axis OA. The ImgH is a distance from the optical axis OA to the diagonal end of the image sensor 300 or half of the maximum diagonal length. Within the optical system 1000 and 1001, the effective focal length (EFL) is provided to be 10 mm or more and the diagonal field of view (FOV) is provided to be less than 45 degrees, so that the optical system may be provided as a standard optical system in a vehicle camera module. For example, the optical system and camera module according to the embodiment can be applied to a camera module for an ADAS (Advanced Driving Assistance System) installed inside or outside a vehicle. The optical system 1000 and 1001 can have a condition of TTL/(2*ImgH) of 2.5 or more or 2.7 or more, for example, can be in the range of 2.5 to 5 or 3 to 5. By setting the value of TTL/(2*ImgH) to 2.5 or more by the optical system 1000 and 1001, a vehicle lens optical system can be provided. The total number of lenses of the first and second lens groups LG1 and LG2 is 8 or less. Accordingly, the optical system 1000 and 1001 can provide an image without exaggeration or distortion for the formed image.

The length of the image sensor 300 is the maximum length of the diagonal in the direction orthogonal to the optical axis OA. The number of lenses having an effective diameter larger than the length of the image sensor 300 within the optical system 1000 and 1001 is 50% or more, and the number of lenses having an effective diameter smaller than the length of the image sensor 300 is less than 50%, for example, in the range of 10% to 43%. At least one or all of the aspherical lenses within the optical system 1000 and 1001 may have an effective diameter smaller than the length of the image sensor 300. The effective diameter of the lens closest to the object side within the lens portion 100 and 100A may be larger than the effective diameter of the lens closest to the image sensor 300. In addition, the effective diameters of the lens arranged on the object side of the aperture stop ST and the lens arranged on the sensor side may be larger than the diagonal length of the image sensor 300. Accordingly, the brightness of the optical system can be controlled. By controlling the effective diameter size of each of the lenses, the optical system 1000 and 1001 can control the incident light to compensate for the resolution and the deterioration of optical characteristics due to temperature changes, improve the chromatic aberration control characteristics, and improve the vignetting characteristics of the optical system 1000 and 1001.

The optical system 1000 and 1001 may include at least one cemented lens 145 and 145A inside. The cemented lens 145 and 145A may be a lens in which two lenses with different focal lengths are bonded. The effective diameters of the lenses arranged on the object side based on the cemented lens 145 and 145A may be larger than the length of the image sensor 300. The effective diameters of the lenses arranged on the sensor side based on the cemented lens can be larger than the length of the image sensor 300. In addition, the effective diameter of the object-side lens of the cemented lens 145 and 145A may be larger than the length of the image sensor 300, and the effective diameter of the sensor-side lens may be arranged within a range of +110% of the diagonal length of the image sensor 300. The cemented lens 145 and 145A may be a spherical lens.

The first lens group LG1 and the second lens group LG2 may have a set distance in the optical axis OA. The optical axis distance between the first lens group LG1 and the second lens group LG2 in the optical axis OA may be the optical axis interval between the sensor-side surface of the lens closest to the sensor side among the lenses in the first lens group LG1 and the object-side surface of the lens closest to the object side among the lenses in the second lens group LG2.

The optical axis distance between the first lens group LG1 and the second lens group LG2 may be 1 time or less of the optical axis distance of the first lens group LG1, and may be, for example, in a range of 0.5 to 1 time the optical axis distance of the first lens group LG1. The optical axis distance between the first lens group LG1 and the second lens group LG2 may be 0.2 times or less of the optical axis distance of the second lens group LG2, and may be, for example, in a range of 0.01 to 0.2 times the optical axis distance of the second lens group LG2. The optical axis distance of the second lens group LG2 is an optical axis distance between the object-side surface of the lens closest to the object side of the second lens group LG2 and the sensor-side surface of the lens closest to the image sensor 300. Here, among the lens surfaces of the first lens group LG1 and the second lens group LG2, two surfaces facing each other, for example, the sensor-side surface of the object-side lens, may be convex, and the object-side surface of the sensor-side lens, may be concave. That is, the sensor-side surface closest to the sensor side in the first lens group LG1 may be convex, and the object-side surface closest to the object side in the second lens group LG2 may be concave. The first lens group LG1 may refract light incident through the object side to gather, and the second lens group LG2 may refract light emitted through the first lens group LG1 to the image sensor 300.

The first lens group LG1 may have negative (−) refractive power, and the second lens group LG2 may have positive (+) or negative refractive power. In the first lens group LG1, the lens closest to the object side may have negative (−) refractive power, and among the lenses of the second lens group LG2, the lens closest to the sensor side may have negative (−) refractive power. That is, the composite focal length of the first and second lenses may have a positive focal length in the first embodiment, a negative focal length in the second embodiment, and the focal length of the third to seventh lenses may have a positive focal length in the first and second embodiments. In addition, the refractive power of the first lens on the object side may have a negative value, and the composite focal length of the second to seventh lenses may have a positive value.

When the focal length is expressed as an absolute value, the focal length of the first lens group LG1 may be 1.5 times or more, for example, 1.5 to 5 times, of the focal length of the second lens group LG2. The effective focal length (EFL) of the optical system 1000 and 1001 may be smaller than the absolute value of the focal length of the first lens group LG1. The EFL of the optical system 1000 and 1001 may be smaller than the absolute value of the focal length of the second lens group LG2.

The lens portion 100 and 100A may be a mixture of spherical lenses and aspherical lenses. The number of lenses of the aspherical lenses may be less than 50% of the total number of lenses, and may be in the range of 10% to 43%. When representing the absolute value of the focal length, the average of the focal lengths of the spherical lenses may be smaller than the average of the focal lengths of the aspherical lenses. The average of the refractive indices of the aspherical lenses may be smaller than the average of the refractive indices of the spherical lenses. In addition, the difference in the average effective diameter of the spherical lenses and the average effective diameter of the aspherical lenses may be more than 1 mm, for example, in the range of 1.5 mm to 4 mm. Accordingly, when two or more aspherical lenses are arranged in the camera module, the weight of the camera module can be reduced and the optical characteristics can be improved. The average Abbe number of the spherical material lenses in the lens portion 100 and 100A may be smaller than the average Abbe number of the aspherical lenses. Since the lens adjacent to the image sensor 300 is arranged to have a low Abbe number and a high refractive index, color dispersion can be improved at a position adjacent to the image sensor 300. The number of lenses having negative (−) refractive power on the optical system 1000 and 1001 may be smaller than the number of lenses having positive (+) refractive power. The number of lenses having negative (−) refractive power may be less than 60% of the total number of lenses, for example, in the range of 20% to 45%.

The sum of the refractive indices of the lenses of the lens portion 100 and 100A of the embodiment may be 8 or more, for example, in the range of 8 to 15, and the average of the refractive indices may be in the range of 1.65 to 1.79. The sum of the Abbe numbers of each of the lenses may be 250 or more, for example, in the range of 250 to 370, and the average of the Abbe numbers may be 55 or less, for example, in the range of 31 to 55. The sum of the center thicknesses of the entire lens may be 15 mm or more, for example, in the range of 15 mm to 30 mm or 20 mm to 35 mm. The average of the center thicknesses of the entire lens may be 5 mm or less, for example, in the range of 2.8 mm to 5 mm. The sum of the center distances between the lenses on the optical axis OA may be 5 mm or more, for example, in the range of 5 mm to 10 mm, and may be smaller than the sum of the center thicknesses of the lenses. In addition, the average value of the effective diameter of each lens surface of the lens portion 100 and 100A may be provided as 8 mm or more, for example, in the range of 8 mm to 15 mm.

The F number of the optical system or camera module according to the embodiment of the invention may be 2.4 or less, for example, in the range of 1.4 to 2.4 or in the range of 1.5 to 1.8. The maximum angle of view (diagonal) in the optical system according to the embodiment of the invention may be 50 degrees or less, for example, in the range of 20 degrees to 55 degrees or 25 degrees to 40 degrees. The vehicle optical system may have a horizontal field of view FOV_H in the Y-axis direction that may be greater than 20 degrees and less than 40 degrees, for example, in the range of 25 degrees to 35 degrees. In addition, the vertical field of view may be provided at an angle smaller than the horizontal field of view, and may be 20 degrees or less, for example, in the range of 10 degrees to 20 degrees. At this time, the sensor length in the horizontal direction Y may be 8.064 mm+0.5 mm, and the sensor height in the vertical direction X may be 4.54 mm+0.5 mm. The horizontal field of view FOV His the field of view based on the horizontal length of the sensor. Accordingly, it is possible to suppress the change in the focus position due to temperature change, and provide a vehicle camera in which various aberrations are well corrected.

The optical system 1000 and 1001 or the camera module may include an image sensor 300. The image sensor 300 may detect light and convert it into an electrical signal. The image sensor 300 may detect light that has sequentially passed through the lens portion 100 and 100A. The image sensor 300 may include a device capable of detecting incident light, such as a CCD (Charge coupled device) or a CMOS (Complementary metal oxide semiconductor). Here, the length of the image sensor 300 is the maximum length in the diagonal direction orthogonal to the optical axis OA, may be smaller than the effective diameter of the lens closest to the object side in the first lens group LG1, and may be larger than the effective diameter of the lens closest to the sensor side in the second lens group LG2. Here, the number of lenses having an effective diameter larger than the length of the image sensor 300 may be 4 to 5, and the number of lenses having an effective diameter smaller than the length of the image sensor 300 may be 1 to 3.

The optical system 1000 and 1001 or the camera module may include an optical filter 500. The optical filter 500 may be placed between the second lens group LG2 and the image sensor 300. The optical filter 500 may be placed between the lens closest to the sensor side among the lenses of the lens portion 100 and 100A and the image sensor 300. For example, the optical system 100 and 100A may be placed between the last lens and the image sensor 300. The cover glass 400 is disposed between the optical filter 500 and the image sensor 300, and may protect the upper portion of the image sensor 300 and inhibit the reliability of the image sensor 300 from being deteriorated. The cover glass 400 may be removed. The optical filter 500 may include an infrared filter or an infrared cut-off filter. The optical filter 500 may allow light of a set wavelength band to pass through and filter light of a different wavelength band. When the optical filter 500 includes an infrared filter, it can block radiant heat emitted from external light from being transmitted to the image sensor 300. In addition, the optical filter 500 may transmit visible light and reflect infrared light.

The optical system 1000 and 1001 according to the embodiment can include an aperture stop ST. The aperture stop ST can adjust the amount of light incident on the optical system 1000 and 1001. The aperture stop ST may be arranged between any two lenses in the lens portion 100 and 100A. In the lenses arranged between the object and the aperture stop ST, the effective diameter of the lenses tends to decrease as they go from the object side to the aperture stop ST. In the lenses arranged between the aperture stop ST and the image sensor 300, the effective diameter of the lenses tends to decrease as they go from the aperture stop ST to the sensor side. The meaning of ‘the effective diameters of the lenses tend to decrease as they go from the aperture stop ST to the sensor side’ does not only mean that the effective diameters of the lenses arranged between the aperture stop ST and the image sensor 300 decrease as they go from the aperture stop ST to the sensor side, but also that at least one lens surface may be larger than the object-side lens surface. As in the embodiment of the invention, the effective diameters of the lenses arranged between the aperture stop ST and the image sensor also include a case where they increase and then decrease as they go from the aperture stop ST to the sensor side.

A first lens 101 and 111 and a second lens 102 and 112 may be disposed on the object side of the aperture stop ST, and a third lens 103 and 113 and a fourth lens 104 and 114 may be disposed on the sensor side of the aperture stop ST. When the aperture stop ST is disposed on the sensor-side surface of the second lens 102 and 112, the following condition satisfies: effective diameter of the object-side surface of the first lens>effective diameter of the sensor-side surface of the first lens>effective diameter of the object-side surface of the second lens>effective diameter of the sensor-side surface of the second lens (an effective diameter of the aperture stop). The following condition satisfies: effective diameter of the sensor-side surface of the second lens 102 and 112>effective diameter of the object-side surface of the fourth lens>effective diameter of the sensor-side surface of the fourth lens>effective diameter of the object-side surface of the sixth lens>effective diameter of the sensor-side surface of the sixth lens.

The aperture stop ST can be arranged at a set position. The aperture stop ST may be arranged on the periphery of the object-side surface or the sensor-side surface of any one of the lenses of the first lens group LG1. For example, the aperture stop ST may be arranged around the sensor-side surface of the sensor-side lens of the first lens group LG1, that is, around the sensor-side surface of the second lens 102. As another example, the aperture stop ST may be arranged around the object-side surface or the sensor-side surface of the lens closest to the object side among the lenses of the second lens group LG2. Alternatively, the aperture stop ST may be arranged around the object-side surface or the sensor-side surface of the object-side lens of the first lens group LG1. Alternatively, at least one lens selected from among the plurality of lenses may function as an aperture stop. In detail, the object-side surface or the sensor-side surface of one lens selected from among the lenses of the optical system 1000 and 1001 may function as an aperture stop for controlling the amount of light.

Since the embodiment is an optical system applied to a vehicle camera, an aspherical lens and a spherical lens can be used together, and the first lens closest to the object side can be provided with a glass material. This is because the glass material has the advantage of being scratch-resistant and insensitive to external temperature compared to a plastic material. In order to be placed inside a vehicle or to more effectively inhibit scratches caused by foreign substances, a glass lens is used as the first lens, and the object-side surface of the first lens may have a concave shape so as not to come into contact with external structures. If the object-side surface of the first lens is designed to have a convex shape, scratches may occur due to contact with external structures. In order to monitor the driver while driving, take front/rear shots of the vehicle, or detect lanes and detect unexpected objects around the vehicle, the field of view may be more than 20 degrees and less than 40 degrees, and can be, for example, in the range of 25 degrees to 35 degrees. This horizontal field of view may be a preset angle for an advanced driver assistance system (ADAD). The optical system 1000 and 1001 according to the embodiment may further include a reflective member (not shown) for changing the path of light. The reflective member may be implemented as a prism that reflects the incident light of the first lens group LG1 toward the lenses. Hereinafter, the optical system according to the embodiment will be described in detail.

### First Embodiment

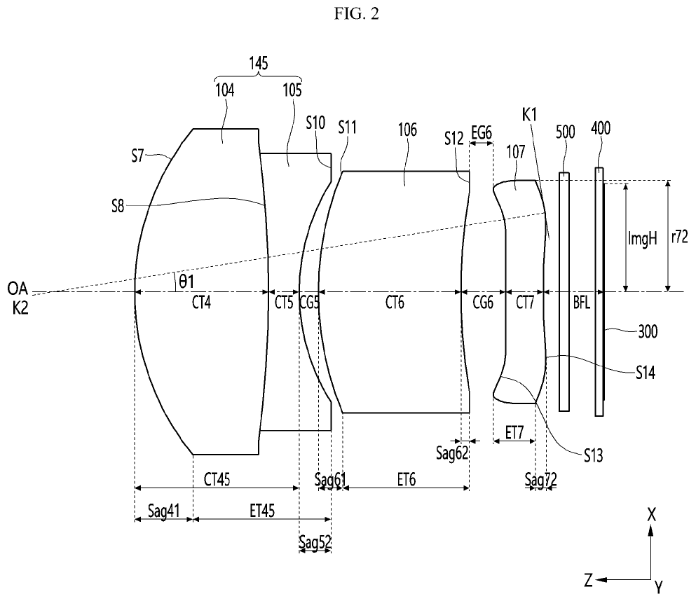

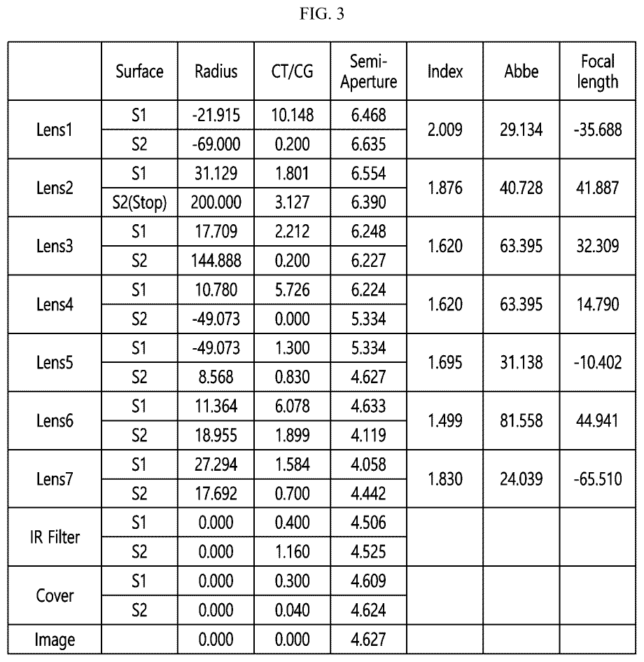

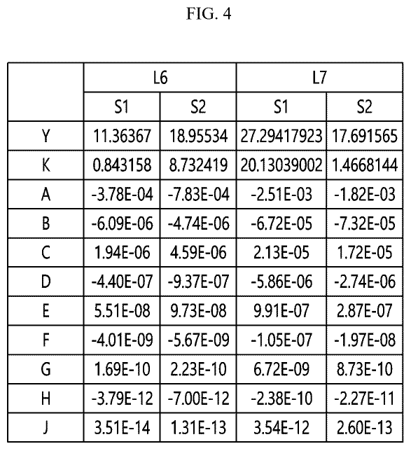

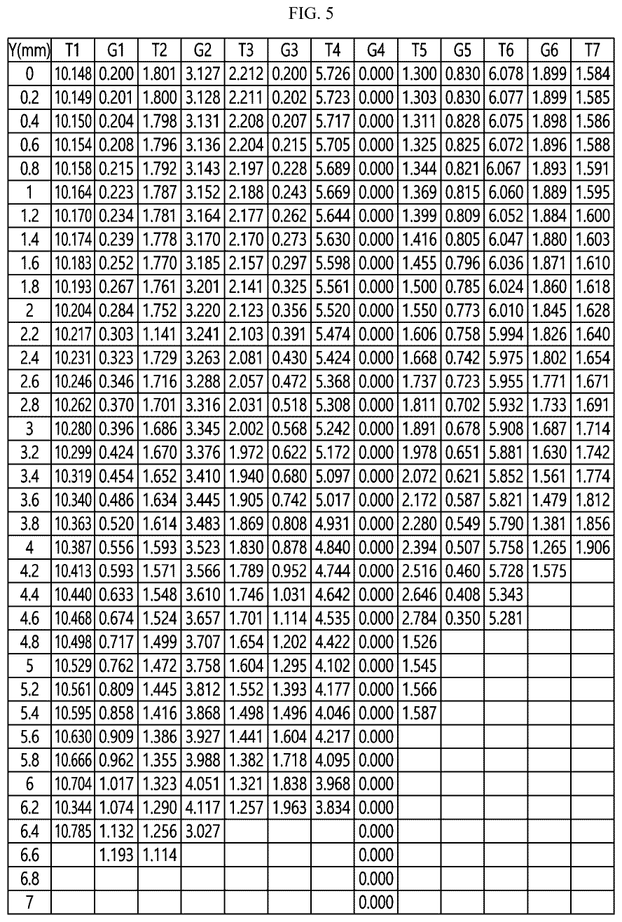

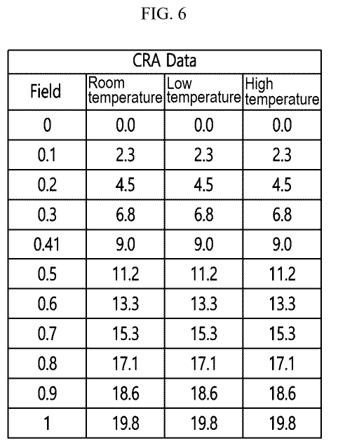

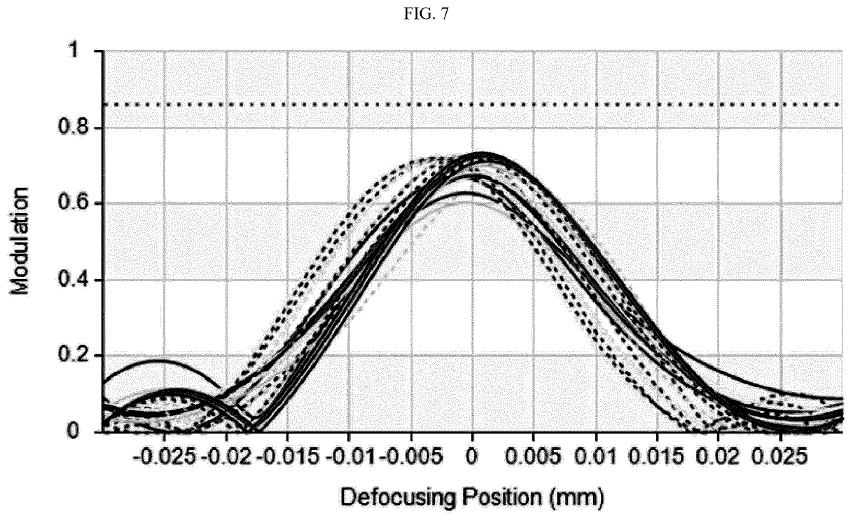

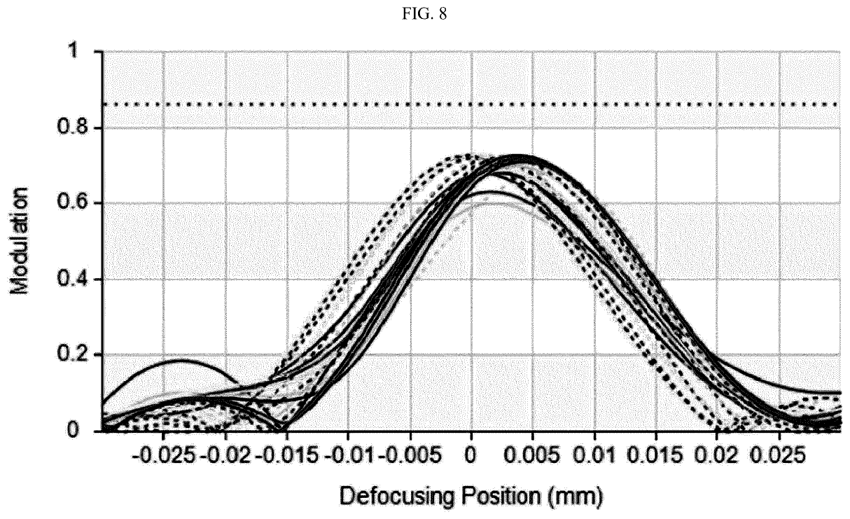

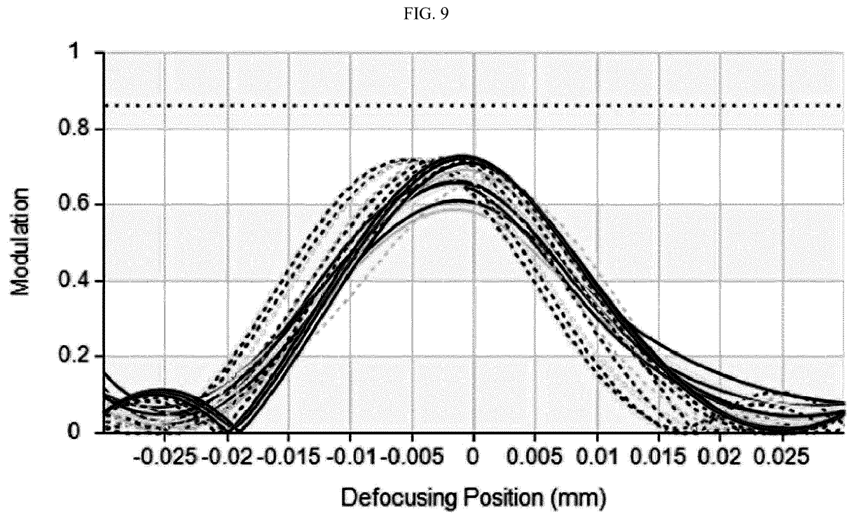

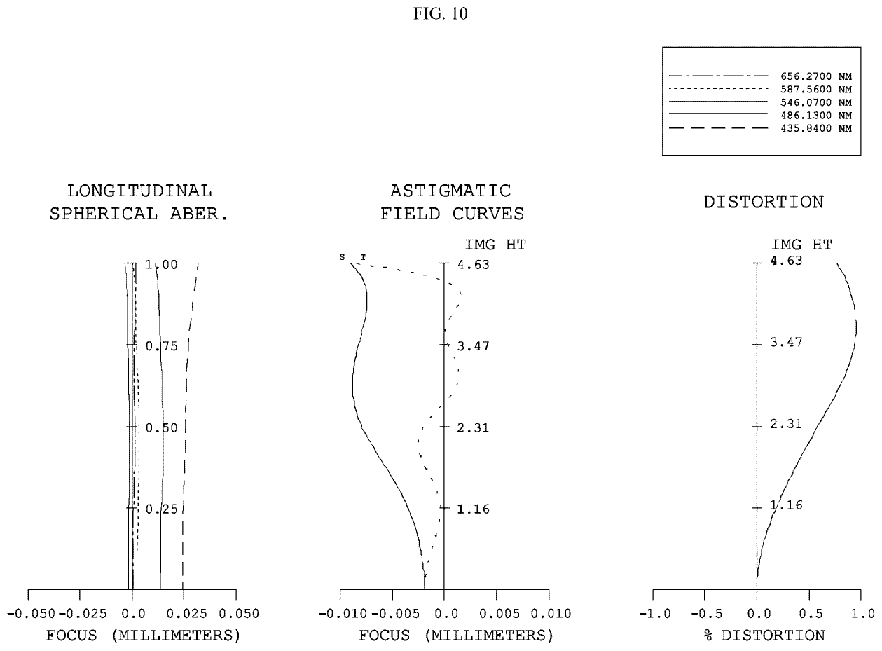

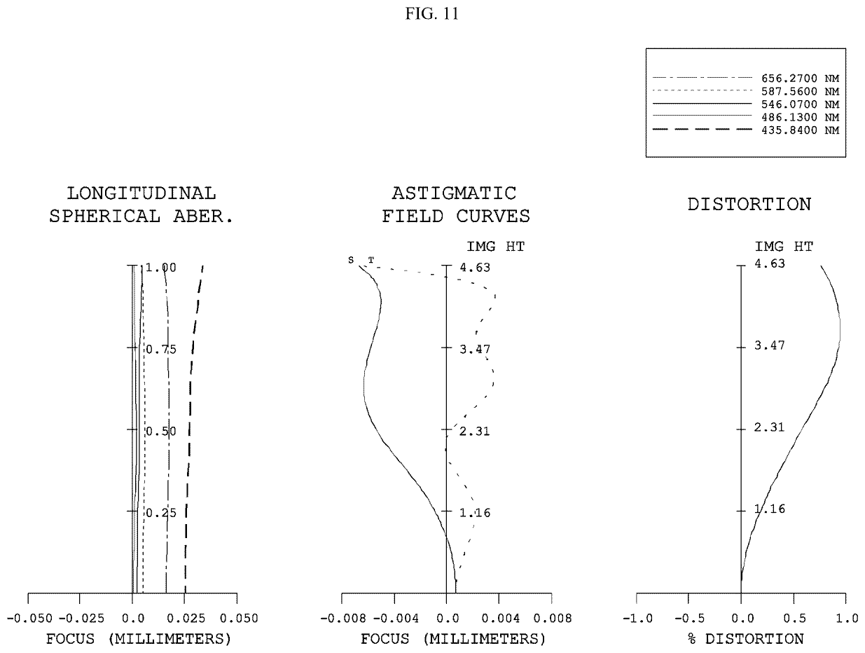

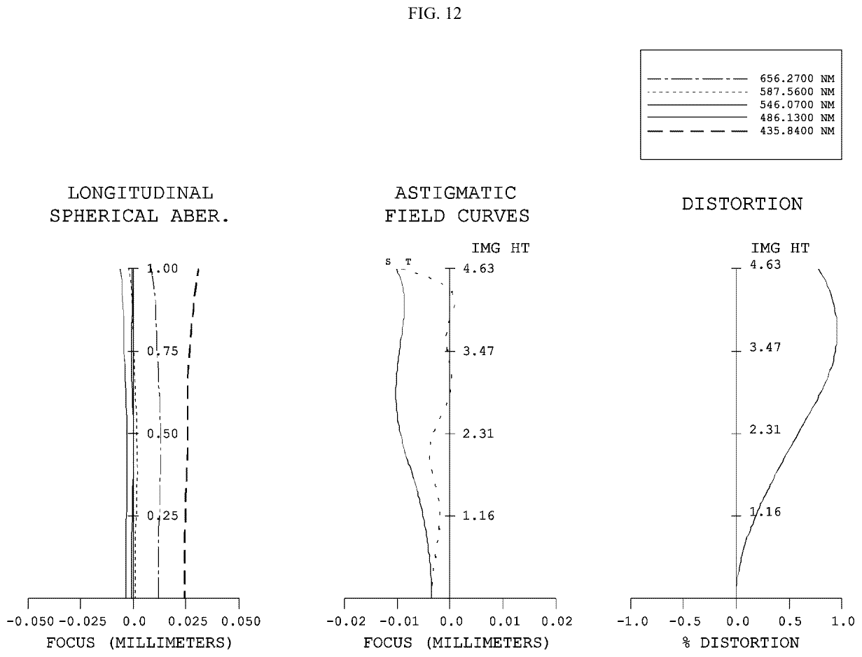

The optical system according to the first embodiment of the invention will be described. FIG. 1 is a side cross-sectional view of an optical system according to a first embodiment and a camera module having the same, FIG. 2 is a side cross-sectional view for explaining the relationship between the n-th and n-1th lenses according to FIG. 1, FIG. 3 is a table showing lens characteristics of the optical system of FIG. 1, FIG. 4 is a table showing aspherical coefficients of lenses in the optical system of FIG. 1, FIG. 5 is a table showing the thickness of each lens and the spacing between adjacent lenses in the optical system of FIG. 1, FIG. 6 is a table showing CRA data at room temperature, low temperature, and high temperature according to the position of the image sensor in the optical system of FIG. 1, FIGS. 7 to 9 are graphs showing data on diffraction MTF of the optical system of FIG. 1 at room temperature, low temperature, and high temperature, and FIGS. 10 to 12 are graphs showing data on aberration characteristics of the optical system of FIG. 1 at room temperature, low temperature, and high temperature.

Referring to FIGS. 1 to 3, an optical system 1000 according to a first embodiment includes a lens portion 100, and the lens portion 100 may include a first lens 101 to a seventh lens 107. The first to seventh lenses 101, 102, 103, 104, 105, 106, and 107 may be sequentially arranged along an optical axis OA. Light corresponding to information about an object may pass through the first lens 101 to the seventh lens 107 and the optical filter 500 and be incident on an image sensor 300. The first lens 101 is the lens closest to the object side in the first lens group LG1. The seventh lens 107 is the lens closest to the image sensor 300 in the second lens group LG2 or the lens portion 100. The first and second lenses 101 and 102 may be a first lens group LG1, and the third to seventh lenses 103, 104, 105, 106, and 107 may be a second lens group LG2.

The first lens 101 may have positive (+) or negative (−) refractive power on the optical axis OA. The first lens 101 may have negative refractive power. The first lens 101 may include a plastic material or a glass material, and may be, for example, a glass material. The first lens 101 made of a glass material may reduce changes in the center position and the curvature radius due to temperature changes according to the surrounding environment, and may protect the incident side surface of the optical system 1000. The object-side first surface S1 of the first lens 101 may be concave on the optical axis, and the sensor-side second surface S2 may be convex. The first lens 101 may have a convex meniscus shape toward the sensor. Alternatively, the first surface S1 may have a convex shape with respect to the optical axis OA, and the second surface S2 may have a concave shape. Alternatively, the first lens 101 may have concave shapes on both sides with respect to the optical axis OA. The first lens 101 may be provided as a spherical lens made of glass. The effective radius r11 of the first surface S1 of the first lens 101 may be larger than the effective radii of the object-side surface and the sensor-side surface of the second to seventh lenses 102-107. Since the first surface S1 is concave and the second surface S2 has a convex shape, the incident light is refracted in a direction away from the optical axis OA, and the distance between the first lens 101 and the second lens 102 can be reduced. The first surface S1 of the first lens 101 may be provided without a critical point from the optical axis OA to the end of the effective region, i.e., the edge. The second surface S2 of the first lens 101 can be provided without a critical point.

The second lens 102 can be arranged between the first lens 101 and the third lens 103. The second lens 102 may have positive (+) or negative (−) refractive power at the optical axis OA. The second lens 102 may have positive refractive power. The second lens 102 may include a plastic or glass material. For example, the second lens 102 may be provided as a glass material. The object-side third surface S3 of the second lens 102 with respect to the optical axis OA may have a convex shape, and the sensor-side fourth surface S4 may have a concave shape. The second lens 102 may have a meniscus shape that is convex from the optical axis toward the object side. Alternatively, the second lens 102 may have a convex shape on both sides. Alternatively, the third surface S3 may be concave, and the fourth surface S4 may be convex. Alternatively, the second lens 102 may have a concave shape on both sides. The second lens 102 may be provided as a spherical lens made of glass. The third surface S3 and the fourth surface S4 may be spherical. At least one or both of the third surface S3 and the fourth surface S4 may be provided without a critical point from the optical axis OA to the end of the effective region.

The aperture stop ST may be disposed around the sensor-side surface of the second lens 102. Alternatively, the aperture stop ST may be disposed around the object-side or sensor-side surface of the first lens 101, or around the object-side surface of the second lens 102.

The third lens 103 may have positive (+) or negative (−) refractive power on the optical axis OA. The third lens 103 may have positive refractive power. The third lens 103 may include a plastic or glass material. For example, the third lens 103 may be provided with a glass material. The fifth surface S5 on the object side of the third lens 103 based on the optical axis may have a convex shape, and the sixth surface S6 on the sensor side may have a concave shape. The third lens 103 may have a meniscus shape convex from the optical axis to the object side. Alternatively, the third lens 103 may have a meniscus shape convex from the optical axis to the sensor side. Alternatively, the third lens 103 may have a concave shape on both sides from the optical axis. The third lens 103 may be provided as a spherical lens made of glass. The fifth surface S5 and the sixth surface S6 may be spherical. At least one or both of the fifth surface S5 and the sixth surface S6 may be provided without a critical point from the optical axis OA to the end of the effective region.

Since the third lens 103 adjacent to the sensor side of the aperture stop ST has positive refractive power (F3>0), the third lens 103 can refract incident light in the direction of the optical axis, and can suppress an increase in the effective diameter of the sensor-side or rear-side lenses of the third lens 103. Accordingly, the yield by weight of the optical system can be inhibited from decreasing by the third lens 103, and production efficiency can be improved. Here, the composite focal length of the third to seventh lenses 103-107 arranged on the sensor side of the aperture stop ST can have a positive value, and can reduce the TTL within the field of view range.

The fourth lens 104 may have positive (+) or negative (−) refractive power on the optical axis OA. The fourth lens 104 may have positive refractive power. The fourth lens 104 may include a plastic or glass material. For example, the fourth lens 104 may be provided as a glass material. The object-side seventh surface S7 of the fourth lens 104 on the optical axis may be convex, and the sensor-side eighth surface S8 may have a convex shape. The fourth lens 104 may have a convex shape on both sides. Alternatively, the fourth lens 104 may have a meniscus shape convex on the optical axis OA toward the sensor side. Alternatively, the seventh surface S7 may have a concave shape on the optical axis OA, and the eighth surface S8 may have a concave shape. Alternatively, the fourth lens 104 may have a meniscus shape convex toward the object side. The fourth lens 104 may be provided as a spherical lens made of glass. The seventh surface S7 and the eighth surface S8 may be spherical. The seventh surface S7 and the eighth surface S8 may be provided without a critical point from the optical axis OA to the end of the effective region.

The fifth lens 105 may have positive (+) or negative (−) refractive power on the optical axis OA. The fifth lens 105 may have negative refractive power. The fifth lens 105 may include a plastic or glass material. For example, the fifth lens 105 may be provided with a glass material. With respect to the optical axis OA, the object-side ninth surface of the fifth lens 105 may have a concave shape, and the sensor-side tenth surface S10 may have a concave shape. The fifth lens 105 may have a concave shape on both sides on the optical axis OA. In this way, the fifth lens 105 may have a convex meniscus shape toward the object side. In this way, the ninth surface may have a concave shape on the optical axis OA, and the tenth surface S10 may have a convex shape. In this way, the fifth lens 105 may have a convex shape on both sides on the optical axis. The ninth surface and the tenth surface S10 of the fifth lens 105 may be spherical. At least one or both of the ninth surface and the tenth surface S10 may be provided without a critical point from the optical axis OA to the end of the effective region.

The fourth lens 104 and the fifth lens 105 may be cemented, and may be defined as a cemented lens 145. The bonding surface between the fourth lens 104 and the fifth lens 105 may be defined as the eighth surface S8. The eighth surface S8 may be the same surface as the ninth surface of the fifth lens 105. When the distance between the fourth and fifth lenses 104 and 105 is G4, G4 may be less than 0.01 mm. The distance G4 between the fourth and fifth lenses 104 and 105 may be less than 0.01 mm from the optical axis OA to the end of the effective region. The fourth and fifth lenses 104 and 105 may have opposite refractive powers. The composite refractive power of the fourth and fifth lenses 104 and 105 may have negative (−) refractive power. When the composite refractive power of the cemented lens 145 is F45, the composite refractive power of the first and second lenses 101 and 102 is F12, and the composite refractive power of the third to seventh lenses 103-107 is F37, the following condition in absolute value may satisfy: F27<F45<F12.

The product of the refractive power of the fourth lens 104 of the cemented lens 145 and the refractive power of the fifth lens 105 may be less than 0. The product of the focal length of the fourth lens 104 of the cemented lens 145 and the focal length of the fifth lens 105 may be less than 0. Accordingly, the aberration characteristics of the optical system may be improved. If the refractive powers of the two lenses of the cemented lens 145 are the same, there is a limit to the improvement of aberration. The composite refractive power of the cemented lens 145 has negative refractive power, and the third lens 103 arranged on the object side and the sixth lens 106 arranged on the sensor side based on the cemented lens 145 may have positive refractive power. Accordingly, the third lens 103, the cemented lens 145, and the sixth lens 106 may refract some of the incident light in the direction of the optical axis.

The effective diameter of the fourth lens 104 may be larger than the diagonal length of the image sensor 300. The effective diameter of the fourth lens 104 is an average of the effective diameters of the seventh surface S7 and the eighth surface S8, and may be larger than the diagonal length of the image sensor 300. The effective diameter of the fifth lens 105 may be smaller than the effective diameter of the fourth lens 104 and may have a length within a range of ±110% or ±105% of the diagonal length of the image sensor 300. Preferably, the effective diameter of the fifth lens 105 may be larger than the diagonal length of the image sensor 300, for example, 110% or less or 105% or less of the diagonal length of the image sensor 300. The effective diameter of the seventh surface S7 of the fourth lens 104 may be larger than the diagonal length of the image sensor 300, and the effective diameter of the tenth surface S10 of the fifth lens 105 may have a range of 95% to 105% of the diagonal length of the image sensor 300.

When the fifth lens 105 is a spherical lens and the sixth lens 106 is an aspherical lens, the difference between the effective diameter of the object-side seventh surface S7 of the cemented lens 145 and the effective diameter of the sensor-side tenth surface S10 may be provided to be the largest within the lens portion 100. When the effective diameter of the seventh surface of the fourth lens 104 and the effective diameter of the sensor-side eighth surface S8 are set to CA41 and CA42, the following condition satisfies: CA41>CA42, and a difference between CA41 and CA42 may be the maximum among the effective diameter differences between the object-side surface and the sensor-side surface of each lens. In addition, when the effective diameter of the ninth surface of the fifth lens 105 and the effective diameter of the sensor-side tenth surface S10 are set to CA51 and CA52, the following condition may satisfy: CA51>CA52. Accordingly, it is possible to effectively guide light traveling to the aspherical lens by the fifth lens 105 having a relatively small effective diameter.

Since the cemented lens 145 is bonded with spherical glass lenses having different refractive indices, and at least one lens arranged on the sensor side relative to the cemented lens 145 is arranged as an aspherical lens, spherical aberration can be compensated for in the optical system 1000. In addition, since at least one or two or more lenses arranged on the sensor side are aspherical lenses and have a small effective diameter compared to the cemented lens 145, light traveling through the aspherical lens to the image sensor 300 can be effectively guided. When the refractive index of the fourth lens 104 is n4, the refractive index of the fifth lens 105 is n5, an Abbe number of the fourth lens 104 is v4, and the Abbe number of the fifth lens 105 is v5, the following condition may satisfy: n5*v5<n4*v4.

When the curvature radius of the object-side seventh surface S7 of the cemented lens 145 is L4R1, and the curvature radius of the sensor-side tenth surface S10 of the cemented lens 145 is L5R2, the following condition may satisfy: |L4R1-L5R2|<20 mm, and preferably, |L4R1-L5R2| ≤15 mm. The shape of the object-side surface and the sensor-side surface of the cemented lens 145 has a meniscus shape convex toward the object side, and by setting the difference in the curvature radius of the object-side surface and the sensor-side surface small, the amount of incident light can be increased and the emitted light can be guided to the area of the sixth lens 106 having a small effective diameter.

The sixth lens 106 can have positive (+) or negative (−) refractive power on the optical axis OA. The sixth lens 106 can have positive (+) refractive power. The sixth lens 106 can include a plastic or glass material. For example, the sixth lens 106 may be provided as a glass material or a glass mold material. The sixth lens 106 may have a convex eleventh surface S11 on the object side and a concave twelfth surface S12 on the sensor side with respect to the optical axis OA. The sixth lens 106 may have a convex meniscus shape from the optical axis OA toward the object side. Alternatively, the sixth lens 106 may have a convex meniscus shape toward the sensor side, or a convex shape on both sides. Alternatively, the sixth lens 106 may have a concave shape on both sides. The eleventh surface S11 and the twelfth surface S12 may be aspherical, and the aspherical coefficients of the eleventh and twelfth surfaces S11 and S12 may be provided as L6S1 and L6S2 of FIG. 4. The sixth lens 106 is provided with an aspherical glass material, so that the glass material with a low refractive index has an aspherical surface, and thus the number of lenses in the optical system can be reduced. The optical system 1000 may have at least one, for example, 1 to 3, aspherical glass lenses, and preferably 2. The eleventh surface S11 of the sixth lens 106 may be provided without a critical point from the optical axis OA to the end of the effective region. The twelfth surface S12 may be provided without a critical point from the optical axis OA to the end of the effective region. Differently, at least one of the object-side surface and the sensor-side surface of the sixth lens 106 may have at least one critical point from the optical axis to the end of the effective region.

Since the object-side surface and the sensor side of the sixth lens 106 are provided without a critical point, the effective diameter of the seventh lens 107 may not be increased. In addition, the difference between the effective diameter of the seventh lens 107 and the diagonal length of the image sensor 300 may not be large due to the sixth lens 106. When the effective diameter of the object-side eleventh surface S11 of the sixth lens 106 is CA61 and the effective diameter of the sensor-side twelfth surface S12 of the sixth lens 106 is CA62, the following condition may satisfy: CA62<CA61. When the curvature radius of the object-side eleventh surface S11 of the sixth lens 106 is L6R1 and the curvature radius of the sensor-side twelfth surface S12 of the sixth lens 106 is L6R2, the following condition may satisfy: CA61*L6R1<CA62*L6R2. When the refractive index of the sixth lens 106 is n6, the Abbe number is v6, and the refractive index of the first lens 101 is n1, and the Abbe number is v1, the following conditions may satisfy: n6<n1 and n1*v1<n6*v6. This means that the center thickness of the sixth lens 106 can be provided to be greater than the center thickness of the seventh lens 107, thereby making the refractive index less than 1.6 and increasing the Abbe number to suppress color dispersion.

The seventh lens 107 may have positive (+) or negative (−) refractive power on the optical axis OA. The seventh lens 107 may have negative (−) refractive power. The seventh lens 107 may include a plastic or glass material. For example, the seventh lens 107 may be a glass material or a glass mold material. The object-side thirteenth surface S13 of the seventh lens 107 on the optical axis may have a convex shape, and the sensor-side fourteenth surface S14 may have a concave shape. The seventh lens 107 may have a meniscus shape that is convex toward the object side on the optical axis. Alternatively, the thirteenth surface S13 on the optical axis OA may have a concave shape, and the fourteenth surface S14 may have a convex shape. In contrast, the seventh lens 107 may have a concave shape on both sides. The seventh lens 107 may be made of glass and may have aspherical surfaces on both sides. The thirteenth surface S13 and the fourteenth surface S14 may have aspherical surfaces, and aspherical coefficients may be provided as L7S1 and L7S2 of FIG. 4. The seventh lens 107 may be an aspherical lens closest to the image sensor 300. By arranging the aspherical lens closest to the image sensor 300, it is possible to inhibit deterioration of optical performance, and control the effect on aberration characteristics and resolution. In addition, by arranging the aspherical lens as the lens closest to the image sensor 300, it may be insensitive to assembly tolerance compared to a spherical lens. In other words, being insensitive to assembly tolerance means that even if assembled with a slight difference compared to the design during assembly, it may not significantly affect the optical performance.

In the sixth lens 106, if the Sag value of the object-side surface is Sag61 and the Sag value of the sensor-side surface is Sag62, the following condition may satisfy: 0<Sag61-Sag62<0.5 mm. Accordingly, the difference in thickness between the center and edge of the sixth lens 106 is not large, and the influence on the optical characteristics can be suppressed. In the seventh lens 107, if the Sag value of the object-side surface is Sag71 and the Sag value of the sensor-side surface is Sag72, the following condition may satisfy: 0<|Sag71|−|Sag72|<0.3 mm. Accordingly, the difference in thickness between the center and edge of the seventh lens 107 is not large, and the curvature radius is not large, and the influence on the optical characteristics can be suppressed. Since the sixth and seventh lenses 106 and 107 are arranged with aspherical glass material, they are resistant to temperature changes due to heat, can reduce the number of lenses, and can reduce the TTL of the optical system.

Referring to FIG. 2, at least one or both of the thirteenth surface S13 and the fourteenth surface S14 of the seventh lens 107 can have a critical point. The thirteenth surface S13 of the seventh lens 107 may have at least one critical point from the optical axis OA to the end of the effective region. Since the thirteenth surface S13 and the fourteenth surface S14 of the seventh lens 107 have critical points, light can be provided to the entire region of the image sensor 300. The critical point of the thirteenth surface S13 may be located at a distance of 58% or less of the effective radius from the optical axis OA, or in a range of 38% to 58%, or in a range of 43% to 53%. The critical point of the thirteenth surface S13 may be located at a distance of 2.5 mm or less from the optical axis OA, for example, in a range of 1.2 mm to 2.5 mm, or in a range of 1.6 mm to 2.3 mm. As another example, the thirteenth surface S13 may be provided without a critical point.

The fourteenth surface S14 of the seventh lens 107 may have at least one critical point from the optical axis OA to the end of the effective region. The critical point of the fourteenth surface S14 may be located at a distance of 52% or more of the effective radius from the optical axis OA, or in a range of 52% to 72%, or in a range of 57% to 67%. The critical point of the fourteenth surface S14 can be located at a position 2.1 mm or more from the optical axis OA, for example, in a range of 2.1 mm to 3.4 mm or in a range of 2.5 mm to 3.2 mm. The BFL (Back focal length) is an optical axis distance from the surface of the image sensor 300 to the center of the sensor-side surface of the last lens. A tangent line K1 passing through an arbitrary point of the fourteenth surface S14 of the seventh lens 107 and a normal line K2 perpendicular to the tangent line K1 may have a predetermined angle θ1 with the optical axis OA. The maximum tangent angle θ1 on the fourteenth surface S14 in the first direction X may be 45 degrees or less, for example, in a range of 5 degrees to 45 degrees or in a range of 15 degrees to 25 degrees. In FIG. 2, CT7 is a center thickness of the seventh lens 107, and ET7 is an edge thickness of the seventh lens 107. CT6 is a center thickness of the sixth lens 106, and ET6 is an edge thickness of the sixth lens 106. The edge thickness is the distance in the optical axis direction between the object-side surface and the sensor-side surface at the end of the effective region of each lens. CG6 is the optical axis distance (i.e., center distance) from the center of the sixth lens 106 to the center of the seventh lens 107. That is, CG6 is a distance from the center of the twelfth surface S12 to the center of the thirteenth surface S13. EG6 is a optical axis distance (i.e., edge distance) from the edge of the sixth lens 106 to the edge of the seventh lens 107.

The center thickness of the cemented lens 145 is CT45, which is an optical axis distance from the center of the object-side surface of the fourth lens 104 to the center of the sensor-side surface of the fifth lens 105. The edge thickness of the cemented lens 145 is ET45, which is an optical axis distance from the edge of the object-side surface of the fourth lens 104 to the edge of the sensor-side surface of the fifth lens 105. When the Sag value of the object-side surface of the fourth lens 104 is Sag41, the Sag value of the sensor-side surface of the fifth lens 105 is Sag51, the Sag value of the object-side surface of the sixth lens 106 is Sga61, the Sag value of the sensor-side surface of the sixth lens 106 is Sga62, the Sag value of the object-side surface of the seventh lens 107 is Sag71, and the Sag value of the sensor-side surface of the seventh lens 107 is Sga72, the following condition in absolute value satisfies: Max_Sag52<Max_Sag41, the following condition satisfies: Max_Sag61<Max_Sag52, and the following condition may satisfy: Max_Sag71<Max_Sag 72<Max_Sag62<Sag61. In this way, by adjusting the lens surfaces from the center to the edge of the fifth to seventh lenses 105-107, the incident light can be guided to the entire region of the image sensor 300. Here, the Max_Sag value is the maximum distance in the direction of the optical axis from a straight line perpendicular to the center of the object-side surface or the sensor-side surface of each lens to the lens surface, and the Sag value can have a negative value when it is located on the object-side surface rather than the center, and can have a positive value when it is located on the sensor-side surface rather than the center.

FIG. 3 is an example of lens data of the optical system of the embodiment of FIG. 1. As shown in FIG. 3, the curvature radius of the first to seventh lenses 101 to 107 on the optical axis OA, the center thickness CT of each lens, the center distance CG between adjacent lenses, the refractive index in the d-line, the Abbe numbers, and the size of the effective diameters (i.e., Clear aperture; CA) can be set. When the curvature radius of each lens on the optical axis is expressed as an absolute value, the curvature radius of the fourth surface S4 of the second lens 102 on the optical axis OA may be the largest among the lenses, and the curvature radius of the tenth surface S10 of the fifth lens 105 may be the smallest among the lenses. The difference between the maximum curvature radius and the minimum curvature radius may be 10 times or more, for example, 15 times or more. When the curvature radius of each lens is expressed as an absolute value on the optical axis, the curvature radius of the first lens 101 on the optical axis may be smaller than the curvature radius of the second lens 102 arranged on the sensor side of the aperture stop ST and the curvature radius of the third lens 103 arranged on the object side. Here, the curvature radius is an average of the absolute values of the curvature radius of the object-side surface and the sensor-side surface of each lens.

The curvature radius of the first lens 101 may be larger than the curvature radius of the other lenses except for the curvature radius of the object-side lens and the sensor-side lens of the aperture stop ST. Here, the object-side lens of the aperture stop ST is the second lens 102, the sensor-side lens is the third lens 103, and the other lenses are the fourth to seventh lenses 104-107. The curvature radius is an average of the absolute values of the curvature radius of the object-side surface and the sensor-side surface. The absolute value of the curvature radius of the object-side surface of the i-th lens is Roi, the absolute value of the sensor-side curvature radius is Rsi, and the absolute value of the average of the object-side surface and the sensor-side surface is Ri. The value of (Roi−Rsi)/Ri may be minimum when i is 7 and may be maximum when i is 3. Here, when i is 6 or 7, the value of (Roi−Rsi)/Ri may be less than 1, for example, 0.6 or less. Accordingly, each of the plurality of aspherical lenses may have a difference between the curvature radius of the object-side surface and the sensor-side surface and the average of the curvature radii of each aspherical lens smaller than that of the spherical lenses.

The difference between the curvature radii of the first surface S1 and the second surface S2 of the first lens 101 in absolute value may be 100 mm or less, for example, in the range of 30 mm to 100 mm. The difference in the curvature radius between the first surface S1 and the second surface S2 of the first lens 101 in absolute value may be smaller than the difference in the curvature radius between the object-side surface and the sensor-side surface of the object-side lens 103 of the aperture stop ST, and further, the difference in the curvature radius between the first surface S1 and the second surface S2 of the first lens 101 in absolute value may be smaller than the difference in the curvature radius between the object-side surface and the sensor-side surface of the lens 104 arranged on the sensor side of the aperture stop ST. Since the first lens 101 is provided as a spherical surface, the center thickness in the optical axis can be increased, the difference in the curvature radius between the object-side surface and the sensor-side surface cannot be made large, and the assemblability can be improved.

The curvature radius of the sixth lens 106 on the optical axis can be smaller than the curvature radius of the first lens 101. Since the sixth lens 106 is aspherical and has a curvature radius smaller than that of the first lens 101, the entire region may be provided with a uniform light distribution. The curvature radius of the seventh lens 107 on the optical axis may be smaller than that of the first lens 101. Since the seventh lens 107 is aspherical and has a curvature radius smaller than that of the first lens 101, the entire region may be provided with a uniform light distribution. Since the difference in the curvature radii of the sixth and seventh lenses 106 and 107 on the optical axis is provided to be 20 mm or less, for example, 15 mm or less, incident light can be guided to the entire region of the image sensor 300 through the two aspherical lenses. In addition, the curvature radius of the seventh lens 107 on the optical axis can be larger than the curvature radius of the sixth lens 106 made of glass. Accordingly, the seventh lens 107 can guide the light incident through the first to sixth lenses 101-106 to the entire region of the image sensor 300.

The curvature radii of the first and second surfaces S1 and S2 of the first lens 101 are defined as LIR1 and LIR2, the curvature radii of the thirteenth and fourteenth surfaces S13 and S14 of the seventh lens 107 are defined as L7R1 and L7R2, and the curvature radii of each lens surface of the second to sixth lenses 102-106 may be defined as L2R1, L2R2, L3R1, L3R2, L4R1, L4R2 (L5R1), L5R2, L6R1, and L6R2.
Condition 1: 0<|LIR1/LIR2|<0.6
Condition 2:0<|L2R1/L2R2|<0.5
Condition 3: 0<L3R1/L3R2<0.5
Condition 4: 0<L4R1/L4R2<0.5
Condition 5: 2<L5R1/L5R2<10
Condition 6: 0<L6R1/L6R2<1.2
Condition 7: 1<L7R1/L7R2<2.2
Condition 8:5 mm≤L6R2-L6R1≤25 mm
Condition 9:1 mm≤L7R1-L7R2≤25 mm

When the center thickness of the first to seventh lenses 101-107 is defined as CT1-CT7 and the edge thickness of the first to seventh lenses 101-107 is defined as ET1-ET7, a sum of the center thicknesses of the first to seventh lenses 101-107 is defined as ΣCT, and a sum of the edge thicknesses of the first to seventh lenses 101-107 can be defined as ΣET.

When explaining the thicknesses of the lenses, the center thickness CT1 of the first lens 101 may be greater than the center thicknesses CT2-CT7 of the second to seventh lenses 102-107, and may have the maximum thickness within the lens portion 100. The center thickness CT7 of the seventh lens 107 may be smaller than the center thicknesses CT1-CT6 of the first to sixth lenses 101-106, and can have the minimum thickness within the lens portion 100. The aspherical lens includes the sixth lens 106 and the seventh lens 107, and can satisfy the following condition: CT7<CT4<CT6<CT1.
The following conditions may be satisfied.
Condition 1:0.6<CT1/ET1<1.2
Condition 2: 1<CT2/ET2<2
Condition 3:1.2<CT3/ET3<2.5
Condition 4:1.2<CT4/ET4<2.4
Condition 5:0<CT5/ET5<1
Condition 6:0.6<CT6/ET6<2
Condition 7:0.4<CT7/ET7<1.2
Condition 8:0.8<ΣCT/ΣET<1.2

In this way, the difference between the center thickness and the edge thickness of each lens can be set to more than 0.6 mm and less than 3 mm. By arranging the two aspherical lenses adjacent to the image sensor 300 so that the difference between the center thickness and the edge thickness of each lens is not large, light can be effectively guided without increasing the difference between the center thickness and the edge thickness of each lens. In addition, the difference between the maximum center thickness and the minimum center thickness in the lenses may be 7 mm or more, for example, in the range of 7 mm to 10 mm or 7 mm to 9 mm. That is, even if the center thickness of the last aspherical lens is provided thinly, the optical performance may not be degraded, and the thickness of the camera module may be provided slimly.

The optical axis distance from the center of the object-side surface of the first lens 101 to the surface of the image sensor 300 may satisfy the following conditions when TTL.
Condition 1:0.15<CT1/TTL<0.5
Preferably, Condition 1 may satisfy: 0.20≤CT1/TTL≤0.30.
Condition 2:0<CT2/TTL<0.1
Condition 3: 0<CT3/TTL<0.1
Condition 4:0.1<CT4/TTL<0.25
Condition 5: 0<CT5/TTL<0.1
Condition 6: 0<CT6/TTL<0.2
Condition 7:0<CT7/TTL<0.1

The ratio of CT1/TTL of condition 1 may be greater than the values of conditions 2 to 7. The relationship between the cemented lens 145 and the first and sixth lenses 101 and 106 may satisfy the following conditions.
Condition 1:1.2<CT1/CT45<1.6
Condition 2:1.3<CT1/CT6<1.8
Condition 3:0.3<CT1/ΣCT<0.5
Condition 4:0.15<CT45/ΣCT<0.35
Condition 5:0.1<CT6/ΣCT<0.33

By setting the center thickness and edge thickness of the first to seventh lenses 101-107 to the conditions, light can be guided to an optimal path according to the refractive index, Abbe number, and curvature radius of each lens within the optical system 1000.

The center distance between the first to seventh lenses 101-107 is defined as CG1-CG6, and the sum of the center distances between the first to seventh lenses 101-107 can be defined as ΣCG. Here, the center distance between the lenses is described excluding the spacing between two lenses in the cemented lens. The center distance CG2 between the second lens 102 and the third lens 103 is maximum, and the center distance between the first and second lenses 101 and 102 or/and the center distance between the third and fourth lenses 103 and 104 is minimum. In addition, the center distance between the aspherical lenses is CG6 and can satisfy: 1.2<CG2/CG6<2. The center distance CG6 between the sixth lens 106 and the seventh lens 107 can be smaller than CG1 and the second largest within the lens portion 100. The center thickness of each lens and the center distance between adjacent lenses can satisfy the following conditions.
Condition 1: 20<CT1/CG1<60
Condition 2: 2<CT1/CG2<5
Condition 3: 1<CT6/CG6<5
Condition 4: 5<CT45<CG5<10
Condition 5:0.1<CG2/ΣCG<0.6

By providing the maximum center distance between the lenses to be more than twice the maximum center thickness, for example, in the range of 2.5 to 4 times, it is possible to provide a camera module that applies an aspherical lens to the output side of the optical system without increasing the center thickness compared to the center distance of each lens. Here, if the i-th center distance between adjacent two lenses is defined as CGi, and the center thickness of the i-th lens positioned closer to the object than CGi is defined as CTi, the following conditions may be satisfied (here, the center thickness of the cemented lens and the distance between the cemented lenses is excluded). CGi is the center distance between the i-th lens and the i+1 lens. The ratio of CTi/CGi may be minimum when i is 2 and maximum when i is 1.

Regarding the effective diameter, the lens having the maximum effective diameter can be the first lens 101 closest to the object. The first lens 101 having the maximum effective diameter can be a spherical lens. The lens having the minimum effective diameter can be the lens closest to the image sensor 300, for example, can be the seventh lens 107. The effective diameters of the first lens 101 to the seventh lens 107 may be defined as CA1, CA2, CA3, CA4, CA5, CA6, and CA7, the effective diameters of the first and second surfaces S1 and S2 of the first lens 101 may be defined as CA11 and CA12, the effective diameters of the thirteenth and fourteenth surfaces S13 and S14 of the seventh lens 107 may be defined as CA71 and CA72, and the effective diameters of the object-side surface and the sensor-side surface of the second to sixth lenses may be defined as CA21, CA22, CA31, CA32, CA41, CA42, CA51, CA52, CA61, and CA62.

The effective diameters may satisfy the following conditions.
Condition 1: CA22<CA12
Condition 2: CA71<CA72
Condition 3: CA31<CA22
Condition 4: CA61<CA51<CA41

If the refractive index is explained, the refractive index of the first lens 101 is the largest among the lenses, and may be 1.75 or more, for example, 1.85 or more. The refractive index of the fourth lens 104 is the smallest among the lenses. The difference between the maximum refractive index and the minimum refractive index may be 0.25 or more, for example, 0.30 or more. By adjusting the refractive indices of the spherical lens and the aspherical lens, the incident efficiency can be increased, and the incident light can be guided to the image sensor 300. If the Abbe number is explained, the Abbe number of the sixth lens 106 is the largest among the lenses, and may be 60 or more. The Abbe number of the seventh lens 107 is the smallest among the lenses. The difference between the maximum refractive index and the minimum Abbe number may be 30 or more. The Abbe number of the third and fourth lenses 103 and 104 adjacent to the aperture stop ST is made larger than the Abbe number of the second lens 102 and the fifth lens 105, and the Abbe number of the seventh aspherical lens 107 closest to the image sensor 300 is made smallest, thereby controlling the color dispersion of light traveling between the lenses made of glass, and increasing the color dispersion between the spherical lens and the aspherical lens to guide it to the image sensor 300.

If the average effective diameter of the spherical lenses is GL_CA_Aver, and the average effective diameter of the aspherical lens is GM_CA_Aver, the following condition may satisfy: GM_CA_Aver<GL_CA_Aver. If the average of the center thicknesses of the spherical lenses is GL_CT_Aver, and the average of the center thickness of the aspherical lenses is GM_CT_Aver, the following condition may satisfy: GM_CT_Aver<GL_CT_Aver. The average refractive indices of the spherical lenses are GL_nd_Aver, and the average refractive indices of the aspherical lenses is GM_nd_Aver, so that the following condition may satisfy: GM_nd_Aver<GL_nd_Aver. The average of the Abbe numbers of the spherical lenses is GL_Ad_Aver, and the average of the Abbe numbers of the aspherical lenses is GM_Ad_Aver, so that the following condition may satisfy: GL_Ad_Aver<GM_Ad_Aver.

The focal lengths F1, F5, and F7 of the first, fifth, and seventh lenses 101, 105, and 107 have negative refractive power, and the focal lengths F2, F3, F4, and F6 of the second, third, fourth, and sixth lenses 102, 103, 104, and 106 may have positive refractive power. In addition, the sixth and seventh lenses 106 and 107, which are adjacently arranged lenses, can satisfy the following conditions.
Condition 1: Refractive index of lens with positive refractive power<Refractive index of lens with negative refractive power
Condition 2: Dispersion of lens with positive refractive power>Dispersion of lens with negative refractive power

Here, since the sixth lens 106 has positive refractive power and the seventh lens 107 has negative refractive power, according to the conditions 1 and 2, the refractive index of the sixth lens 106 is smaller than the refractive index of the seventh lens 107, and the dispersion value of the sixth lens 106 is larger than the dispersion value of the seventh lens 107. The chromatic aberration occurring in the fifth lens can be corrected by an aspherical lens. In addition, by satisfying the refractive index difference between the sixth and seventh lenses 106 and 107 arranged sequentially to be 0.25 or more and 0.5 or less and the Abbe number difference to be 30 or more and 70 or less, the chromatic aberration occurring in the spherical lens can be compensated for by an aspherical lens.

The optical system 1000 generates chromatic aberration and corrects the chromatic aberration by using a cemented lens 145 or two lenses arranged in series. The lens contracts and expands repeatedly as the temperature changes from low to high. Since the lens characteristics of lenses of the same material change in accordance with the temperature change in the same amount, it is effective to correct the chromatic aberration between lenses of the same material even when the temperature changes. The chromatic aberration between the spherical lens and the aspherical lens can be mutually corrected by using the fourth and fifth lenses 104 and 105 and the sixth and seventh lenses 106 and 107. The refractive index difference between the fourth lens 104 and the fifth lens 105, which are the cemented lenses, is 0.01 or more and 0.25 or less, and the difference of the Abbe numbers is 20 or more and 50 or less, and the chromatic aberration generated in the spherical lenses can be compensated for by the spherical lens. The refractive index difference is rounded off to the third decimal place, and the Abbe number difference is rounded off to the first decimal place, and the values are compared. In addition, by arranging glass lenses with relatively high Abbe numbers on the object side of the aspherical seventh lens 107, color dispersion can be reduced by the glass lenses and color dispersion can be increased by the aspherical lenses.

When the focal length is expressed as an absolute value, the focal length of the seventh lens 107 is the largest among the lenses and may be 45 or more. The focal length of the fifth lens 105 is the smallest among the lenses. The difference between the maximum focal length and the minimum focal length can be 35 or more. By making the focal length of the lens closest to the sensor the largest and providing the focal length of the fifth lens 105 the smallest, the optical system can have improved MTF characteristics, aberration control characteristics, resolution characteristics, etc. in the set field of view range, and can have good optical performance in the periphery of the field of view.

The sensor-side surface of the seventh lens 107 has a critical point. The critical point is the point where the tendency of the Sag value changes. That is, the point where the Sag value increases and then decreases, or the point where the Sag value decreases and then increases. It can be seen that the sensor-side surface of the seventh lens 107 has a critical point between a point 1.8 mm apart in the direction perpendicular to the optical axis and a point 2.8 mm apart. For example, the sensor-side surface of the seventh lens 107 increases the Sag value from the optical axis to a point of 2.0 mm±0.4 mm in the direction perpendicular to the optical axis, and then decreases toward the edge from a point of 2.0 mm±0.4 mm. If the critical point exists on the sensor-side surface of the seventh lens 107, that is, on the sensor-side surface of the last lens, that is, on the lens surface closest to the sensor, TTL can be reduced, making it easy to miniaturize and lighten the optical system.

As shown in FIG. 4, among the lenses of the lens portion 100 in the embodiment, the lens surfaces of the sixth and seventh lenses 106 and 107 may include aspherical surfaces having a 30th aspherical coefficient. For example, the sixth and seventh lenses 106 and 107 may include lens surfaces having a 30th aspherical coefficient. As described above, since the aspherical surface having the 30th aspherical coefficient (a value other than “0”) can significantly change the aspherical shape of the periphery, the optical performance of the periphery of the field of view (FOV) can be well corrected. As shown in FIG. 5, the thicknesses T1-T7 of the first to seventh lenses 101, 102, 103, 104, 105, 106, and 107 and the distances G1-G6 between adjacent two lenses can be set. As shown in FIG. 5, the thickness of each lens T1-T7 in the Y-axis direction can be expressed at intervals of 0.1 mm or 0.2 mm or more, and the interval between each lens G1-G6 can be expressed at intervals of 0.1 mm or 0.2 mm or more.

The center thickness CT45 of the cemented lens 145 may be greater than the edge thickness ET45. The center thickness CT45 of the cemented lens 145 is a distance in the optical axis direction from the center of the object-side seventh surface S7 of the fourth lens 104 to the center of the tenth surface S10 of the fifth lens 105, and the edge thickness ET45 is a distance in the optical axis direction from the end of the effective region of the seventh surface S7 to the tenth surface S10. The maximum thickness of the cemented lens 145 is at the center, the minimum thickness is at the edge, and the maximum thickness may be 1 or more times the minimum thickness, for example, in the range of 1 to 1.5 times. The cemented lens 145 may satisfy the following condition: 0 mm<CT45-ET45<2 mm. The maximum thickness of the sixth lens 106 is at the center, the minimum thickness is at the edge, and the maximum thickness may be 1.5 or less times the minimum thickness. The maximum thickness of the seventh lens 107 is at the edge, the minimum thickness is at the center, and the maximum thickness may be 1.05 or more times the minimum thickness, for example, in the range of 1.05 to 1.5 times.

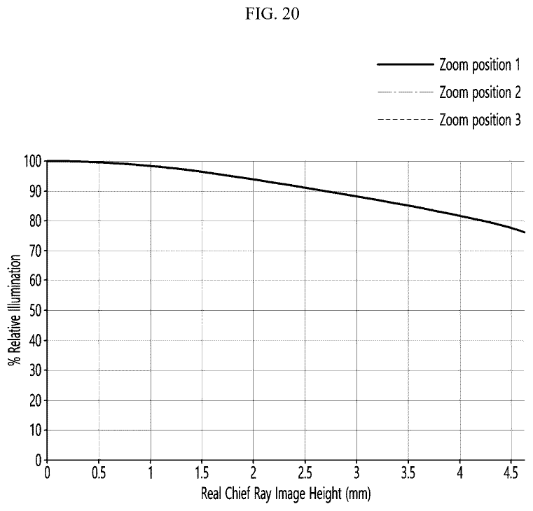

As shown in FIG. 6, in the optical system and camera module of FIG. 1, the chief ray angle (CRA) may be 10 degrees or more, for example, in the range of 10 to 35 degrees or in the range of 10 to 25 degrees. As shown in FIG. 20, a graph showing the relative illumination according to the image height in the optical system according to the embodiment shows that the relative illumination is 70% or more, for example, 75% or more, from the center of the image sensor to the diagonal end. That is, the difference in the relative illumination (Zoom position 1, 2, 3) according to the temperature is almost the same up to 4.4 mm from the optical axis.

FIGS. 7 to 9 are graphs showing the diffraction MTF (Modulation Transfer Function) at room temperature, low temperature, and high temperature in the optical system of FIG. 1, and are graphs showing the modulation according to the spatial frequency. As shown in FIGS. 7 to 9, in the first embodiment of the invention, the deviation of the MTF between the low temperature and the high temperature based on the room temperature may be less than 10%, that is, 7% or less.

FIGS. 10 to 12 are graphs showing aberration characteristics at room temperature, low temperature, and high temperature in the optical system of FIG. 1. In the aberration graphs of FIGS. 10 to 12, longitudinal spherical aberration, astigmatic field curves, and distortion are measured from left to right. In FIGS. 10 to 12, the X-axis may represent a focal length (mm) and a degree of distortion (%), and the Y-axis may represent the height of the image. In addition, the graph for spherical aberration is a graph for light in wavelength bands of about 435 nm, about 486 nm, about 546 nm, about 587 nm, and about 656 nm, and the graphs for astigmatism and distortion are graphs for light in wavelength bands of about 546 nm. In the aberration diagrams of FIGS. 10 to 12, the closer each curve at room temperature, low temperature, and high temperature is to the Y-axis, the better the aberration correction function can be interpreted. It can be seen that the optical system 1000 according to the embodiment has measurement values close to the Y-axis in almost all regions. That is, the optical system 1000 according to the embodiment has improved resolution and can have good optical performance not only in the center portion of the FOV but also in the periphery portion. Here, the low temperature is-20 degrees or lower, for example, in the range of −20 to −40 degrees, the room temperature is in the range of 22 degrees±5 degrees or in the range of 18 degrees to 27 degrees, and the high temperature can be in the range of 85 degrees or higher, for example, in the range of 85 degrees to 105 degrees. Accordingly, it can be seen that the decrease in the luminance ratio (modulation) from the low temperature to the high temperature of FIGS. 10 to 12 is less than 10%, for example, 5% or lower, or is almost unchanged.

Table 1 compares the changes in optical characteristics such as EFL, BFL, F number, TTL, and diagonal FOV at room temperature, low temperature, and high temperature in the optical system according to the first embodiment, and it can be seen that the change rate of optical characteristics at low temperature is 5% or less, for example, 3% or less, based on room temperature, and it can be seen that the change rate of optical characteristics at low temperature is 5% or less, for example, 3% or less, based on room temperature.

TABLE 1

| | | | | Low | High |
|---|---|---|---|---|---|
| | Room | Low | High | temperature/ | temperature/ |
| | temper- | temper- | temper- | room temper- | room temper- |
| | ature | ature | ature | ature (%) | ature (%) |
| EFL | 14.9 | 14.9 | 14.9 | 100.08% | 99.89% |
| BFL | 2.6 | 2.6 | 2.6 | 100.12% | 99.86% |
| F# | 1.6 | 1.6 | 1.61 | 100.08% | 99.89% |
| TTL | 37.7 | 37.7 | 37.7 | 100.08% | 99.91% |
| FOV | 34.2 | 34.3 | 34.2 | 99.90% | 100.12% |

Therefore, as shown in Table 1, it can be seen that the change in optical characteristics according to the temperature change from low temperature to high temperature, for example, the change rate of the effective focal length (EFL), TTL, BFL, F number (F #), and diagonal FOV, is 10% or less, that is, 5% or less, for example, in the range of 0 to 5%. This means that even if at least one or two or more aspherical lenses are used, the design can be made to enable temperature compensation for the aspherical lenses, thereby inhibiting a decrease in the reliability of the optical characteristics. In addition, it can be seen that even if the temperature changes from room temperature to low or high, EFL, TTL, BFL, F number (F #), and diagonal FOV hardly change. The optical system of the embodiment disclosed above can effectively control aberration characteristics such as chromatic aberration and distortion aberration, and can have good optical performance not only at the center portion of the FOV but also at the periphery portion.<Second embodiment>

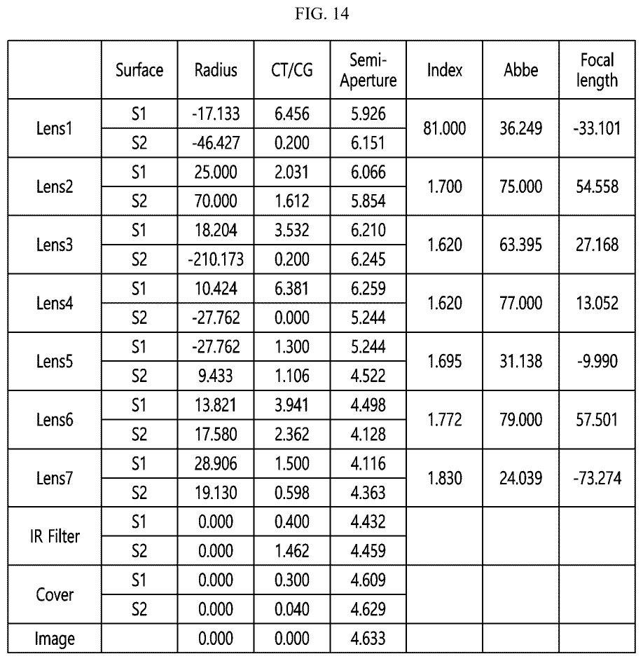

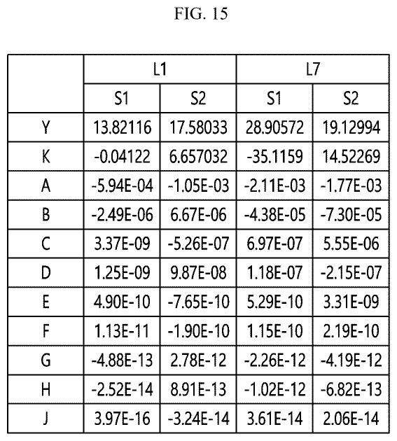

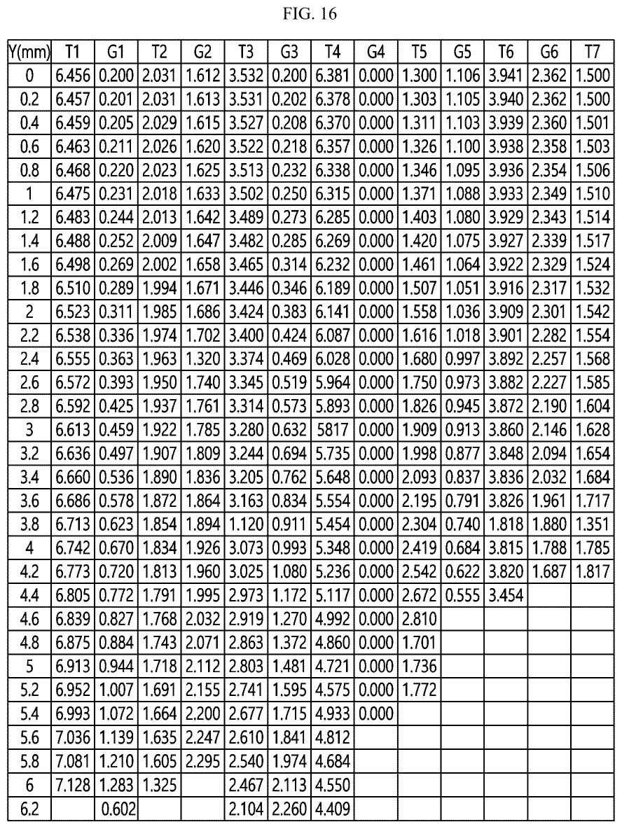

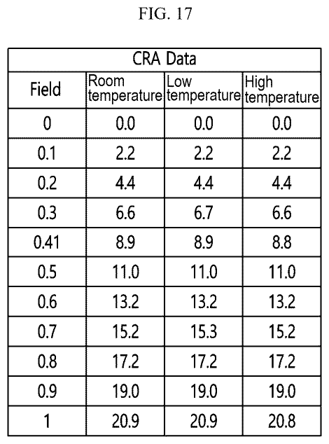

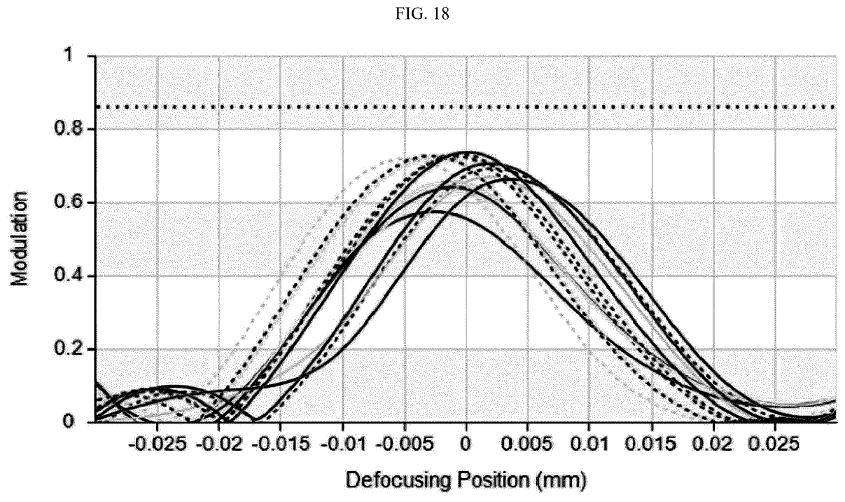

FIG. 13 is a side cross-sectional view of an optical system according to the second embodiment and a camera module having the same, FIG. 14 is a table showing lens characteristics of the optical system of FIG. 13, FIG. 15 is a table showing aspherical coefficients of lenses in the optical system of FIG. 13, FIG. 16 is a table showing thicknesses of each lens and spacing between adjacent lenses in the optical system of FIG. 13, FIG. 17 is a table showing CRA data at room temperature, low temperature, and high temperature according to the position of the image sensor in the optical system of FIG. 13, FIG. 18 is a graph showing data on diffraction MTF at room temperature of the optical system of FIG. 13, and FIG. 18 is a graph showing data on aberration characteristics of the optical system of FIG. 13 at room temperature.

Referring to FIGS. 13 and 14, an optical system 1001 according to the second embodiment includes a lens portion 100A, and the lens portion 100A may include a first lens 111 to a seventh lens 117. The first to seventh lenses 111 to 117 may be sequentially arranged along an optical axis OA. Light corresponding to information about an object may pass through the first lens 111 to the seventh lens 117 and the optical filter 500 and be incident on an image sensor 300. The first lens 111 is the lens closest to the object side in the first lens group LG1. The seventh lens 117 is the lens closest to the image sensor 117 in the second lens group LG2 or the lens portion 100A. The first and second lenses 111 and 112 may be a first lens group LG1, and the third to seventh lenses 113, 114, 115, 116, and 117 may be a second lens group LG2.

The first lens 111 may have positive (+) or negative (−) refractive power on the optical axis OA. The first lens 111 may have negative (−) refractive power. The first lens 111 may include a plastic material or a glass material, and may be, for example, a non-molded glass material. The first lens 111 made of a glass material may reduce changes in the center position and the curvature radius due to temperature changes according to the surrounding environment, and may protect the incident side surface of the optical system 1001. The object-side first surface S1 of the first lens 111 based on the optical axis may have a concave shape, and the sensor-side second surface S2 may have a convex shape. The first lens 111 may have a convex meniscus shape toward the sensor side. Differently, the first surface S1 may have a convex shape, and the second surface S2 may have a concave shape on the optical axis OA. Differently, the first lens 111 may have a concave shape on both sides. The first lens 111 is made of a spherical glass material, has high transmittance and refractive index, and is provided with a thick thickness, thereby inhibiting deterioration of the optical characteristics of the incident-side lens and protecting the surface.

In the optical system 1001, there may be one or more, for example, one to three, lenses made of a glass material having an aspherical surface. The effective radius r11 of the first surface S1 of the first lens 111 may be larger than the effective radii of the object-side surface and the sensor-side surface of the seventh lens 117. Since the first surface S1 is concave and the second surface S2 is convex, the incident light may be refracted in a direction away from the optical axis OA. Accordingly, the distance between the first and second lenses 111 and 112 may be reduced, thereby suppressing an increase in the effective diameter of the second lens 112. The first surface S1 of the first lens 111 may be provided without a critical point from the optical axis OA to the end of the effective region, i.e., the edge. The second surface S2 of the first lens 111 may be provided without a critical point.

The second lens 112 may be arranged between the first lens 111 and the third lens 113. The second lens 112 may have positive (+) or negative (−) refractive power on the optical axis OA. The second lens 112 may have positive (+) refractive power. The second lens 112 may include a plastic or glass material. For example, the second lens 112 may be provided as a glass material. The third surface S3 of the second lens 112 with respect to the optical axis OA may be convex, and the fourth surface S4 may have a concave shape. The second lens 112 may have a meniscus shape that is convex toward the object side on the optical axis. Alternatively, the third surface S3 may be convex, and the fourth surface S4 may have a convex shape. In contrast, the second lens 112 may have a concave shape on both sides or a convex shape toward the sensor side. The second lens 112 may be provided as a spherical lens made of glass. The third surface S3 and the fourth surface S4 may be spherical. At least one or both of the third surface S3 and the fourth surface S4 may be provided without a critical point from the optical axis OA to the end of the effective region.

The aperture stop ST may be arranged around the sensor-side surface of the second lens 112. In contrast, the aperture stop ST may be arranged around the object-side or sensor-side surface of the first lens 111, or around the object-side surface of the second lens 112.

The third lens 113 may have positive (+) or negative (−) refractive power on the optical axis OA. The third lens 113 may have positive (+) refractive power. The third lens 113 may include a plastic or glass material. For example, the third lens 113 may be provided as a glass material. The object-side fifth surface S5 of the third lens 113 on the optical axis may have a convex shape, and the sensor-side sixth surface S6 may have a convex shape. The third lens 113 may have a convex shape on both sides of the optical axis. Alternatively, the third lens 113 may have a meniscus shape convex toward the object side. Alternatively, the third lens 113 may have a meniscus shape convex toward the sensor side. Alternatively, the third lens 113 may have a concave shape on both sides on the optical axis. The third lens 113 may be provided as a spherical lens made of glass. The fifth surface S5 and the sixth surface S6 may be spherical. At least one or both of the fifth surface S5 and the sixth surface S6 may be provided without a critical point from the optical axis OA to the end of the effective region.

Since the third lens 113 adjacent to the sensor side of the aperture stop ST has positive refractive power (F3>0), the third lens 113 may refract incident light in the direction of the optical axis, and may suppress an increase in the effective diameter of the sensor-side or rear-side lenses of the third lens 113. Accordingly, the yield by weight of the optical system can be inhibited from decreasing by the third lens 113, and production efficiency can be improved. Here, the composite focal length of the third to seventh lenses 113-117 arranged on the sensor side of the aperture stop ST may have a positive value, and can reduce the TTL within a range of FOV.

The fourth lens 114 may have positive (+) or negative (−) refractive power on the optical axis OA. The fourth lens 114 may have positive (+) refractive power. The fourth lens 114 may include a plastic or glass material. For example, the fourth lens 114 may be provided as a glass material. The object-side seventh surface S7 of the fourth lens 114 on the optical axis may have a convex shape, and the sensor-side eighth surface S8 may have a convex shape. The fourth lens 114 may have a convex shape on both sides. Alternatively, the seventh surface S7 may have a concave shape, and the eighth surface S8 may have a concave shape on the optical axis OA. Alternatively, the fourth lens 114 may have a convex meniscus shape on the object side or the sensor side. The fourth lens 114 may be provided as a spherical lens made of glass. The seventh surface S7 and the eighth surface S8 may be spherical. The seventh surface S7 and eighth surface S8 may be provided without a critical point from the optical axis OA to the end of the effective region.

The fifth lens 115 can have positive (+) or negative (−) refractive power on the optical axis OA. The fifth lens 115 can have negative (−) refractive power. The fifth lens 115 can include a plastic or glass material. For example, the fifth lens 115 may be provided with a glass material. Based on the optical axis OA, the object-side ninth surface of the fifth lens 115 may have a concave shape, and the sensor-side tenth surface S10 may have a concave shape. The fifth lens 115 may have a concave shape on both sides on the optical axis OA. Alternatively, the ninth surface may have a convex shape on the optical axis OA, and the tenth surface S10 may have a concave shape. Alternatively, the ninth surface may have a concave shape on the optical axis OA, and the tenth surface S10 may have a convex shape. The ninth surface and the tenth surface S10 may be spherical. At least one or both of the ninth surface and the tenth surface S10 may be provided without a critical point from the optical axis OA to the end of the effective region.

The fourth lens 114 and the fifth lens 115 may be cemented, and may be defined as a cemented lens 145A. The bonding surface between the fourth lens 114 and the fifth lens 115 may be defined as the eighth surface S8. The eighth surface S8 may be the same surface as the ninth surface of the fifth lens 115. When the distance between the fourth and fifth lenses 114 and 115 is G4, G4 may be less than 0.01 mm. The distance G4 between the fourth and fifth lenses 114 and 115 may be less than 0.01 mm from the optical axis OA to the end of the effective region. The fourth and fifth lenses 114 and 115 may have opposite refractive powers. The composite refractive power of the fourth and fifth lenses 114 and 115 may have positive refractive power. If the composite refractive power of the cemented lens 145A is F45, the composite refractive power of the first and second lenses 101 and 102 is F12, and the composite refractive power of the third to seventh lenses 103-107 is F37, the following condition in absolute value may satisfy: F37<F12<F45.

The product of the refractive power of the object-side fourth lens 114 of the cemented lens 145A and the refractive power of the sensor-side fifth lens 115 may be less than 0. The product of the focal length of the object-side fourth lens 114 of the cemented lens 145A and the focal length of the sensor-side fifth lens 115 may be less than 0. Accordingly, the aberration characteristics of the optical system can be improved. If the refractive powers of the two lenses of the cemented lens 145A are equally negative or positive, there is a limit to the improvement of aberration. The composite refractive power of the cemented lens 145A has positive refractive power, and the third lens 113 arranged on the object side with respect to the cemented lens (145A) and the sixth lens 116 arranged on the sensor side can have positive refractive power. Accordingly, the third lens 113, the cemented lens 145A, and the sixth lens 116 may refract some of the incident light in the direction of the optical axis.

The effective diameter of the fourth lens 114 may be larger than the diagonal length of the image sensor 300. The effective diameter of the fourth lens 114 is an average of the effective diameters of the seventh surface S7 and the eighth surface S8, and may be larger than the diagonal length of the image sensor 300. The effective diameter of the fifth lens 115 may be smaller than the effective diameter of the fourth lens 114 and may have a length within a range of +110% or +105% of the diagonal length of the image sensor 300. The effective diameter of the seventh surface S7 of the fourth lens 114 may be larger than the diagonal length of the image sensor 300, and the effective diameter of the tenth surface S10 of the fifth lens 115 may be smaller than the diagonal length of the image sensor 300. When the fifth lens 115 is a spherical lens and the sixth and seventh lenses 116 and 117 are aspherical lenses, the difference in effective diameter between the object-side ninth surface of the fifth lens 115 and the sensor-side tenth surface S10 may be large. For example, when the effective diameter of the ninth surface of the fifth lens 115 and the effective diameter of the tenth surface S10 on the sensor side are CA51 and CA52, the following condition may satisfy: CA52<(2*ImgH)<CA51. Here, 2*ImgH is a diagonal length of the image sensor 300. When the effective diameter of the object-side surface of the cemented lens 145A is CA41 and the effective diameter of the sensor-side surface is CA52, the following condition may satisfy: 2 mm<(CA41-CA51). The effective diameter of the cemented lens 145A may satisfy the following condition: 1.1<CA41/CA52<1.5. The difference between the effective diameter of the object-side surface and the effective diameter of the sensor-side surface of the cemented lens 145A may be the largest within the lens portion. Accordingly, by maximizing the difference in effective diameter between the object-side surface and the sensor-side surface of the cemented lens 145A, light traveling through an aspherical lens having a relatively small effective diameter may be effectively guided.

Since the cemented lens 145A is bonded with glass lenses having different refractive indices and has a spherical refractive surface, and at least one lens positioned on the sensor side relative to the cemented lens 145A is positioned as an aspherical lens, spherical aberration occurring between the lenses can be compensated for. In addition, since at least one of the lenses positioned on the sensor side relative to the cemented lens 145A is an aspherical lens and is positioned with a small effective diameter, light traveling through the aspherical lens to the image sensor 300 can be effectively guided. Since the position of the cemented lens 145A is located between the spherical lens and the aspherical lens, chromatic aberration correction may be more efficient.

The sixth lens 116 may have positive (+) or negative (−) refractive power on the optical axis OA. The sixth lens 116 may have positive (+) refractive power. The sixth lens 116 may include a plastic or glass material. For example, the sixth lens 116 may be provided as a glass material. With respect to the optical axis OA, the object-side eleventh surface S11 of the sixth lens 116 may be convex, and the sensor-side twelfth surface S12 may be concave. The sixth lens 116 may have a meniscus shape convex toward the object side on the optical axis OA. Alternatively, the sixth lens 116 may have a meniscus shape convex toward the sensor side, or a convex shape on both sides. Alternatively, the sixth lens 116 may have a concave shape on both sides. The sixth lens 116 may be made of glass and may have aspherical surfaces on both sides. The eleventh surface S11 and the twelfth surface S12 may have aspherical surfaces, and aspherical coefficients may be provided as S1 and S2 of L6 in FIG. 15. Since the sixth lens 116 is made of aspherical glass, the refractive efficiency of light may be improved, and the thickness may be increased to improve the assembling problem caused by the aspherical lens. In addition, the sixth lens 116 made of glass with a thick thickness may be thermally compensated according to temperature changes, thereby inhibiting deterioration of optical characteristics. Since the sixth lens 116 is arranged between the spherical lens and the aspherical lens, deterioration of optical performance may be inhibited, and the influence on aberration characteristics and resolution may be controlled. The eleventh surface S11 of the sixth lens 116 may be provided without a critical point from the optical axis OA to the end of the effective region. The twelfth surface S12 can be provided without a critical point from the optical axis OA to the end of the effective region.

The seventh lens 117 may have positive (+) or negative (−) refractive power on the optical axis OA. The seventh lens 117 can have negative (−) refractive power. The above seventh lens 117 can include a plastic or glass material. For example, the seventh lens 117 can be a glass material or a glass mold material. The object-side thirteenth surface S13 of the seventh lens 117 on the optical axis may have a convex shape, and the sensor-side fourteenth surface S14 may have a concave shape. The seventh lens 117 may have a meniscus shape that is convex on the object side on the optical axis. In contrast, the thirteenth surface S13 on the optical axis OA may have a concave shape, and the fourteenth surface S14 may have a convex shape. In contrast, the seventh lens 117 may have concave shapes on both sides. The seventh lens 117 may be made of glass and may have aspherical surfaces on both sides. The thirteenth surface S13 and the fourteenth surface S14 have aspherical surfaces, and aspherical coefficients may be provided as S1 and S2 of L7 of FIG. 15. The seventh lens 117 may be an aspherical lens closest to the image sensor 300. By arranging the aspherical lenses as the two lenses closest to the image sensor 300, it is possible to inhibit deterioration of optical performance, improve aberration characteristics, and control the influence on resolution. In addition, by arranging the aspherical lens as two lenses adjacent to the image sensor 300, it can be insensitive to the assembly tolerance compared to the spherical lens. In other words, being insensitive to the assembly tolerance means that even if the assembly is assembled with a slight difference compared to the design, it may not significantly affect the optical performance.

At least one or both of the thirteenth surface S13 and the fourteenth surface S14 of the seventh lens 117 can have a critical point. The thirteenth surface S13 of the seventh lens 117 may have at least one critical point from the optical axis OA to the end of the effective region. The critical point of the thirteenth surface S13 can be located at 57% or less of the effective radius from the optical axis OA, or in the range of 37% to 57%, or in the range of 42% to 52%. The critical point of the thirteenth surface S13 can be located at a position less than or equal to 2.4 mm from the optical axis OA, for example, in a range of 2.0 mm±0.4 mm. As another example, the thirteenth surface S13 can be provided without a critical point. The fourteenth surface S14 of the seventh lens 117 can have at least one critical point from the optical axis OA to an end of the effective region. The critical point of the fourteenth surface S14 can be located at a distance of 53% or more of the effective radius from the optical axis OA, or in a range of 53% to 73% or in a range of 58% to 68%. The critical point of the fourteenth surface S14 can be located at a position greater than or equal to 2.4 mm from the optical axis OA, for example, in a range of 2.8 mm±0.4 mm. Since the critical point of the fourteenth surface S14 is arranged closer to the edge than the critical point of the thirteenth surface S13, the fourteenth surface S14 can refract light incident through the thirteenth surface S13 to the periphery of the image sensor 300.

In the sixth lens 116, if the Sag value of the object-side surface is Sag61 and the Sag value of the sensor-side surface is Sag62, the following condition may satisfy: 0<Sag61-Sag62<0.3 mm. Accordingly, the difference in thickness between the center and edge of the sixth lens 116 is not large, and the influence on the optical characteristics may be suppressed. In the seventh lens 117, if the Sag value of the object-side surface is Sag71 and the Sag value of the sensor-side surface is Sag72, the following condition may satisfy: 0<|Sag71|−|Sag72|<0.3 mm. Accordingly, since the difference in thickness between the center and edge of the seventh lens 117 is not large and the curvature radius is not large, the influence on the optical characteristics can be suppressed. Since the sixth and seventh lenses 116 and 117 are arranged with an aspherical glass material, they are resistant to temperature changes due to heat, can reduce the number of lenses, and can reduce the TTL of the optical system.

FIG. 14 is an example of lens data of the optical system of the embodiment of FIG. 13. As shown in FIG. 14, the curvature radius on the optical axis OA of the first to seventh lenses 111 to 117, the center thickness CT of the lenses, the center distance CG between adjacent lenses, the refractive index at the d-line, the Abbe number, and the size of the effective diameter (i.e., Clear aperture; CA) may be set. When the curvature radius of each lens is expressed as an absolute value on the optical axis, the curvature radius of the sixth surface S6 of the third lens 113 on the optical axis OA may be the largest among the lenses, and the curvature radius of the tenth surface S10 of the fifth lens 115 may be the smallest among the lenses. The difference between the maximum curvature radius and the minimum curvature radius may be 15 times or more, for example, 20 times or more. In addition, when the first to third lenses 111, 112, and 113 are the first group and the fourth to seventh lenses 114, 115, 116, and 117 are the second group, the curvature radius of each lens of the second group may be smaller than the curvature radius of each lens of the first group. In addition, the difference between the absolute values of the radii of curvature of the object-side surface and the sensor-side surface of each lens of the second group may be smaller than the difference between the absolute values of the radii of curvature of the object-side surface and the sensor-side surface of each lens of the first group. Accordingly, the lenses of the first group can transmit incident light to the second group without loss, and the lenses of the second group can stably guide the light incident through the first group to the image sensor 300. That is, the absolute value of the curvature radius of the first lens 111, which is a spherical lens, can be greater than the absolute value of the curvature radius of the fourth to sixth lenses 114, 115, and 116, which are spherical lenses. The absolute value of the curvature radius of the first to third lenses 111, 112, and 113, which are spherical lenses, can be greater than the absolute value of the curvature radius of the sixth and seventh lenses 116 and 117, which are aspherical lenses. Accordingly, the aspherical lens can be used to refract light uniformly over the entire region of the image sensor 300. In addition, the curvature radius of the sixth and seventh lenses 116 and 117 may be reduced, thereby lowering the Sag value from the center to the edge of each lens surface, improving the assemblability, improving the aberration characteristics by the aspherical lens, and reducing the number of lenses.

The absolute value of the curvature radius of the first lens 111 on the optical axis may be smaller than the absolute value of the curvature radius of the second lens 112 arranged on the sensor side of the aperture stop ST and smaller than the curvature radius of the third lens 113 arranged on the object side. Here, the curvature radius is the average of the absolute values of the curvature radius of the object-side surface and the sensor-side surface of each lens. Since the first lens 111 is a spherical lens, even if the curvature radius of the first lens 111 is smaller than the curvature radius of the second and third lenses 112 and 113, the assemblability may not be affected.

In absolute value, the average of the radii of curvature of the first surface S1 and the second surface S2 of the first lens 111 may be 25 mm or more, for example, in a range of 25 mm to 60 mm or in a range of 25 mm to 35 mm. In absolute value, the radii of curvature of each of the first surface S1 and the second surface S2 of the first lens 111 may be 10 mm or more, for example, in a range of 10 mm to 70 mm. In absolute value, the difference between the radii of curvature of the first surface S1 and the second surface S2 of the first lens 111 may be 15 mm or more, for example, in a range of 15 mm to 40 mm. In absolute value, the difference in the curvature radius between the first surface S1 and the second surface S2 of the first lens 111 may be smaller than the difference in the curvature radius between the object-side surface and the sensor-side surface of the object-side lens 113 of the aperture stop ST, and further, in absolute value, the difference in the curvature radius between the first surface S1 and the second surface S2 of the first lens 111 may be smaller than the difference in the curvature radius between the object-side surface and the sensor-side surface of the lens 114 arranged on the sensor side of the aperture stop ST. Here, the object-side lens of the aperture stop ST is the second lens 112, the sensor-side lens is the third lens 113, and the other lenses are the fourth to seventh lenses 114 to 117. The curvature radius is an average of the absolute values of the radii of curvature of the object-side surface and the sensor-side surface. The absolute value of the curvature radius of the object-side surface of the i-th lens is Roi, the absolute value of the sensor-side curvature radius is Rsi, and the absolute value of the average of the object-side surface and the sensor-side surface is Ri. The value of (Roi−Rsi)/Ri may be minimum when i is 6 and maximum when i is 3. Here, when i is 6 or 7, the value of (Roi−Rsi)/Ri may be less than 1, for example, 0.6 or less. Accordingly, each of the plurality of aspherical lenses may have a difference between the curvature radius of the object-side surface and the sensor-side surface and the average of the curvature radius of each aspherical lens smaller than that of the spherical lenses.

Since the first lens 111 is provided as a spherical lens having a thick thickness, the curvature radius on the optical axis may be increased, the difference between the curvature radius of the object-side surface and the sensor-side surface may not be greatly reduced, and the assemblability can be improved.

The curvature radius of the sixth lens 116 on the optical axis may be smaller than the curvature radius of the first spherical lens 111. The curvature radius of the seventh lens 117 on the optical axis may be larger than the curvature radius of the sixth lens 116. Accordingly, the aspherical seventh lens 117 may guide light incident through the first to sixth lenses 111-116 to the entire region of the image sensor 300. The radii of curvature of the first and second surfaces S1 and S2 of the first lens 111 on the optical axis are defined as LIR1, L1R2, the radii of curvature of the thirteenth and fourteenth surfaces S13 and S14 of the seventh lens 117 on the optical axis are defined as L7R1, L7R2, and the radii of curvature of each lens surface of the second to sixth lenses 112-116 on the optical axis can be defined as L2R1, L2R2, L3R1, L3R2, L4R1, L4R2 (L5R1), L5R2, L6R1, and L6R2.
Condition 1: 0<|LIR1/L1R2|<1
Condition 2:0<|L2R1/L2R2|<1
Condition 3: 0<L3R1/L3R2<0.5
Condition 4:0<L4R1/L4R2<1
Condition 5: 1<L5R1/L5R2<5
Condition 6:0.5<L6R1/L6R2<1.2
Condition 7: 1<L7R1/L7R2<2.2
Condition 8: |LIR2-L1R1|<|L2R2-L2R1|<|L3R2-L3R1|
Condition 9: 5 mm≤(L7R1-L7R2)≤25 mm
Condition 10: 25 mm≤L1R12≤60 mm

Here, LIR12 is the average of the curvature radii of the first and second surfaces S1 and S2 of the first lens 111.

Describing the thickness of the lenses, the center thickness CT1 of the first lens 111 may be greater than the center thicknesses CT2, CT3, CT5, C56, and CT7 of the second, third, fifth, sixth, and seventh lenses 112, 103, 105, 106, and 117, and may have the maximum thickness within the lens portion 100A. The center thickness CT7 of the seventh lens 117 may be smaller than the center thicknesses CT1-CT4 of the first to fourth lenses 111-114, and the center thickness CT5 of the fifth lens 115 may have a minimum thickness within the lens portion 100A. The center thickness CT1 of the first lens 111 may be smaller than the center thickness CT45 of the cemented lens 145A. The edge thickness ET1 of the first lens 111 may be larger than the edge thickness ET45 of the cemented lens 145A. The center thickness and the edge thickness of each lens may satisfy the following conditions.
Condition 1:0.6<CT1/ET1<1.2
Condition 2:0.5<CT2/ET2<2
Condition 3: 1<CT3/ET3<5
Condition 4:1.2<CT4/ET4<5
Condition 5: 0<CT5/ET5<1
Condition 6:0.6<CT6/ET6<3
Condition 7:0.6<CT7/ET7<1.2
Condition 8:0.8<ΣCT/ΣET<1.2

In this way, the difference between the center thickness and the edge thickness of each lens can be set to more than 0.6 mm and less than 3 mm. This allows the aspherical lens to be placed on the sixth and seventh lenses 116 and 117 to effectively guide light without increasing the difference between the center thickness and the edge thickness of each lens. In addition, by designing the difference between the center thickness and edge thickness of each lens to be small, it is possible to suppress the influence on optical characteristics due to assembly.

In addition, the difference between the maximum center thickness and the minimum center thickness in the lenses may be more than 3 mm, for example, in the range of 4 mm to 9 mm or 4.5 mm to 6 mm. That is, even if the center thickness of the last aspherical lens is provided thinly, the optical performance may not be degraded, and the thickness of the camera module may be provided slimly.

The center distance CG7 between the sixth lens 116 and the seventh lens 117 is maximum and is larger than the center distance between the spherical lens and the aspherical lens. The center distance CG6 between the sixth lens 116 and the seventh lens 117 may satisfy the following condition: CG1<CG2<CG6. That is, the distance CG6 between the adjacent object-side spherical lens and the sensor-side aspherical lens may satisfy the following condition: CT7<CG6<CT6<CT1. The center thickness of each lens and the center distance between the adjacent lenses may satisfy the following conditions.
Condition 1: 20<CT1/CG1<60
Condition 2:2≤CT1/CG6<5
Condition 3: 1<CT6/CG6<5
Condition 4: 5<CT45<CG5<10
Condition 5:0.1<CG2/ΣCG<0.6

By providing the maximum center thickness between the lenses to be at least twice the maximum center distance, for example, in the range of 2 to 4 times, it is possible to provide a camera module in which aspherical lenses are applied to the incident side and the output side of the optical system without increasing the center distance compared to the center thickness of each lens. Here, if the i-th center distance among the center distances of two adjacent lenses is defined as CGi, and the center thickness of the i-th lens arranged on the object side relative to CGi is defined as CTi, the following conditions can be satisfied. (Here, the thickness of the cemented lens and the distance between the cemented lenses are excluded) The ratio of CTi/CGi may be maximum when i is 1 and minimum when i is 5.

When the optical axis distance from the center of the object-side surface of the first lens 111 to the surface of the image sensor 300 is TTL, the following conditions may be satisfied.
Condition 1: 0<CT1/TTL<0.5
Preferably, Condition 1 may satisfy 0<CT1/TTL<0.25.
Condition 2: 0<CT2/TTL<0.5
Preferably, Condition 2 may satisfy 0<CT1/TTL<0.1.
Condition 3: 0<CT3/TTL<0.1
Condition 4:0.1<CT4/TTL<0.25
Condition 5: 0<CT5/TTL<0.1
Condition 6: 0<CT6/TTL<0.2
Condition 7:0<CT7/TTL<0.1

The ratio of CT1/TTL in Condition 1 may be greater than the values in Conditions 2 to 7.

As for the effective diameter, the lens having the maximum effective diameter may be the third lens 113 adjacent to the aperture stop. The third lens 113 having the maximum effective diameter may be a spherical lens. The lens having the minimum effective diameter may be the lens closest to the image sensor 300, for example, the seventh lens 117. The effective diameter may satisfy the following conditions.
Condition 1: CA22<CA12
Condition 2: CA71<CA72
Condition 3: CA22<CA31
Condition 4: CA61<CA51<CA41
Condition 5: CA2<CA1<CA3
Condition 6: CA5<CA4<CA3

If the refractive index is explained, the refractive index of the first lens 111 is the largest among the lenses and may be 1.75 or more, for example, 1.85 or more. The refractive index of the fourth lens 114 is the smallest among the lenses. The difference between the maximum refractive index and the minimum refractive index may be 0.25 or more, for example, 0.30 or more. By adjusting the refractive indices of the spherical lens and the aspherical lens, the incident efficiency can be increased and the incident light can be guided to the image sensor 300. If the Abbe number is explained, the Abbe number of the sixth lens 116 is the largest among the lenses and may be 60 or more. The Abbe number of the seventh lens 117 is the smallest among the lenses. The difference between the maximum refractive index and the minimum Abbe number can be 30 or more. The Abbe numbers of the third and fourth lenses 113 and 114 adjacent to the aperture stop ST are made larger than the Abbe numbers of the second lens 112 and the fifth lens 115, and the Abbe number of the seventh aspherical lens 117 closest to the image sensor 300 is made the smallest, thereby controlling the color dispersion of light traveling between the lenses made of glass, and increasing the color dispersion between the spherical lens and the aspherical lens to guide it to the image sensor 300.

If the average effective diameter of the spherical lens is GL_CA_Aver, and the average effective diameter of the aspherical lens is GM_CA_Aver, the following condition may satisfy: GM_CA_Aver<GL_CA_Aver. If the average of the center thickness of the spherical lens is GL_CT_Aver, and the average of the center thickness of the aspherical lens is GM_CT_Aver, then the following condition may satisfy: GM_CT_Aver<GL_CT_Aver. If the average of the refractive index of the spherical lens is GL_nd_Aver, and the average of the refractive index of the aspherical lens is GM_nd_Aver, then the following condition may satisfy: GM_nd_Aver<GL_nd_Aver. If the average of the Abbe number of the spherical lens is GL_Ad_Aver, and the average of the Abbe number of the aspherical lens is GM_Ad_Aver, then the following condition may satisfy: GL_Ad_Aver<GM_Ad_Aver.

The focal lengths F1, F5, and F7 of the first, fifth, and seventh lenses 111, 115, and 117 may have negative refractive power, and the focal lengths F2, F3, F4, and F6 of the second, third, fourth, and sixth lenses 112, 113, 114, and 116 may have positive refractive power. In addition, the sixth and seventh lenses 116 and 117, which are adjacently arranged lenses, may satisfy the following conditions.
Condition 1: Refractive index of lens with positive refractive power<Refractive index of lens with negative refractive power
Condition 2: Dispersion of lens with positive refractive power>Dispersion of lens with negative refractive power

Here, since the sixth lens 116 has positive refractive power and the seventh lens 117 has negative refractive power, according to the following conditions 1 and 2, the refractive index of the sixth lens 116 is smaller than the refractive index of the seventh lens 117, and the dispersion value of the sixth lens 116 is larger than the dispersion value of the seventh lens 117. The chromatic aberration occurring in the fifth lens can be corrected by an aspherical lens. In addition, by satisfying the refractive index difference between the sixth and seventh lenses 116 and 117 arranged sequentially being 0.25 or more and 0.5 or less and the Abbe number difference being 30 or more and 70 or less, the chromatic aberration occurring in the spherical lens can be compensated for by an aspherical lens. The optical system 1001 generates chromatic aberration and corrects the chromatic aberration by using a cemented lens 145A or two lenses arranged in series. The lens contracts and expands repeatedly as the temperature changes from low to high. Since the amount of change in lens characteristics according to the temperature change is the same for lenses of the same material, it is effective to correct the chromatic aberration between lenses of the same material even when the temperature changes. The chromatic aberration between the spherical lens and the aspherical lens can be mutually corrected by using the fourth and fifth lenses 114 and 115 and the sixth and seventh lenses 116 and 117, and the TTL of the optical system can be reduced. The refractive index difference between the fourth lens 114 and the fifth lens 115, which are the cemented lenses, satisfies 0.01 or more and 0.25 or less, and the Abbe number difference satisfies 20 or more and 50 or less, and the chromatic aberration generated in the spherical lenses can be compensated for by the spherical lens. The difference in refractive index is rounded to the third decimal place, and the difference in Abbe number is rounded to the first decimal place to compare the values. In addition, by arranging glass lenses with relatively high Abbe numbers on the object side of the aspherical seventh lens 117, the chromatic dispersion can be reduced by the glass lenses, and the chromatic dispersion can be increased by the aspherical lenses.

If the focal length is expressed as an absolute value, the focal length of the seventh lens 117 is the largest among the lenses and may be 45 or more. The focal length of the fifth lens 115 is the smallest among the lenses. The difference between the maximum focal length and the minimum focal length may be 35 or more. By making the focal length of the lens closest to the sensor the largest and providing the focal length of the fifth lens 115 the smallest, the optical system can have improved MTF characteristics, aberration control characteristics, resolution characteristics, etc. in the set field of view range, and can have good optical performance in the periphery of the field of view.

The critical point and Sag value of the object-side surface and the sensor-side surface of the seventh lens 117 will be referred to the description of the first embodiment. It can be seen that the sensor-side surface of the seventh lens 117 has a critical point between a point spaced 1.8 mm apart and a point spaced 2.8 mm apart in the direction perpendicular to the optical axis based on the optical axis. For example, the sensor-side surface of the seventh lens 117 increases the Sag value from the optical axis to a point of 2.0 mm±0.4 mm in a direction perpendicular to the optical axis, and then decreases the Sag value toward the edge from a point of 2.0 mm±0.4 mm. If a critical point exists on the sensor-side surface of the seventh lens 117, that is, the sensor-side surface of the last lens, that is, the lens surface closest to the sensor, the TTL can be reduced, making it easy to miniaturize and lighten the optical system.

As shown in FIG. 15, among the lenses of the lens portion 100A in the embodiment, the lens surfaces of the sixth and seventh lenses 116 and 117 may include aspherical surfaces having a 30th aspherical coefficient. For example, the sixth and seventh lenses 116 and 117 may include lens surfaces having a 30th aspherical coefficient. As described above, since an aspheric surface having a 30th aspheric coefficient (a non-zero value) can significantly change the aspheric shape of the periphery, the optical performance of the periphery of the FOV may be well compensated. As shown in FIG. 16, the thicknesses T1-T7 of the first to seventh lenses 111, 112, 113, 114, 115, 116, and 117 and the distances G1-G6 between adjacent two lenses can be set. As shown in FIG. 16, the thickness T1-T7 of each lens in the Y-axis direction can be expressed at intervals of 0.1 mm or 0.2 mm or more, and the distances G1-G6 between adjacent lenses can be expressed at intervals of 0.1 mm or 0.2 mm or more. The center thickness CT45 of the cemented lens 145 may be greater than the edge thickness ET45. The center thickness CT45 of the cemented lens 145 is the distance from the center of the object-side seventh surface S7 of the fourth lens 114 to the center of the tenth surface S10 of the fifth lens 115, and the edge thickness ET45 is the distance from the end of the effective region of the seventh surface S7 to the tenth surface S10 in the optical axis direction. The maximum thickness of the cemented lens 145A is the center, the minimum thickness is the edge, and the maximum thickness may be 1.1 times or more of the minimum thickness, for example, 1.1 to 2.5 times, and may satisfy the following condition: 0 mm<CT45-ET45<1.5 mm.

As shown in FIG. 17, CRA of the optical system and camera module of FIG. 13 may be 10 degrees or more, for example, in a range of 10 to 35 degrees or 10 to 25 degrees. As shown in FIG. 20, a graph showing the relative illumination or the ambient light ratio according to the image height in the optical system according to the embodiment shows that the ambient light ratio from the center of the image sensor to the diagonal end is 70% or more, for example, 75% or more. That is, it can be seen that the difference in the ambient illumination (Zoom positions 1, 2, 3) according to the temperature has almost no difference up to 4.4 mm from the optical axis. FIG. 18 is a graph showing the diffraction MTF at room temperature in the optical system of FIG. 13, and is a graph showing the luminance ratio (modulation) according to the spatial frequency. In the second embodiment of the invention, the deviation of MTF between low temperature and high temperature based on room temperature may be less than 10%, that is, 7% or less.

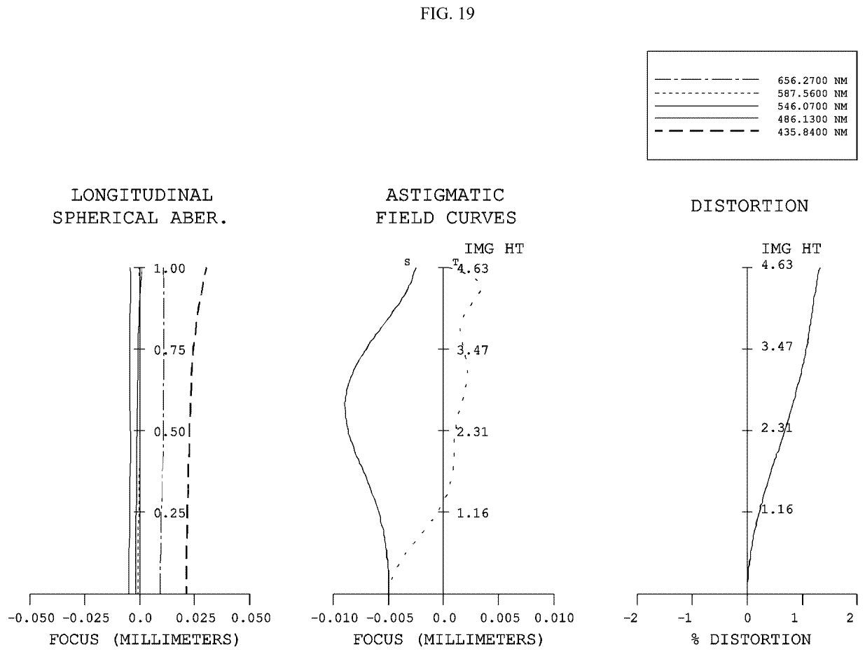

FIG. 19 is a graph showing the aberration characteristics at room temperature in the optical system of FIG. 13. In the aberration graph of FIG. 19, longitudinal spherical aberration, astigmatic field curves, and distortion are measured from left to right. In FIG. 19, the X-axis may represent the focal length (mm) and distortion (%), and the Y-axis may represent the height of the image. In addition, the graph for spherical aberration is a graph for light in wavelength bands of about 435 nm, about 486 nm, about 546 nm, about 587 nm, and about 656 nm, and the graph for astigmatism and distortion is a graph for light in wavelength bands of about 546 nm. In the aberration diagram of FIG. 19, it can be interpreted that the closer each curve at room temperature is to the Y-axis, the better the aberration correction function is. It can be seen that the optical system 1001 according to the embodiment has measurement values close to the Y-axis in almost all regions. That is, the optical system 1001 according to the embodiment has improved resolution and can have good optical performance not only in the center portion of the FOV but also in the periphery portion. Here, the low temperature is-20 degrees or lower, for example, in the range of −20 to −40 degrees, the room temperature is in the range of 22 degrees±5 degrees or in the range of 18 degrees to 27 degrees, and the high temperature can be in the range of 85 degrees or higher, for example, in the range of 85 degrees to 105 degrees. Accordingly, it can be seen that the decrease in the luminance ratio (modulation) from the low temperature to the high temperature of FIGS. 10 to 12 is less than 10%, for example, 5% or lower, or is almost unchanged.

Therefore, it can be seen that the optical system according to the second embodiment has a change in optical characteristics due to temperature changes from low to high temperatures, for example, a change rate of EFL, TTL, BFL, F number, and diagonal FOV of 10% or less, that is, 5% or less, for example, in the range of 0 to 5%. This design enables temperature compensation for aspherical lenses even when at least one or two or more aspherical lenses are used, thereby inhibiting a decrease in reliability of optical characteristics. The optical system according to the above-described embodiment can effectively control aberration characteristics such as chromatic aberration and distortion aberration, and can have good optical performance not only in the center portion but also in the periphery portion of the FOV.

The optical system 1000 and 1001 according to the above-described embodiment can satisfy at least one or two or more of the mathematical equations described below. Accordingly, the optical system 1000 and 1001 according to the embodiment can have improved optical characteristics. For example, when the optical system 1000 and 1001 satisfies at least one Equation, the optical system 1000 and 1001 can effectively control aberration characteristics such as chromatic aberration and distortion aberration, and can have good optical performance not only at the center portion of the FOV but also at the periphery portion. In addition, the optical system 1000 and 1001 can have improved resolution. In addition, the thickness of the lens at the optical axis OA and the distance of adjacent lenses on the optical axis OA described in the Equations can refer to the embodiments disclosed above.

2<CT1/CT2<8 [Equation 1]

In Equation 1, CT1 means the center thickness of the first lens 101 and 111, and CT2 means the center thickness of the second lens 102 and 112. Equation 1 may improve the chromatic aberration of the optical system by setting the difference in the center thickness of the first and second lenses. Equation 1 satisfies 3<CT1/CT2<7 in the first embodiment, and 2<CT1/CT2<4 in the second embodiment. By increasing the thickness of the first lens 101 and 111 made of glass, the change in optical characteristics due to temperature change can be suppressed, and the optical performance of the center and periphery portions of the FOV can be improved.

(CT7*CA7)<(CT1*CA1) [Equation 2]

CT7 is the center thickness of the seventh lens 107 and 117, CA1 is the effective diameter of the first lens 101 and 111, and CA7 is the effective diameter of the seventh lens. The effective diameter is the average of the effective diameters of the object-side surface and the sensor-side surface of each lens. Preferably, the following conditions may satisfy: CT7<CT1 and CA7<CA1. By setting the thickness and effective diameter of the aspherical first and seventh lenses, the optical system can improve spherical aberration and provide a slim camera module.

Po1<0 [Equation 3]

In Equation 3, Po1 represents the refractive power of the first lens 101, and can be set to have a short effective focal length (F) compared to TTL in the optical system for the performance of the optical system. Accordingly, TTL>F can be satisfied, and for example, TTL can be in the range of 1.5 times or more, for example, 1.5 times to 3 times the effective focal length (F).

1.7<n2<2.2 [Equation 4]

n2 is the refractive index of the d-line of the second lens 102 and 112. Equation 4 sets the refractive index of the second lens high, so that it can control the factor affecting the reduction of the third-order aberration (Seidel aberration) of the optical system, and can reduce aberration that may occur when the TTL becomes somewhat longer. Equation 4 can preferably satisfy: 1.75<n2<2.0. If designed to be lower than the lower limit of Equation 4, aberration can be reduced to obtain performance, but the refractive power of the second lens 102 and 112 becomes weak, so that light cannot be collected efficiently, which may deteriorate the performance of the optical system. If designed to be higher than the upper limit of Equation 4, there is a disadvantage in that it becomes difficult to obtain materials. In addition, if the refractive index of the second lens 102 and 112 is designed to be lower than the lower limit of Equation 4, in order to increase the refractive power of the sixth and seventh lenses, the curvature radius of the sixth and seventh lenses must be increased, and in this case, lens manufacturing becomes more difficult, the lens defect rate increases, and the yield may decrease.

1.60≤Aver(n1:n7)<1.77 [Equation 4-1]

In Equation 4-1, Aver (n1: n7) is the average of the refractive index values of the d-line of the first to seventh lenses. When the optical system 1000 and 1001 according to the embodiment satisfies the Equation 4-1, the optical system 1000 and 1001 can set the resolution and suppress the influence on the TTL.

1.0<GL_nd Aver/GM_nd_Aver<1.5 [Equation 4-2]

GL_nd_Aver is the average refractive index of the spherical lenses in the lens portion 100 and 100A, and GM_nd_Aver is the average refractive index of the aspherical lenses. The first and second lenses having high refractive indices are located on the object side, which can increase the color dispersion.

1.8≤n1<2.2 [Equation 4-3]

n1 is the refractive index of the d-line of the first lens 101 and 111. Equation 4-3 can increase the color dispersion by setting the refractive index of the first lens high.

20<FOV_H<40 [Equation 5]

In Equation 5, FOV_H represents a horizontal field of view, and can set the range of the vehicle optical system. Equation 5 preferably satisfies: 25≤FOV_H≤35, or a range of 30 degrees+3 degrees, and at this time, the sensor length in the horizontal direction can be based on 8.064 mm±0.5 mm. In addition, if Equation 5 is satisfied, when the temperature changes from room temperature to high temperature, the change rate of the effective focal length and the change rate of the field of view can be set to 5% or less, for example, 0 to 5%. In addition, even if one or more aspherical lenses, for example, two or more aspherical lenses, are mixed and used in the optical system 1000 and 1001, the deterioration of the optical characteristics can be inhibited through temperature compensation of the glass lens. Here, when the vertical field of view is FOV_V, the following condition may satisfy: 10<FOV_V<FOV_H.

LIR1<0 [Equation 6]

LIR1 means the curvature radius of the first surface S1 of the first lens 101 on the optical axis, and can be set to be smaller than 0. When this Equation 6 is satisfied, the shape of the optical system can be limited. The object-side surface of the first lens 101 is formed concavely on the optical axis, so that when it comes into contact with an external structure, it can inhibit surface damage, and can refract the incident light in a direction away from the optical axis. In addition, the following condition may satisfy: L1R1*LIR2>0. Accordingly, the center thickness and edge thickness of the first lens 101 and 111 can be increased, and the gap between the first lens 101 and 111 and the second lens 102 and 112 can be reduced.

L3R1>0,L2R1>0 [Equation 6-1]

L3R1 is the curvature radius of the object-side surface of the third lens 103 on the optical axis, and L2R1 is the curvature radius of the object-side surface of the second lens on the optical axis. Since the first lens 101 has a meniscus shape convex toward the object side, it can be closely attached to the center of the object-side surface of the second lens 102 and 112, and the curvature radius of the sensor-side surface of the second lens 102 and 112 can be increased to increase the distance from the third lens 103 and 113. Since the effective diameters of the first to third lenses are large and the average curvature radius is provided as spherical lenses, the assembling performance can be improved. This can reduce the influence on the optical characteristics of light traveling through the first to third lenses. Also, since the following condition may satisfy: L3R2>L3R1, the light can be controlled so that the effective diameter of the lenses arranged on the sensor side, that is, the fourth to seventh lenses, is not larger than that of the third lens, and the TTL can be reduced. If the following condition satisfies: L3R1>L3R2, there is a problem that aberration occurs between the object-side surfaces of the first lens and the second lens, or the effective diameter of the lenses on the sensor side increases, or the TTL increases.

0.8<BFL/L7S2_max_sag to Sensor<3 [Equation 7]

BFL is the optical axis distance from the center of the sensor-side surface of the last lens, that is, the seventh lens, to the surface of the image sensor. L7S2_max_sag to Sensor may be the distance in the optical axis direction from the maximum Sag value of the seventh lens 107 to the image sensor 300. If the optical system satisfies Equation 7, the TTL can be reduced, and conditions for manufacturing the camera module can be set. In addition, L7S2_max_sag to Sensor can set the space in which the optical filter 500 and the cover glass 400 positioned between the image sensor 300 and the seventh lens 107 and 117 can be placed. When the range of Equation 7 is smaller than the lower limit, the space in which the circuit structures such as the optical filter and the image sensor are disposed becomes more restricted, and the process of assembling the circuit structures such as the filter and the image sensor into the optical system may become difficult. When the range of Equation 7 is larger than the upper limit, the process of assembling the circuit structures such as the filter and the image sensor into the optical system is easy, but the TTL becomes long, making it difficult to miniaturize the optical system. That is, Equation 7 can set the minimum distance between the image sensor 300 and the last lens, and preferably, can satisfy the following condition: L7S2_max_sag to Sensor<BFL. In addition, if the last lens does not have a point where it protrudes more toward the image sensor than the center of the sensor-side surface, the value of the Equation 6 may be equal to the BFL (Back focal length). The BFL is the optical axis distance from the image sensor 300 to the center of the sensor-side surface of the last lens. In detail, if the following equation satisfies: 1<BFL/L7S2_max_sag to Sensor<1.2, the manufacturing convenience and TTL reduction are easier.

3<CT1/CT7<9 [Equation 8]

If Equation 8 is satisfied, the aberration characteristics can be improved and the influence on the reduction of the optical system can be set. Equation 8 may preferably satisfy: 3<CT1/CT7<7. Equation 8 can set the center thickness of the aspherical lenses, which are the first lens on the object side and the seventh lens on the sensor side of the optical system, and limit the difference in their center thicknesses. Accordingly, the chromatic aberration of the optical system can be improved, and good optical performance can be achieved at the set field of view and TTL can be controlled.

0.5<CT1/CA11<1 [Equation 8-1]

In Equation 2, the center thickness CT1 of the first lens 101 and 111 and the effective diameter CA11 of the object-side surface S1 of the first lens 101 can be set, and if this is satisfied, the strength and optical characteristics of the glass lens can be inhibited from being deteriorated. If it is lower than the range of Equation 1, the lens may be damaged or difficult to process, and if it is larger than the above range, the TTL may increase and the weight of the optical system may become heavy. Preferably, 0.6<CT1/CA11<1 can be satisfied.

0<CT1/CT6<3 [Equation 9]

CT6 means the center thickness of the sixth lens 106. When the optical system satisfies Equation 9, the aberration characteristics can be improved and the influence on the reduction of the optical system can be set. Equation 9 can preferably satisfy: 0<CT1/CT6<2. Equation 9 can improve the chromatic aberration of the optical system by setting the difference in the center thickness of the first and sixth lenses.

0<CT45/CT6<5 [Equation 10]

In Equation 10, CT45 is the center thickness of the fourth and fifth lenses, for example, the center thickness of the cemented lens 145 and 145A. That is, CT45 is the optical axis distance from the center of the object-side surface of the fourth lens 104 and 114 to the center of the sensor-side surface of the fifth lens 105 and 115. When the optical system satisfies Equation 10, the thickness of the cemented lens and the adjacent sixth lens 106 and 116 can be set to improve the aberration characteristics, and the following equation may preferably satisfy: 1<CT45/CT6<3. Here, the following condition may satisfy: CT45>ET45, and ET45 is the edge thickness of the cemented lens.

0<|L2R1/L4R2|<1 [Equation 11]

In Equation 11, L2R1 means the curvature radius of the first surface S1 of the second lens 102 and 112, and L4R2 means the curvature radius of the eighth surface S8 of the fourth lens 104 and 114. When the optical system 1000 and 1001 according to the embodiment satisfies Equation 11, the optical system 1000 and 1001 can have improved aberration characteristics.

0<CT45−ET45<2 mm [Equation 12]

In Equation 12, ET45 is the optical axis distance from the end of the effective region of the object-side surface of the fourth lens 104 and 114 to the end of the effective region of the sensor-side surface of the fifth lens 105 and 115. When the optical system satisfies Equation 12, the center thickness and edge thickness of the cemented lens can be set to improve the aberration characteristics, and the following condition may satisfy: 1 mm≤CT45/ET45<1.5 mm. The ET45 can be larger than the edge thickness ET1-ET7 of each of the first to seventh lenses.

0<CA11/CA31<2 [Equation 13]

In Equation 13, CA11 means the effective diameter of the first surface S1 of the first lens 101 and 111, and CA31 means the effective diameter of the fifth surface S5 of the third lens 103 and 113. If Equation 13 is satisfied, the optical system 1000 and 1001 can control the incident light and set the factors affecting the aberration, and the following condition may satisfy: 0.5<CA11/CA31<1.5.

0<CA72/CA42<2 [Equation 14]

In Equation 14, CA42 means the effective diameter of the eighth surface S8 of the fourth lens 104 and 114, and CA72 means the effective diameter of the fourteenth surface S14 of the seventh lens 107 and 117. If Equation 14 is satisfied, the optical system 1000 and 1001 can control the incident light path and set the factors for the performance change according to CRA and temperature. Preferably, Equation 14 can satisfy: 0.5<CA72/CA42<1.0.

0<CA12/CA21<2 [Equation 15]

In Equation 15, CA12 means the effective diameter of the second surface S2 of the first lens 101 and 111, and CA21 means the effective diameter of the third surface S3 of the second lens 102 and 112. When the optical system 1000 and 1001 according to the embodiment satisfies Equation 15, the optical system 1000 and 1001 can control the light traveling to the first lens group LG1 and the second lens group LG2, and can set a factor affecting the decrease in lens sensitivity. Equation 15 may preferably satisfy: 1<CA12/CA21<1.5.

0<CA31/CA42<2 [Equation 16]

CA31 means the effective diameter of the fifth surface S5 of the third lens 103 and 113, and CA42 means the effective diameter of the eighth surface S8 of the fourth lens 104 and 114. When the optical system 1000 and 1001 according to the embodiment satisfies Equation 16, the size of the spherical lens(es) can be set. Equation 16 can preferably satisfy: 1<CA31/CA42<1.5.

0.1<CA41/CA52<2.1 [Equation 17]

CA42 means the effective diameter of the seventh surface S7 of the fourth lens 104 and 114, and CA52 means the effective diameter of the tenth surface S10 of the fifth lens 105 and 115. When the optical system 1000 and 1001 according to the embodiment satisfies Equation 17, the optical system 1000 and 1001 can improve chromatic aberration and set the size between the object-side surface and the sensor-side surface of the cemented lens 145 and 145A. Accordingly, by setting the effective diameter size of the cemented lens arranged closer to the object side than the aspherical lens, the light incident through the cemented lens can be effectively guided to the aspherical lens. Equation 17 can preferably satisfy: 1<CA41/CA42<1.6.

0<CA52/CA61<2 [Equation 18]

CA61 means the eleventh surface S11 of the sixth lens 106 and 116. When the optical system 1000 and 1001 according to the embodiment satisfies Equation 18, the relationship between the effective diameter of the sensor-side surface of the cemented lens 145 and 145A and the effective diameter of the object-side surface of the lens adjacent thereto can be set. Accordingly, the optical system 1000 and 1001 can improve chromatic aberration and set the size and curvature radius between the sensor-side surfaces of the cemented lens. Accordingly, the effective diameter size of the fifth and sixth lenses arranged on the object side more than the last lens can be set. Equation 18 preferably satisfies: 0.5<CA52/CA61<1.2.

1 mm<CA51−CA52<3 mm[Equation 18-1]

In Equation 18-1, the difference in effective diameter between the object-side surface (L5S1) and the sensor-side surface (L5S2) of the fifth lens may be more than 1 mm, and may be greater than the difference in effective diameter (mm) between the sixth and seventh lenses. Accordingly, by increasing the difference in effective diameter between the object-side surface and the sensor-side surface of the fifth lens, which is a spherical lens adjacent to the aspherical lens, the light refracted through the fifth lens may proceed within the effective region of the aspherical lens.

CA4>CA5>CA6 [Equation 18-2]

CA41>(ImgH*2) [Equation 18-3]

CA51>(ImgH*2) [Equation 18-4]

CA62<(ImgH*2) [Equation 18-5]

In Equations 18-2 to 18-5, CA5 is the effective diameter of the fifth lens 105 and 115, CA6 is the effective diameter of the sixth lens 106 and 116, ImgH is ½ of the diagonal length of the image sensor 300, and CA62 is the effective diameter of the sensor-side surface of the sixth lens. Accordingly, the light path can be set to the region of the image sensor 300 by the effective diameter of the fifth lens 105 and 115, the effective diameter of the object-side surface of the fourth lens 104 and 114, and the effective diameter of the object-side surface of the fifth lens 105 and 115. In the embodiment, since the n-th lens is provided as an aspherical lens, the effective diameter ratio of the adjacent spherical lens and the cemented lens can satisfy Equation 18 to 18-5.

0.2<GL_CA_Aver/GM_CA_Aver<2.2 [Equation 19]

In Equation 19, GL_CA_Aver means the average effective diameter of glass lenses having a spherical surface, and GM_CA_Aver means the average effective diameter of glass mold lenses having an aspherical surface. In Equation 19, the effective diameter size of the aspherical lens placed on the object side is set to the maximum, so that the path of the incident light can be effectively guided. Equation 19 preferably satisfies: 1<GL_CA_Aver/GM_CA_Aver<1.5. That is, the difference in effective diameter between the spherical lens and the aspherical lens can be set not to be large. Here, nGL>nGM can be satisfied. The nGL is the number of spherical glass lenses, and nGM is the number of aspherical glass lenses.

0<GL_nd_Aver/GM_nd Aver<1.60 [Equation 20]

In Equation 19, GL_nd_Aver is the average refractive index of the glass material lenses, for example, the average refractive index of the second to fifth lenses. GM_nd_Aver is the average refractive index of the first and seventh lenses. Preferably, the refractive index of the spherical lens and the refractive index of the aspherical lens can be set to satisfy the following condition: 0.7<GL_nd_Aver/GM_nd_Aver<1.5.

0<ΣGM_nd/ΣGL_nd<1 [Equation 20-1]

ΣGM_nd is the sum of the refractive indices of the glass mold lens, and ΣGL_nd is the sum of the refractive indices of the spherical glass lens. Preferably, the following condition may satisfy: 0.2<ΣGM_nd/ΣGL_nd<0.6. The optical system can adjust the resolution and color dispersion by setting the difference in the refractive indices of the spherical lens and the aspherical lens.

CA6 or CA7<CA4 [Equation 21]

In Equation 21, CA6 means the effective diameter of the sixth lens 106, CA7 means the effective diameter of the seventh lens 107, and CA4 means the effective diameter of the fourth lens. When Equation 21 is satisfied, the optical system can guide light to the center and periphery portions of the image sensor 300 and improve chromatic aberration by setting the effective diameter of the sixth and seventh lenses arranged between the fourth lens 104 and 114 and the image sensor 300 to be smaller than the effective diameter of the fourth lens 104 and 114.

CG1<CG6<CG2 [Equation 22]

In Equation 22, CG1 represents the center distance between the first and second lenses, CG2 represents the center distance between the second and third lenses, and CG6 represents the center distance between the sixth and seventh lenses. If Equation 22 is satisfied, the center distance from the first lens to the seventh lens can be set, so that the center distance can be reduced and the optical performance of the peripheral portion of the FOV can be improved.

G4<0.01 or CG4<0.01 [Equation 22-1]

In Equation 22-1, G4 and CG4 are the distance and the center distance between the fourth lens 104 and the fifth lens 105. If Equation 22-1 is satisfied, the fourth and fifth lenses can be set as cemented lenses. Here, preferably, CT45=CT4+CT5+CG4 can be satisfied, and the center thickness CT4 and CT5 of the fourth and fifth lenses and the center distance CG4 of the fourth and fifth lenses can be set.

0<CT7/CG6<1 [Equation 23]

In Equation 23, CG6 is the center distance between the sensor-side surface of the sixth lens 106 and the object-side surface of the seventh lens 107. By setting the center thickness CT7 of the seventh lens 107 and the center distance between the sixth and seventh lenses in Equation 23, the optical performance at the periphery portion of the field of view can be improved. Equation 23 preferably satisfies: 0.2<CT7/CG6<0.8.

CT2<(2*CT3)<CT1 [Equation 24]

When the center thicknesses of the first, second, and third lenses satisfy Equation 24, the incident light can be guided to the aspherical lens by the thickness of the object-side spherical lenses, and thermal compensation according to temperature change can be performed and the assembly characteristics can be improved.

(3*CT7)<CT1<(2*CT6) [Equation 25]

If the center thicknesses of the first, sixth, and seventh lenses satisfy Equation 25, the light emitted by the thickness of the sensor-side aspherical lens can be refracted to the entire region of the image sensor and the TTL can be reduced.

2<CT6/CT7<5 [Equation 26]

In Equation 26, by setting the center thickness CT6 of the sixth lens to be thicker than the center thickness CT7 of the seventh lens, the factors affecting aberration can be controlled. Preferably, Equation 26 can satisfy: 2<CT6/CT7<3.

10<L7R1/CT7<40 [Equation 27]

L7R1 means to the curvature radius of the thirteenth surface of the seventh lens on the optical axis. In Equation 27, by setting the curvature radius of the object-side surface of the seventh lens and the center thickness of the seventh lens, the refractive power of the seventh lens can be controlled. Accordingly, good optical performance can be achieved in the center and peripheral portions of the field of view. Preferably, Equation 27 can satisfy: 18<L7R1/CT7<38.

0<L5R2/L7R1<10 [Equation 28]

L5R2 means the curvature radius of the tenth surface of the fifth lens on the optical axis. In Equation 28, by setting the curvature radius of the sensor-side surface of the fifth lens and the curvature radius of the object-side surface of the seventh lens, the refractive powers of the fifth and seventh lenses can be controlled. Accordingly, good optical performance can be achieved in the center and peripheral parts of the angle of view. Preferably, Equation 28 can satisfy 0<L5R2/L7R1<1.

LIR1*L1R2>0 [Equation 29]

LIR1 is the curvature radius of the object-side surface of the first lens on the optical axis, and LIR2 is the curvature radius of the sensor-side surface of the first lens on the optical axis. If Equation 29 is satisfied, the dispersion of the incident light can be adjusted by controlling the refractive power of the first lens, and the assemblability of the first lens can be improved. Preferably, the following condition may satisfy: LIR1+L1R2<0.

0<L5R1/L4R2<2 [Equation 30]

L5R1 is the curvature radius of the object-side surface of the fifth lens on the optical axis, and L4R2 is the curvature radius of the sensor-side surface of the fourth lens on the optical axis. If Equation 30 is satisfied, the fourth and fifth lenses can be expressed as a cemented lens. Preferably, the following condition may satisfy: L5R1/L4R2=1.

1<L4R1/L5R2<2 [Equation 30-1]

L4R1 is the curvature radius of the object-side surface of the cemented lens on the optical axis, and L5R2 is the curvature radius of the sensor-side surface of the cemented lens on the optical axis. When Equation 30-1 is satisfied, the cemented lens refracts the incident light in the direction of the optical axis, and can suppress the increase in the effective diameter of the lenses between the cemented lens and the image sensor. In addition, L5R2 has a curvature radius of 12 mm or less, and can have the minimum curvature radius within the lens section.

0<L6R2/L6R1<3 [Equation 31]

L6R1 means the curvature radius of the object-side surface of the sixth lens on the optical axis, and L6R2 means the curvature radius of the sensor-side surface of the sixth lens on the optical axis. In Equation 31, the curvature radii of the object-side surface and the sensor-side surface of the sixth lens are set so that light can be effectively refracted from the cemented lens toward the aspherical lens. Equation 31 preferably satisfies: 1<L6R2/L6R1<2. The object-side surface and the sensor-side surface of the sixth lens are aspherical, and when the difference in the curvature radii of the aspherical object-side surface and the aspherical sensor-side surface satisfies the above range, the assemblability of the sixth lens can be improved, and the influence of the optical characteristics due to temperature change can be suppressed.

1<L7R1/L7R2<3 [Equation 31-1]

L7R1 and L7R2 mean the curvature radii of the object-side surface and the sensor-side surface of the seventh lens on the optical axis. In Equation 31-1, the curvature radius of the aspherical object-side surface and the aspherical sensor-side surface of the seventh lens is set, so that light can be refracted to the entire region of the image sensor through the seventh lens. Equation 31-1 can preferably satisfy: 1<L7R1/L7R2<2. Accordingly, when the difference in the curvature radius of the object-side surface and the sensor-side surface of the seventh lens satisfies the above range, the assemblability of the seventh lens can be improved, and the influence on the optical characteristics due to temperature change can be suppressed.

0<CT_Max/CG Max<1 [Equation 32]

In Equation 32, the maximum center thickness CT_Max among the lenses and the maximum center distance CG_Max between adjacent lenses can be set. When Equation 32 is satisfied, the optical system can have good optical performance at the focal length at the set angle of view, and can reduce TTL. Preferably, the first embodiment can satisfy: 0.1<CT_Max/CG Max<0.5.

2<ΣCT/ΣCG<7 [Equation 33]

ΣCT is the sum of the center thicknesses of the lenses, and ΣCG is the sum of the center distances between adjacent lenses. If Equation 33 is satisfied, the optical system can have good optical performance at the focal length at the set field of view, and can reduce the TTL.

8<ΣIndex<30 [Equation 34]

>Index means the sum of the refractive indices at the d-line of each of the plurality of lenses. If Equation 34 is satisfied, the optical system 1000 and 1001 in which an aspherical lens and a spherical lens are mixed can control the TTL, and can have improved resolution. Also, when the number of spherical lenses is greater than the number of aspherical lenses, heat compensation is possible by spherical lenses having relatively thick thickness, and the sum of TTL and refractive indices of the lenses can be set. Equation 34 preferably satisfies: 10<ΣIndex<13.

10<ΣAbb/ΣIndex<50 [Equation 35]

ΣAbb means the sum of Abbe numbers of each of the plurality of lenses. When Equation 35 is satisfied, the optical system 1000 and 1001 can have improved aberration characteristics and resolution. Equation 35 can control optical characteristics by setting the Abbe's sum and the sum of refractive indices of the lenses, and preferably satisfies: 20<ΣAbb/ΣIndex<35.

Distortion<2 [Equation 36]

Distortion means the maximum value or the absolute value of the maximum value of the distortion from the center (0.0F) of the image sensor to the diagonal end (1.0F) based on the optical characteristics detected by the image sensor 300. When the optical system 1000 and 1001 satisfies Equation 36, the optical system 1000 and 1001 can improve the distortion characteristics and set the conditions for image processing. Preferably, Distortion<1 can be satisfied.

0<ΣCT/ΣET<2 [Equation 37]

ΣCT is the sum of the center thicknesses of the lenses, and ΣET is the sum of the edge thicknesses of the effective regions of the lenses. When Equation 37 is satisfied, the optical system can have good optical performance at the focal length at the set field of view and can reduce the TTL. Equation 37 preferably satisfies 1<ΣCT/ΣET<1.5.

0.5<CA11/CA Min<2.5 [Equation 38]

CA11 means the effective diameter of the object-side surface of the first lens, and CA_Min means the minimum effective diameter among the object-side surfaces and the sensor-side surfaces of the lenses. If Equation 38 is satisfied, the optical system can provide a slimmer module while maintaining incident light control and optical performance. Equation 38 preferably satisfies: 1<CA11/CA_Min<2.5.

1<CA_Max/CA Min<5 [Equation 39]

CA_Max means the maximum effective diameter among the object-side surfaces and the sensor-side surfaces of the lenses. If Equation 39 is satisfied, the optical system can set the size for a slim and compact structure while maintaining optical performance. Equation 39 preferably satisfies: 1<CA_Max/CA_Min<2.5.

1<CA_Max/CA Aver<3 [Equation 40]

CA_Aver means the average of the effective diameters of the object-side surfaces and the sensor-side surfaces of the lenses. If Equation 40 is satisfied, the optical system can set the size for a slim and compact structure while maintaining optical performance. Equation 40 preferably satisfies: 1<CA_Max/CA_Aver<1.7.

0.5<CA_Min/CA Aver<2 [Equation 41]

If Equation 41 is satisfied, the optical system can set the size for a slim and compact structure while maintaining optical performance. Equation 41 preferably satisfies: 0.5<CA_Min/CA Aver<1.

1<CA_Max/(2*ImgH)<3 [Equation 42]

Equation 42 can be set to the maximum effective diameter CA_Max of the lens surfaces and the diagonal length of the image sensor, and if it is satisfied, the optical system can maintain good optical performance and set the size for a slim and compact structure. Equation 42 preferably satisfies: 1<CA_Max/(2*ImgH)<2.

1<TD/CA Max<4 [Equation 43]

TD is an optical axis distance from the center of the object-side surface of the first lens to the center of the sensor-side surface of the last lens. If Equation 43 is satisfied, the total optical axis distance and the maximum effective diameter of the lenses can be set, and the size for good optical performance can be set. Equation 43 preferably satisfies: 2<TD/CA_Max<3.

TD>SD [Equation 43-1]

The SD is a distance from the position of the aperture stop to the center of the sensor-side surface of the last lens.

1<F/CA61<10 [Equation 44]

F represents the effective focal length (EFL) of the optical system, and may be 10 mm or more, for example, in the range of 10 mm to 20 mm. In Equation 44, the relationship between the effective focal length and the effective diameter of the object-side surface of the last spherical lens is set, so that the influence on the optical system reduction, for example, TTL, can be controlled. Equation 44 preferably satisfies: 1<F/CA61<2.

0<F/|L1R1|<1 [Equation 45]

In Equation 45, the effective focal length of the optical system and the curvature radius of the object-side surface of the first lens on the optical axis are set, so that the influence on the incident light and TTL can be controlled. Equation 45 preferably satisfies: 0.3<F/|LIR1|<1.

Max(CT/ET)<3 [Equation 46]

Max (CT/ET) means the maximum value of the ratio of the center thickness to the edge thickness of each lens. When Equation 46 is satisfied, the optical system can control the influence on the effective focal length. Equation 46 preferably satisfies: 0<Max (CT/ET)<1. Accordingly, the assemblability of the entire lenses can be improved. The maximum value of the ratio of the center thickness to the edge thickness of the aspherical lens within the lens section can satisfy the following condition: 1<GM_Max (CT/ET)<1.2. The maximum value of the ratio of the center thickness to the edge thickness of the spherical lens within the lens section can satisfy the following condition: 1.5<GL_Max (CT/ET)<2. If the condition of the aspherical lens is less than the lower limit of the above range, it is difficult to manufacture a glass mold lens. That is, it is manufactured by injecting high-temperature resin and hardening it at a low temperature, but if the thickness difference is large, the lens may not shrink uniformly as it cools at a low temperature, which may result in a high surface defect rate. In addition, as the temperature changes from −40 degrees to 105 degrees, the aspherical lens shrinks and expands, and during this process, the change rate of the lens shape appears significantly, which may deteriorate the optical system performance.

0<EPD/|L1R1|<1 [Equation 47]

EPD means the size (mm) of the entrance pupil diameter of the optical system 1000 and 1001, and LIR1 means the curvature radius of the first surface S1 of the first lens on the optical axis. When the optical system 1000 and 1001 according to the embodiment satisfies Equation 47, the optical system 1000 and 1001 can control incident light. Equation 47 can preferably satisfy: 0.2<EPD/|LIR1|<0.7.

−5<F1/F3<0 [Equation 48]

F1 is the focal length of the first lens, and F3 is the focal length of the third lens. If Equation 48 is satisfied, the resolution can be improved by controlling the refractive power of the first and third lenses, and it can affect the TTL and effective focal length (EFL).

|F5|<F4 [Equation 48-1]

2*|F5|<F6 [Equation 48-2]

2*|F5|<|F7| [Equation 48-3]

F5 is the focal length of the fifth lens, F4 is the focal length of the fourth lens, F6 is the focal length of the sixth lens, and F7 is the focal length of the seventh lens. Accordingly, the absolute value of the focal length of the fifth lens closest to the aspherical lens can be smaller than the focal length of the fourth lens and smaller than the focal lengths of the sixth and seventh lenses. Accordingly, the refractive power of the last spherical lens can be controlled to effectively guide light to the aspherical lens.

The aperture stop ST is disposed on the sensor-side surface of the second lens 102. The focal length of the lens arranged on the sensor side more than the aperture stop ST and most closely to the aperture stop ST is greater than 0. In the embodiment of the invention, the focal length F3 of the third lens 103 should be designed to be greater than 0. In this case, the third lens 103 collects light, so that the effective diameter of the fourth to seventh lenses, which are arranged closer to the sensor than the third lens 103, can be inhibited from increasing. In addition, since the TTL can be inhibited from becoming longer, miniaturization of the optical system is possible. The composite focal length of the lens arranged on the sensor side more than the aperture stop ST, that is, the lens arranged closer to the sensor than the aperture stop, is designed to be greater than 0. In the embodiment of the present invention, the composite focal length of the third to seventh lenses is designed to be greater than 0. In this case, the optical system can be miniaturized by reducing the TTL at a horizontal field of view FOV_H of 25 to 35 degrees.

Po4*Po5<0 [Equation 49]

Po4 is the refractive power value of the fourth lens, and Po5 is the refractive power value of the fifth lens. In other words, the refractive powers of the fourth and fifth lenses have opposite refractive powers, so they can improve aberrations and effectively guide light with an aspherical lens. If a value of Po4*Po5 is greater than 0, the effect of improving chromatic aberration as a cemented lens does not appear significantly.

Po1(Po4*Po5)>0 [Equation 49-1]

F45<0 (First embodiment) or F45>0 (Second embodiment) [Equation 49-2]

F4*F5<0 [Equation 49-3]

Po1 is the refractive power value of the first lens, F45 is the composite focal length of the fourth and fifth lenses, F4 is the focal length of the fourth lens, and F5 is the focal length of the fifth lens. When Equations 49-1 to 49-3 are satisfied, it is easy to improve the aberration of the optical system with the fourth lens and the fifth lens, which are cemented lenses, and the incident light can be effectively guided to the aspherical lens.

15<v4−v5<50 [Equation 50]

v4 is the Abbe number of the fourth lens, and v5 is the Abbe number of the fifth lens. If Equation 50 is satisfied, the difference in Abbe numbers of at least two lenses forming the cemented lens can be maintained above a certain value, and chromatic aberration can be improved. Equation 50 preferably satisfies: 20<v4−v5<40. If the cemented lens is less than the lower limit of Equation 50, it may be insignificant in improving the aberration characteristics of the optical system.

0<|F1/F|<20 [Equation 51]

Equation 51 sets the relationship between the focal length F1 of the first lens and the effective focal length F, and can set the TTL of the optical system. Equation 51 preferably satisfies: 1<|F1/F|<5.

0<|F5/F6|<1 [Equation 52]

In Equation 52, the relationship between the focal lengths F5 and F6 of the fifth and sixth lenses can be set, so that the refractive power and optical path of the spherical lens and the adjacent aspherical lens can be adjusted, and the resolution can be improved. Equation 52 preferably satisfies: 0<| F5/F6|<0.5.

0<|F5/F7|<1 [Equation 53]

In Equation 53, the relationship between the focal lengths F5 and F7 of the fifth and seventh lenses can be set, so that the refractive power and optical path of the spherical lens and the last aspherical lens can be adjusted, and the resolution can be improved. Equation 53 preferably satisfies: 0<| F5/F7|<0.6.

0<|F6/F1|<2 [Equation 54]

In Equation 54, the relationship between the focal lengths F1 and F6 of the first and sixth lenses is set, so that the refractive power and optical path of the first spherical lens and the first aspherical lens can be controlled, and the influence of TTL can be controlled to improve the resolution. Equation 54 preferably satisfies: 1<| F6/F1|<2.

0<|F37|/F12<3 [Equation 55]

In Equation 55, the relationship between the composite focal lengths F37 of the third to seventh lenses and the composite focal lengths F12 of the first and second lenses is set, so that the refractive power of the object-side lens group and the sensor-side lens group of the aperture stop can be controlled to improve the resolution, and the optical system can be provided in a slim and compact size. Equation 55 preferably satisfies: 0<| F37|/F12<1. Here, F12 is the focal length of the first lens group, F37 may be the focal length of the second lens group, and F37 may have positive refractive power in the first embodiment and negative refractive power in the second embodiment.

0<F37/F6<1 [Equation 56]

In Equation 56, the relationship between the composite focal length F37 of the third to seventh lenses and the focal length F6 of the sixth lens is set, so that the composite refractive power of the third to seventh lenses and the refractive power of the first aspherical lens can be adjusted to improve the resolution, and the optical system can be provided in a slim and compact size. Equation 56 preferably satisfies: 0<| F37/F6|<0.8.

0<|F37/F7|<1 [Equation 57]

In Equation 57, the relationship between the composite focal length F37 of the third to seventh lenses and the focal length F7 of the seventh lens is set, so that the composite refractive power of the third to seventh lenses and the refractive power of the last aspherical lens can be adjusted to improve the resolution, and the optical system can be provided in a slim and compact size. Equation 57 preferably satisfies: 0<| F37/F7|<0.5.

0<F6/F<5 [Equation 58]

In Equation 58, the relationship between the focal length F6 of the sixth lens and the effective focal length F is set, so that the refractive power of the first aspherical lens and the entire focal length can be adjusted to improve the resolution, and the optical system can be provided in a slim and compact size. Equation 58 preferably satisfies: 1<F6/F<3.5.

F37<TTL [Equation 59]

In Equation 59, the relationship between the focal length F37 of the second lens group and the total length TTL can be set. The TTL can be reduced by the second lens group having an aspherical surface.

1<nGL/nGM<4 [Equation 60]

nGL means the number of spherical lenses, and nGM means the number of aspherical lenses. By arranging the number of aspherical lenses in Equation 60 to be 1 time more than the number of spherical lenses, the thickness of the optical system can be reduced, and more refractive power can be provided through the aspherical surface. Equation 60 preferably satisfies: 2<nGL/nGM<3.

1<nSS/nAS<4 [Equation 61]

nSS means the number of lens surfaces having a spherical surface within the lens section, and nAS means the number of lens surfaces having an aspherical surface within the lens section. In Equation 61, by arranging the number of aspherical lens surfaces to be 1 time more than the number of spherical lens surfaces, the thickness of the optical system can be reduced and a wider range of refractive powers can be provided through the aspherical surface. Equation 60 preferably satisfies: 2<nSS/nAS<3.

CA3<CA2<CA1 [Equation 62]

By setting the relationship between the effective diameters CA1, CA2, and CA3 of the first, second, and third lenses, the optical paths of the lenses before and after the aperture stop can be controlled, thereby setting the optical paths of the entire lenses.

0<ΣGM_CT/ΣGL_CT<1 [Equation 63]

ΣGM_CT is the sum of the center thicknesses of the aspherical lenses, and ΣGL_CT is the sum of the center thicknesses of the spherical lenses. If Equation 62 is satisfied, the relationship between the thickness of the aspherical lens and the thickness of the spherical lens relative to the TTL can be set to control the entire TTL. Equation 62 preferably satisfies: 0.1<ΣGM_CT/≥ΣGL_CT<0.5.

10<TTL<50 [Equation 64]

TTL (Total track length) means the distance (mm) from the center of the first surface S1 of the first lens 101 to the surface of the image sensor 300 in the optical axis OA. In Equation 64, the TTL may be set to exceed 10 mm or 20 mm, thereby providing a vehicle optical system. Equation 64 preferably satisfies: 22<TTL<40 or the following condition of TD<TTL.

2<ImgH [Equation 65]

Equation 65 can set the diagonal size (2*ImgH) of the image sensor 300 and can provide an optical system having a vehicle sensor size. Equation 65 can preferably satisfy: 4≤ImgH.

2<BFL<7 [Equation 66]

In Equation 66, the BFL (Back focal length) is set to be more than 2 mm and less than 7 mm, thereby securing the installation space of the optical filter 500 and the cover glass 400, improving the assemblability of the components through the gap between the image sensor 300 and the last lens, and improving the bonding reliability. Equation 66 can preferably satisfy: 2.5≤BFL≤3. When the BFL is less than the range of Equation 68, some of the light that proceeds to the image sensor may not be transmitted to the image sensor, which may cause a decrease in resolution. If the BFL exceeds the range of Equation 68, stray light may be introduced, which may deteriorate the aberration characteristics of the optical system.

0.1<BFL/CG2<2 [Equation 67]

In Equation 67, the BFL sets the spacing between lenses, for example, the center distance CG2 between the second and third lenses, thereby securing the installation space for the optical filter 500 and the cover glass 400, and improving the assemblability of components and improving the joint reliability through the spacing between the image sensor 300 and the last lens. In Equation 67, the first embodiment satisfies: 0.5<BFL/CG2<1, and the second embodiment satisfies: 1<BFL/CG1<2.5.

CG6<BFL [Equation 68]

In Equation 68, the BFL is set to be larger than the spacing between the lenses, for example, the center distance CG6 between the sixth and seventh lenses, so that the installation space for the optical filter 500 and the cover glass 400 can be secured, and the assembly of the components can be improved and the bonding reliability can be improved through the spacing between the image sensor 300 and the last lens. In addition, the seventh lens, which is the last lens, can disperse the incident light to the effective region of the image sensor, but if the BFL does not satisfy Equation 68, some of the emitted light may not be transmitted to the effective region of the image sensor, thereby lowering the resolution. Here, the CG3 and CG5 may be smaller than the BFL.

3<F<40 [Equation 69]

Equation 69 can set the overall effective focal length F to suit the vehicle optical system. Equation 69 can satisfy 10<F<30.

FOV<45 [Equation 70]

In Equation 70, FOV (Field of view) means the diagonal angle of view (Degree) of the optical system 1000 and 1001, and can provide a vehicle optical system of less than 45 degrees. Preferably, the FOV can satisfy: 20≤FOV≤40.

1<TTL/CA Max<5 [Equation 71]

CA_Max means the largest effective diameter (mm) among the object-side and sensor-side surfaces of the plurality of lenses, and TTL means the distance (mm) from the apex of the first surface S1 of the first lens to the image surface of the image sensor 300 on the optical axis OA. Equation 71 sets the relationship between the total optical axis length of the optical system and the maximum effective diameter, thereby providing an improved vehicle optical system. Equation 71 preferably satisfies: 1.5<TTL/CA_Max<4.

2<TTL/ImgH<15 [Equation 72]

Equation 72 can set the total optical axis length TTL of the optical system and the diagonal length ImgH from the optical axis of the image sensor 300. When the optical system 1000 and 1001 according to the embodiment satisfies Equation 72, the optical system 1000 and 1001 can have a TTL for application to the vehicle image sensor 300, thereby providing a more improved image quality. Equation 72 preferably satisfies: 4<TTL/ImgH≤10.

0.1<BFL/ImgH<2 [Equation 73]

Equation 73 can set the optical axis distance between the image sensor 300 and the last lens and the diagonal length from the optical axis of the image sensor 300. When the optical system 1000 and 1001 according to the embodiment satisfies Equation 73, the optical system 1000 and 1001 can secure the BFL for applying the size of the vehicle image sensor 300, set the distance between the last lens and the image sensor 300, and have good optical characteristics at the center and periphery portion of the FOV. Equation 73 can preferably satisfy: 0.3<BFL/ImgH<1.

5<TTL/BFL<20 [Equation 74]

Equation 74 can set the total optical axis length TTL of the optical system and the optical axis distance BFL between the image sensor 300 and the last lens (unit: mm). If the optical system 1000 and 1001 according to the embodiment satisfies Equation 55, the optical system 1000 and 1001 can secure BFL. Equation 74 can preferably satisfy: 8<TTL/BFL<16.

1<TTL/F<3 [Equation 75]

Equation 75 can set the total focal length F and the total optical axis length TTL of the optical system 1000 and 1001. Accordingly, an optical system for a driver assistance system can be provided. Equation 75 preferably satisfies: 1.5≤TTL/F≤2.8. When the optical system 1000 and 1001 according to the embodiment satisfies Equation 75, the optical system 1000 and 1001 can have an appropriate focal length in a set TTL range, and provides an optical system that can maintain an appropriate focal length and form an image even when the temperature changes from low to high. When it is less than the lower limit of Equation 75, it is necessary to increase the refractive power of the lenses, so that it becomes difficult to correct spherical aberration or distortion aberration, and when it exceeds the upper limit of Equation 75, the effective diameter or TTL of the lenses becomes long, which may cause a problem in that the imaging lens system becomes large.

1<F/BFL<10 [Equation 76]

Equation 76 can set the total effective focal length F of the optical system 1000 and 1001 and the optical axis distance BFL between the image sensor 300 and the last lens. If the optical system 1000 and 1001 according to the embodiment satisfies Equation 76, the optical system 1000 and 1001 can have a set field of view and an appropriate focal length, and a vehicle optical system can be provided. In addition, the optical system 1000 and 1001 can minimize the distance between the last lens and the image sensor 300, so that it can have good optical characteristics in the periphery portion of the FOV. Equation 76 can preferably satisfy: 3<F/BFL<8.

1<F/ImgH<5 [Equation 77]

Equation 77 can set the total effective focal length F of the optical system 1000 and 1001 and the diagonal length ImgH from the optical axis of the image sensor 300. This optical system 1000 and 1001 can have improved aberration characteristics in the size of the vehicle image sensor 300. Equation 77 can preferably satisfy: 2<F/ImgH<4.1.

1<F/EPD<5 [Equation 78]

Equation 78 can set the total effective focal length F and the entrance pupil diameter of the optical system 1000 and 1001. Accordingly, the overall brightness of the optical system can be controlled. Equation 78 can preferably set: 1<F/EPD<3.

0<BFL/TD<0.3 [Equation 79]

Equation 79 can set the relationship between the optical axis distance TD of the lenses of the optical system 1000 and 1001 and the back focal distance (BFL). Accordingly, the resolution of the optical system can be maintained and the overall size can be controlled. Equation 79 preferably satisfies: 0<BFL/TD<0.2. When the condition value of BFL/TD is 0.2 or more, the BFL is designed to be large compared to the TD, so the size of the entire optical system becomes large, making it difficult to miniaturize the optical system, and the distance between the seventh lens and the image sensor becomes long, so that an unnecessary amount of light may increase between the seventh lens and the image sensor, resulting in a problem of lowering the resolution, such as deterioration of aberration characteristics.

0<EPD/ImgH/FOV<0.2 [Equation 80]

Equation 80 can set the relationship between the entrance pupil diameter (EPD), the length (ImgH) of half the diagonal length of the image sensor, and the diagonal field of view. Accordingly, the overall size and brightness of the optical system can be controlled. Equation 80 can preferably satisfy: 0<EPD/ImgH/FOV<0.1.

5<FOV/F#<40 [Equation 81]

Equation 81 can set the relationship between the diagonal field of view and the F number of the optical system. Equation 81 can preferably satisfy: 10<FOV/F #<30. Here, F # is provided to be 1.8 or less to provide a bright image.

1<ΣGL_CT/F#<20 [Equation 82]

Equation 82 can set the relationship between the sum of the center thicknesses ΣGL_CT of the glass lenses of the optical system and the F number F #. Preferably, Equation 82 can satisfy: 10<ΣGL_CT/F #<15.

1<ΣGM_CT/F#<10 [Equation 83]

Equation 83 can set the relationship between the sum of the center thicknesses ΣGM_CT of the aspherical lenses of the optical system and the F number F #. Equation 83 can preferably satisfy: 1<ΣPL_CT/F #<5.

1<ΣGL_Index/F#<10 [Equation 84]

Equation 84 can set the relationship between the sum of refractive indices ΣGL_Index of spherical lenses of an optical system and the F number F #. Equation 84 can preferably satisfy: 3<ΣGL_Index/F #<8.

1<ΣGM_Index/F#<10 [Equation 85]

Equation 84 can set the relationship between the sum of refractive indices ΣGL_Index of aspherical lenses of an optical system and the F number F #. Equation 84 can preferably satisfy: 1<ΣGL_Index/F #<5.

|Max_Sag62|<|Max_Sag52| [Equation 86]

Max_Sag62 is the maximum distance in the optical axis direction from a straight line perpendicular to the optical axis on the sensor-side surface of the sixth lens to the sensor-side surface of the sixth lens, and Max_Sag52 is the maximum distance in the optical axis direction from a straight line perpendicular to the optical axis on the sensor-side surface of the fifth lens to the sensor-side surface of the fifth lens. When Equation 86 is satisfied, light can be guided from the last spherical lens to the first aspherical lens by the curvature radius of the sensor-side surface of the fifth lens, and the effective diameters of the fifth and sixth lenses can be controlled.

|Max_Sag72|<|Max_Sag62| [Equation 87]

Max_Sag62 is the maximum distance in the optical axis direction from a straight line perpendicular to the optical axis on the sensor-side surface of the seventh lens to the sensor-side surface of the seventh lens. If Equation 87 is satisfied, the light can be guided from the aspherical lens to the aspherical lens by the curvature radius of the sensor-side surface of the sixth lens, and the effective diameter of the sixth and seventh lenses can be controlled.

|Max_Sag52|<|Max_Sag41||Max_Sag62|<|Max_Sag61||Max_Sag72|<|Max_Sag71| [Equation 87-1]

Equation 87-1 can satisfy at least one of the equations.

Max_Sag41 is the maximum distance in the optical axis direction from a straight line perpendicular to the optical axis on the object-side surface of the fourth lens to the object-side surface of the fourth lens. Max_Sag52 is the maximum distance in the optical axis direction from a straight line perpendicular to the optical axis on the sensor-side surface of the fifth lens to the sensor-side surface of the fifth lens. Max_Sag71 is the maximum distance in the optical axis direction from a straight line perpendicular to the optical axis on the object-side surface of the seventh lens to the object-side surface of the seventh lens.

$$Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} + {EY}^{12} + {FY}^{14} + … \qquad [ Equation 88 ]$$

In Equation 93, Z may mean Sag, a distance in the optical axis direction from an arbitrary position on the aspherical surface to the vertex of the aspherical surface. The Y may mean a distance in a direction perpendicular to the optical axis from an arbitrary position on the aspherical surface to the optical axis. The c may mean the curvature of the lens, and K may mean the conic constant. In addition, A, B, C, D, E, and F may mean aspheric coefficients.

The optical system 1000 and 1001 according to the embodiment may satisfy at least one or two or more of Equations 1 to 44. At least one or more of Equations 1 to 44 may satisfy at least one or more of Equations 45 to 87. In this case, the optical system 1000 and 1001 may have improved optical characteristics. In detail, when the optical system 1000 and 1001 satisfies at least one of Equations 1 to 44 and/or at least one of Equations 45 to 87, the optical system 1000 and 1001 may have improved resolution and may improve aberration and distortion characteristics. In addition, the optical system 1000 and 1001 may secure a BFL (Back focal length) for applying a vehicle image sensor 300, compensate for optical characteristic degradation due to temperature change, and minimize the gap between the last lens and the image sensor 300, thereby having good optical performance at the center and periphery portions of the FOV.

Table 2 shows the items of the Equations described above in the optical system 1000 and 1001 of the embodiment, including the TTL (mm), BFL, effective focal length F (mm), ImgH (mm), effective diameter CA (mm), thickness (mm), TTL (mm), TD (mm), which is the optical axis distance from the first surface S1 to the fourteenth surface S14, the focal lengths F1, F2, F3, F4, F5, F6, and F7 (mm) of each of the first to seventh lenses, the sum of refractive indices, the sum of Abbe numbers, the sum of thicknesses (mm), the sum of distances between adjacent lenses, the effective diameter characteristics, the diagonal FOV (Degree), the edge thickness ET, the focal lengths of the first and second lens groups, the F number, etc. of the optical system 1000 and 1001.

TABLE 2

| Items | First embodiment | Second embodiment |
|---|---|---|
| F | 14.907 | 14.867 |
| F1 | −35.688 | −33.101 |
| F2 | 41.887 | 54.558 |
| F3 | 32.309 | 27.168 |
| F4 | 14.790 | 13.052 |
| F5 | −10.402 | −9.990 |
| F6 | 44.941 | 57.501 |
| F7 | −65.510 | −73.274 |
| F_LG1 | 703.534 | −113.288 |
| F_LG2 | 18.948 | 14.775 |
| ET1 | 10.804 | 7.104 |
| ET2 | 1.205 | 1.530 |
| ET3 | 1.208 | 2.350 |
| ET4 | 3.457 | 3.797 |
| ET5 | 2.947 | 2.952 |
| ET6 | 5.566 | 3.761 |
| ET7 | 1.822 | 1.774 |
| F-number | 1.604 | 1.600 |
| ΣIndex | 12.149 | 12.154 |
| ΣAbbe | 333.388 | 321.916 |
| ΣCT | 28.849 | 25.141 |
| ΣCG | 6.256 | 5.480 |
| FOV | 34.230 | 34.139 |
| EPD | 9.295 | 9.292 |
| BFL | 2.600 | 2.800 |
| TD | 35.105 | 30.621 |
| ImgH | 4.626 | 4.626 |
| SD | 22.956 | 21.934 |
| TTL | 37.704 | 33.421 |
| Image sensor | 3840*2160 | 3840*2160 |

Table 3 shows the result values for Equation 1 to Equation 44 described above in the optical system 1000 and 1001 of the embodiment. Referring to Table 3, it can be seen that the optical system 1000 and 1001 satisfies at least one, two or more, or three or more of Equation 1 to Equation 44. In detail, it can be seen that the optical system 1000 and 1001 according to the embodiment satisfies all of Equation 1 to Equation 44. Accordingly, the optical system 1000 and 1001 can have good optical performance at the center and periphery of the field of view (FOV) and can have excellent optical characteristics.

TABLE 3

| | | First | Second |
|---|---|---|---|
| | | embodi- | embodi- |
| Equations | | ment | ment |
| 1 | 2 < CT1/CT2 < 8 | 5.636 | 3.179 |
| 2 | (CT7*CA7) < (CT1*CA1) | Satisfaction | Satisfaction |
| 3 | Po1 < 0 | −0.028 | −0.030 |
| 4 | 1.7 < n2 < 2.2 | 1.876 | 1.700 |
| 5 | 20 < FOV_H < 40 | 30.00 | 30.00 |
| 6 | L1R1 < 0 | −21.915 | −17.133 |
| 7 | 0.8 < BFL/Max_Sag72 to Sensor < 3 | 1.041 | 1.061 |
| 8 | 3 < CT1/CT7 < 9 | 6.405 | 4.304 |
| 9 | 0 < CT1/CT6 < 3 | 1.670 | 1.638 |
| 10 | 0 < CT45/CT6 < 5 | 1.156 | 1.949 |
| 11 | 0 < \|L2R1/L4R2\| < 1 | 0.634 | 0.901 |
| 12 | 0 < (CT45 − ET45) < 2 | 1.097 | 1.138 |
| 13 | 0 < CA11/CA31 < 2 | 1.035 | 0.954 |
| 14 | 0 < CA72/CA42 < 2 | 0.833 | 0.832 |
| 15 | 0 < CA12/CA21 < 2 | 1.012 | 1.014 |
| 16 | 0 < CA31/CA42 < 2 | 1.171 | 1.184 |
| 17 | 0 < CA41/CA52 < 2 | 1.345 | 1.384 |
| 18 | 0 < CA52/CA61 < 2 | 0.999 | 1.005 |
| 19 | 0.2 < GL_CA_Aver/ | 1.392 | 1.350 |
| | GM_CA_Aver < 2.2 | | |
| 20 | 0 < GL_nd_Aver/ | 1.060 | 0.950 |
| | GM_nd_Aver < 1.60 | | |
| 21 | CA6, CA7 < CA4 | Satisfaction | Satisfaction |
| 22 | CG1 < CG6 < CG2 | Satisfaction | Satisfaction |
| 23 | 0 < CT7/CG6 < 1 | 0.834 | 0.635 |
| 24 | CT2 < (2*CT3) < CT1 | Satisfaction | Satisfaction |
| 25 | (3*CT7) < CT1 < (2*CT6) | Satisfaction | Satisfaction |
| 26 | 2 < CT6/CT7 < 5 | 3.836 | 2.627 |
| 27 | 10 < L7R1/CT7 < 40 | 17.226 | 19.270 |
| 28 | 0 < L5R2/L7R1 < 10 | 0.314 | 0.326 |
| 29 | LIR1*L1R2 > 0 | 1512.134 | 795.420 |
| 30 | 0 < L5R1/L4R2 < 2 | 1.000 | 1.000 |
| 31 | 0 < L6R2/L6R1 < 3 | 1.668 | 1.272 |
| 32 | 0 < CT_Max/CG_Max < 1 | 0.308 | 0.366 |
| 33 | 2 < ΣCT/ΣCG < 7 | 4.611 | 4.588 |
| 34 | 8 < ΣIndex < 30 | 12.149 | 12.154 |
| 35 | 10 < ΣAbb/ΣIndex < 50 | 27.442 | 26.487 |
| 36 | Distotion < 2 | Satisfaction | Satisfaction |
| 37 | 0 < ΣCT/ΣET < 2 | 1.068 | 1.081 |
| 38 | 0.5 < CA11/CA_Min < 2.5 | 1.594 | 1.440 |
| 39 | 1 < CA_Max/CA_Min < 5 | 1.635 | 1.521 |
| 40 | 1 < CA_Max/CA_Aver < 3 | 1.202 | 1.171 |
| 41 | 0.5 < CA_Min/CA_Aver < 2 | 0.735 | 0.770 |
| 42 | 1 < CA_Max/(2*ImgH) < 3 | 1.434 | 1.466 |
| 43 | 1 < TD/CA_Max < 4 | 2.646 | 2.545 |
| 44 | 1 < F/CA61 < 10 | 1.609 | 1.624 |

Table 4 shows the results for Equation 45 to Equation 87 described above in the optical system 1000 and 1001 of the embodiment. Referring to Table 4, it can be seen that the optical system 1000 and 1001 satisfies at least one, two or more, or three or more of Equation 45 to Equation 87. In detail, it can be seen that the optical system 1000 and 1001 according to the embodiment satisfies all of Equation 1 to Equation 87. Accordingly, the optical system 1000 and 1001 can have good optical performance and excellent optical characteristics at the center and periphery portions of the FOV.

TABLE 4

| | | First | Second |
|---|---|---|---|
| Equations | | embodiment | embodiment |
| 45 | 0 < F/\|LIR1\| < 1 | 0.680 | 0.868 |
| 46 | Max (CT/ET) < 3 | 0.939 | 0.909 |
| 47 | 0 < EPD/\|LIR1\|< 1 | 0.424 | 0.542 |
| 48 | −10 < F1/F3 < 0 | −1.105 | −1.218 |
| 49 | Po4 * Po5 < 0 | Satisfaction | Satisfaction |
| 50 | 15 < v4 − v5 < 60 | 32.257 | 32.257 |
| 51 | 0 < \|F1/F \| < 20 | 2.394 | 2.226 |
| 52 | 0 < \| F5/F6 \| < 1 | 0.231 | 0.174 |
| 53 | 0 < \| F5/F7 \| < 1 | 0.159 | 0.136 |
| 54 | 0 < \| F6/F1 \| < 2 | 1.259 | 1.737 |
| 55 | 0 < \|F37\|/F12 < 3 | 0.027 | 0.130 |
| 56 | 0 < F37/F6 < 1 | 0.422 | 0.257 |
| 57 | 0 < \|F37/F7\| < 1 | 0.289 | 0.202 |
| 58 | 0 < F6/F < 5 | 3.015 | 3.868 |
| 59 | F37 < TTL | Satisfaction | Satisfaction |
| 60 | 1 < nGL/nGM < 4 | 2.500 | 2.500 |
| 61 | nSS/nAS | 2.500 | 2.500 |
| 62 | CA3 < CA2 < CA1 | Satisfaction | Satisfaction |
| 63 | 0 < ΣGM_CT/ΣGL_CT < 1 | 0.362 | 0.276 |
| 64 | 10 < TTL < 50 | 37.704 | 33.421 |
| 65 | 2 < ImgH | 4.626 | 4.626 |
| 66 | 2 < BFL < 7 | 2.600 | 2.800 |
| 67 | 0.1 < BFL/CG2 < 2 | 0.831 | 1.737 |
| 68 | CG6 < BFL | Satisfaction | Satisfaction |
| 69 | 3 < F < 40 | 14.907 | 14.867 |
| 70 | FOV < 45 | 34.230 | 34.139 |
| 71 | 1 < TTL/CA_Max < 5 | 2.841 | 2.670 |
| 72 | 2 < TTL/ImgH < 15 | 8.150 | 7.224 |
| 73 | 0.1 < BFL/ImgH < 2 | 0.562 | 0.605 |
| 74 | 5 < TTL/BFL < 20 | 14.502 | 11.936 |
| 75 | 1 < TTL/F < 3 | 2.529 | 2.248 |
| 76 | 1 < F/BFL < 10 | 5.733 | 5.310 |
| 77 | 1 < F/ImgH < 5 | 3.222 | 3.214 |
| 78 | 1 < F/EPD < 5 | 1.604 | 1.600 |
| 79 | 0 < BFL/TD < 0.3 | 0.0741 | 0.0914 |
| 80 | 0 < EPD/Imgh/FOV < 0.2 | 0.0145 | 0.0146 |
| 81 | 5 < FOV/F# < 40 | 21.343 | 21.337 |
| 82 | 1< ΣGL_CT/F# < 20 | 13.210 | 12.313 |
| 83 | 1 < ΣGM_CT/F# < 10 | 4.778 | 3.400 |
| 84 | 1 < ΣGL_Index/F# < 10 | 5.500 | 5.345 |
| 85 | 1 < ΣGM_Index/F# < 10 | 2.075 | 2.251 |
| 86 | Max_Sag62 < Max_Sag52 | Satisfaction | Satisfaction |
| 87 | Max_Sag72 < Max_Sag62 | Satisfaction | Satisfaction |

### Third Embodiment

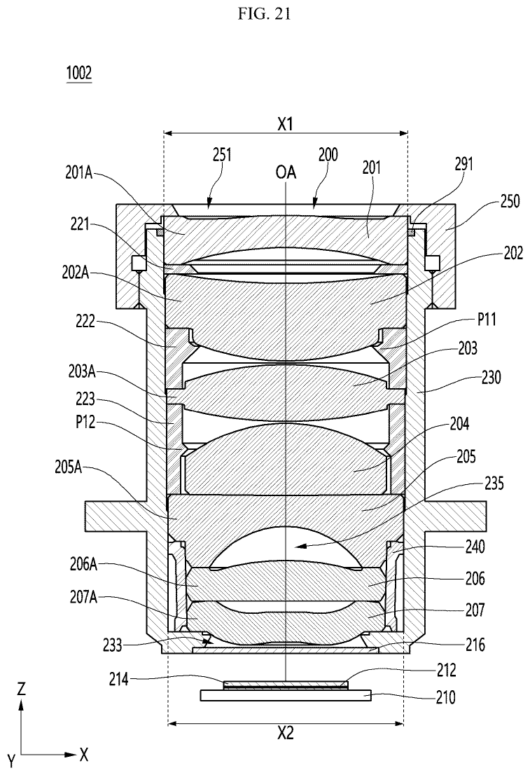

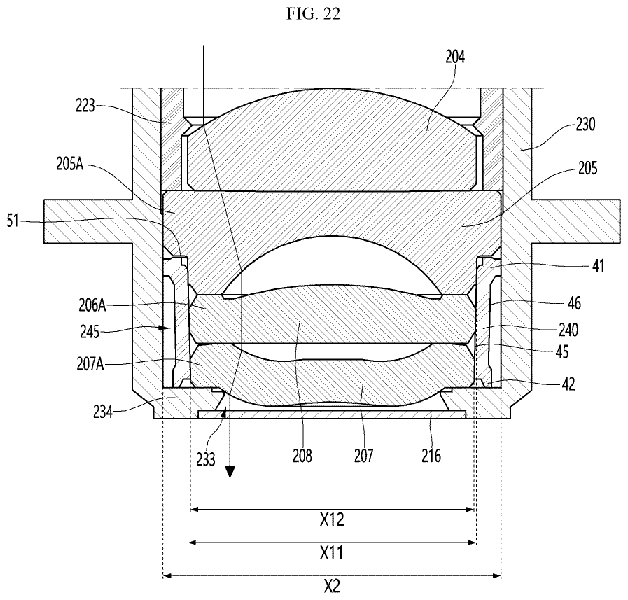

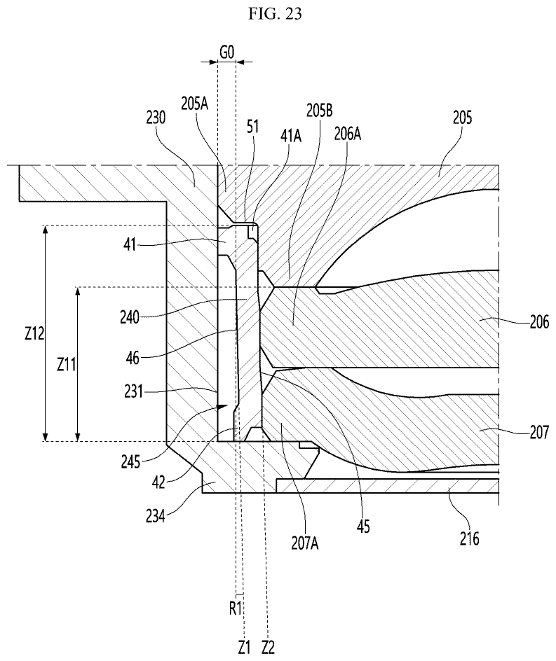

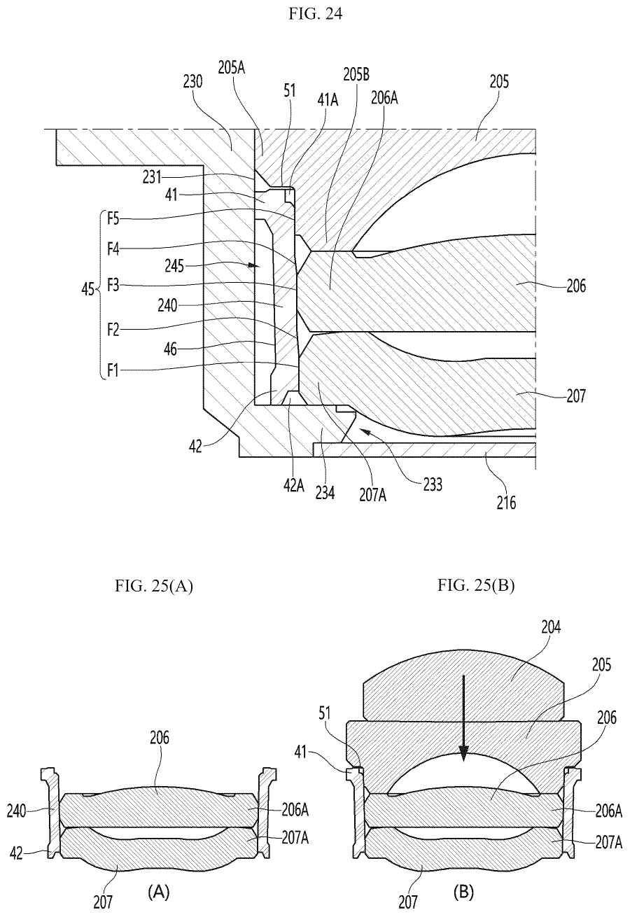

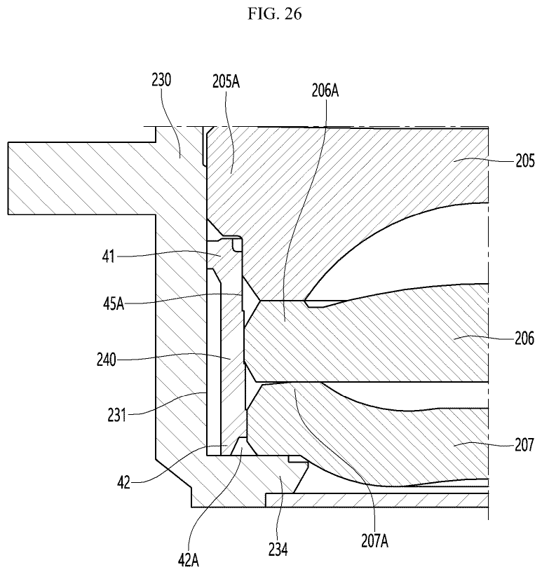

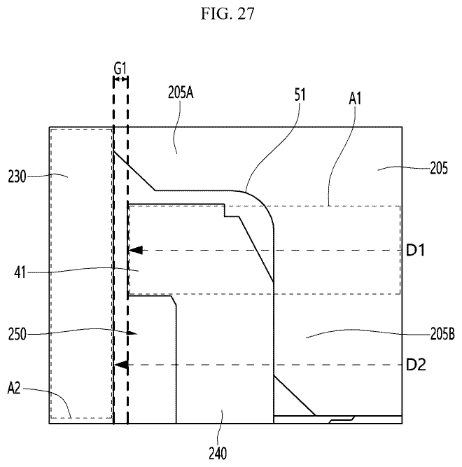

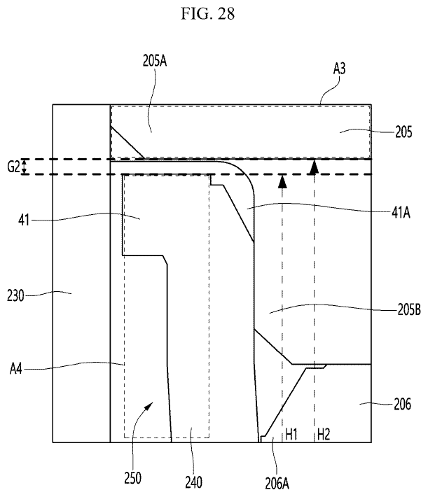

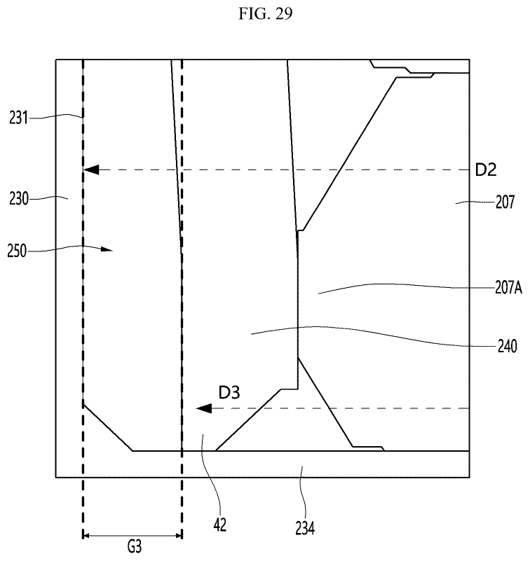

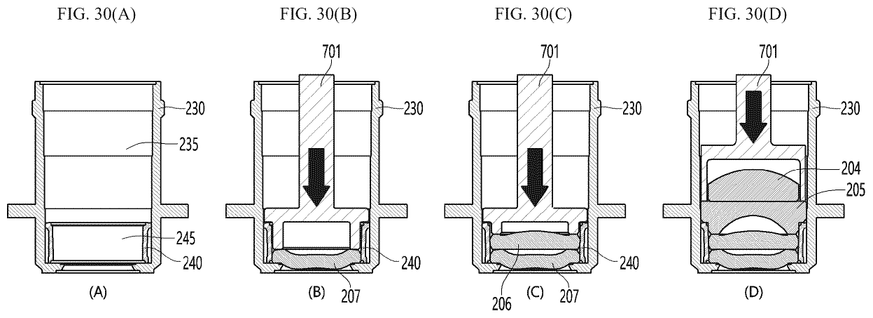

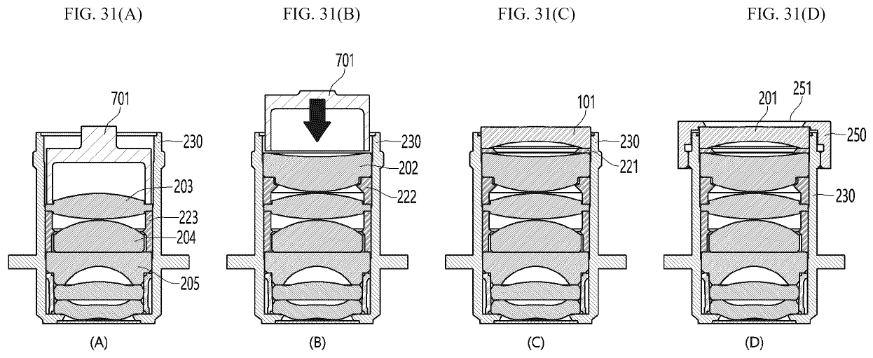

FIG. 21 is an example of a side cross-sectional view of a camera module according to a third embodiment of the invention, FIG. 22 is a drawing showing a sensor-side area of a first barrel in the camera module of FIG. 21, FIG. 23 is a drawing explaining the combination of the second barrel and the sensor-side lenses of the camera module of FIG. 22, FIG. 24 is a drawing explaining the second barrel of FIG. 22, FIGS. 25(A) and 25(B) are examples of combining lenses to the second barrel of FIG. 22, FIG. 26 is another example of the second barrel in the camera module of FIG. 21, FIG. 27 is a drawing explaining a gap G1 between the outermost side of the second barrel and the inner side of the first barrel in the camera module of the third embodiment of the invention, FIG. 28 is a drawing explaining a gap G2 between the object-side surface of the second barrel and the sensor-side lens having a different material from the second barrel in the camera module of the third embodiment of the invention, FIG. 29 is This is a drawing explaining a gap G3 between the outer surface of the second barrel and the first barrel in the camera module of the third embodiment of the invention, and FIGS. 30(A)-31(D) are drawings explaining a joining process of the camera module of FIG. 21.

Referring to FIG. 21 to FIG. 25(B), the camera module 1002 according to the third embodiment of the invention may include a lens portion 200 having a plurality of lenses, a first barrel 230 in which the plurality of lenses is stacked, a second barrel 240 on the inner side of the first barrel 230, and at least one gap-maintaining member arranged on the outer side between the plurality of lenses. The second barrel 240 may be penetrated from an upper portion to a lower portion. It may include a cover 250 coupled to the upper side of the first barrel 230. The gap-maintaining member may maintain a gap between two adjacent lenses, and may function as a light shield, a spacer, or a spacing member.

A ring member 291 may be arranged around the first barrel 230 and the first lens. The ring member 291 may be made of an elastic material or a resin material such as silicone or epoxy. As another example, the ring member 291 may be coupled between the first barrel 230 and the cover. The ring member 291 may perform waterproof and dustproof functions on the inside and/or outside of the first barrel 230.

The camera module 1002 may include a substrate 210 and an image sensor 212 arranged on the sensor side of the lens portion 200, that is, on the sensor side of the last lens. The camera module 1002 may include a cover glass 214 and an optical filter 216 between the last lens of the lens portion 200 and the image sensor 212.

The image sensor 212 may be disposed on the substrate 210. The substrate 210 may be mounted, settled, in contact with, fixed, temporarily fixed, supported, or coupled to the image sensor 212 on a plane intersecting the optical axis Z0. Alternatively, according to another embodiment, a groove or hole (not shown) capable of accommodating the image sensor 212 may be formed in the substrate 210, and the embodiment is not limited to a specific form in which the image sensor 212 is disposed on the substrate 210. The substrate 210 may be a rigid PCB or FPCB. The image sensor 212 may perform a function of converting light passing through the lens portion 200 into image data. The image sensor 212 may be any one of a CCD (Charge coupled device) or a CMOS (Complementary metal-oxide semiconductor), CPD, or CID. When the image sensor 212 is plural, one of them may be a color (RGB) sensor and the other may be a black and white sensor.

The optical filter 216 may be disposed between the lens portion 200 and the image sensor 212. The optical filter 216 may filter light corresponding to a specific wavelength range for light passing through the lenses 201-207. The optical filter 216 may be an infrared (IR) blocking filter that blocks infrared rays or an ultraviolet (UV) blocking filter that blocks ultraviolet rays, but the embodiment is not limited thereto. The optical filter 216 may be disposed on the image sensor 212. The cover glass 214 is disposed between the optical filter 216 and the image sensor 212, and may protect the upper portion of the image sensor 212 and inhibit the reliability of the image sensor 212 from being deteriorated.

The lens portion 200 may include an optical system in which five or more lenses are laminated, or an optical system in which nine or less lenses are laminated. The lens portion 200 may include six to eight solid lenses. The lens portion 200 may include lenses of different materials, for example, lenses made of plastic and lenses made of glass. For example, the lens portion 200 may include one or more plastic lenses and two or more glass lenses. The ratio of the number of lenses made of plastic and the number of lenses made of glass may be 1:2 to 1:4. The number of lenses made of glass may be more or less than the number of lenses made of plastic.

In the lens portion 200 according to the third embodiment of the invention, the number of lenses made of glass may be two or more than the number of lenses made of plastic. Here, the lens portion 200 may be laminated with plastic lenses or/and glass lenses. Here, the plastic material is higher than the coefficient of linear thermal expansion (CTE) of the glass material, for example, 5 times higher, and the change value of the refractive index according to the function of temperature can be higher than that of the glass material, for example, 10 times higher. However, since the lenses made of the plastic material are easier to manufacture and design than the lenses made of the glass material, the demand for their use is increasing.

In the camera module 1002, the lens having the maximum effective diameter may be a lens close to the object side, or one of the lenses between the two lenses on the object side and the two lenses on the sensor side. Preferably, the lens having the maximum effective diameter may be made of glass. The effective diameter may be the diameter of the effective region where effective light is incident on each lens. The effective diameter is the average of the effective diameter of the object-side surface and the effective diameter of the sensor-side surface of each lens. The third embodiment of the invention may reduce the weight of the camera module by further mixing a plastic lens into the camera module 1002, can provide a lower manufacturing cost, can suppress the deterioration of optical characteristics due to temperature change, various types of plastic lenses can replace glass lenses, and can facilitate polishing and processing of lens surfaces such as aspherical or free-form surfaces.

The first barrel 230 has a hole 235 extending from the upper portion to the lower portion, and a plurality of lenses are combined inside the hole, and the plurality of lenses can be combined through the upper opening of the first barrel 230 or the opening 251 of the cover 250. As shown in FIGS. 30(A)-31(D), the plurality of lenses can be sequentially stacked from the lens 207 closest to the sensor side to the lens 201 closest to the object side. As another example, the lenses can be combined from the sensor side toward the object side, or can be combined in both directions. The lens closest to the object side can be the first lens 201, and the sensor-side lens closest to the optical filter 216 or the image sensor 212 may be the n-th lens or the last lens 207, and n can be an integer greater than or equal to 5, for example, one of 6, 7, and 8.

The lens portion 200 may have a plurality of lenses aligned along the optical axis OA from the object side toward the image sensor 212, for example, a first lens 201, a second lens 202, a third lens 203, a fourth lens 204, a fifth lens 105, a sixth lens 106, and a seventh lens 207 may be aligned. The second lens 202 may be disposed between the first lens 201 and the third lens 203. The fourth lens 204 may be disposed between the third lens 203 and the fifth lens 205, and the sixth lens 206 may be disposed between the fifth lens 205 and the seventh lens 207. The camera module 1002 according to the third embodiment may include an aperture stop (e.g., 221). The aperture stop can control the amount of light incident on the optical system 1002. The aperture stop can be arranged at a set position. For example, the aperture stop may be functioned by a first spacer 221 arranged around the periphery between the first lens 201 and the second lens 202, or by a light-blocking material coated on the surface of the first spacer 221. Alternatively, a light-blocking material may be coated around the perimeter of the sensor-side surface of the first lens 201 or the perimeter of the object-side surface of the second lens 202 to function as an aperture stop for controlling the amount of light.

The first spacer 221 is disposed around the perimeter of the first and second lenses 201 and 202, and can maintain a gap between the first and second lenses 201 and 202. The outer surface of the first spacer 221 may be in contact with the inner surface of the first barrel 230 and may be provided in a ring shape. The first spacer 221 may be made of a metal material or a non-metal material, and may be formed of, for example, aluminum material or plastic material.

For convenience of explanation, the invention will be described with seven lenses, and the lenses 201-207 in the first barrel 230 will be described as being coupled from the sensor side toward the object side. The lens portion 200 may include any one of the lenses of the first and second embodiments inside the first barrel 230. In addition, the second barrel 240 may have the last lens of the first and second embodiments arranged inside it, or the sixth and seventh lenses coupled thereto.

The first lens 201 may have positive (+) or negative (−) refractive power on the optical axis OA. The first lens 201 may have a negative (−) refractive power. The first lens is arranged closest to the object side among the lenses, and may have, for example, a convex object-side surface and a concave sensor-side surface on the optical axis. Since the object-side surface of the first lens has a convex shape on the optical axis, it may suppress the problem of external foreign substances or dust accumulating. In addition, the first lens may be formed of a maintenance material. The first lens may be provided in an injection-molded shape made of glass, and the object-side surface and the sensor-side surface may be aspherical.

The first lens 201 made of glass may reduce changes in the center position and the curvature radius due to temperature changes in the surrounding environment, and may protect the incident-side surface of the optical system 1002. In addition, the flange portion 201A of the first lens 201 may have a flat object-side surface, and the flat surface may block foreign substances from entering from the outside. In addition, since the first lens 201 is made of a mold material, the sealing force with the cover 250 may be improved. A cover 250 is coupled to the upper circumference of the flange portion 201A of the first lens 201, and the cover 250 may be coupled to the upper circumference of the first barrel 230.

The second lens 202 may have positive (+) or negative (−) refractive power on the optical axis OA. The second lens 202 may have positive (+) refractive power. For example, the second lens may have a concave object-side surface and a convex sensor-side surface on the optical axis. In contrast, the second lens 202 may have a convex meniscus shape toward the object side or a concave shape on both sides. The second lens may be formed of a plastic material or a glass material, for example, may be formed of a glass material.

The third lens 203 may have positive (+) or negative (−) refractive power on the optical axis OA. The third lens 203 may have positive (+) refractive power. The third lens may have, for example, a convex object-side surface and a convex sensor-side surface on the optical axis. In contrast, the third lens 203 may have a convex meniscus shape toward the sensor side or a concave shape on both sides. The third lens 203 may be formed of a plastic material or a glass material, for example, may be formed of a glass material.

The fourth lens 204 may have positive (+) or negative (−) refractive power on the optical axis OA. The fourth lens 204 may have positive (+) refractive power. The fourth lens may have, for example, a convex object-side surface and a concave sensor-side surface on the optical axis. Alternatively, the fourth lens 204 may have a meniscus shape convex toward the sensor side or a concave shape on both sides. The fourth lens 204 may be formed of a plastic material or a glass material, for example, may be formed of a glass material.

The fifth lens 205 may have positive (+) or negative (−) refractive power on the optical axis OA. The fifth lens 205 may have negative (−) refractive power. The fifth lens 205 may include a plastic or glass material. For example, the fifth lens 205 may be provided of a glass material. The fifth lens 205 may have, for example, a convex object-side surface and a concave sensor-side surface on the optical axis. Alternatively, the fifth lens 205 may have a meniscus shape convex toward the sensor side or a concave shape on both sides.

The fourth lens 204 and the fifth lens 205 may be bonded. The sensor-side surface of the fourth lens 204 and the object-side surface of the fifth lens 205 may be bonded. The fourth and fifth lenses 204 and 205 may have opposite refractive powers. The composite refractive power of the fourth and fifth lenses 204 and 205 may have positive refractive power. The product of the refractive power of the object-side lens of the cemented lens and the refractive power of the sensor-side lens may be less than 0. The product of the focal length of the object-side lens of the cemented lens and the focal length of the sensor-side lens may be less than 0. Accordingly, the aberration characteristics of the optical system can be improved. If the refractive powers of the two lenses of the cemented lens are the same, there is a limit to the aberration improvement. The composite refractive power of the cemented lens has positive refractive power, and the object-side third lens 203 and the sensor-side sixth lens 206 based on the cemented lens can have positive refractive power. Accordingly, the third lens 203, the cemented lens, and the sixth lens 206 can refract some of the incident light in the direction of the optical axis.

The diameter of the fifth lens 205 may be larger than the diameter of the fourth lens 204, and the outer surface of the fourth lens 204 may be spaced apart from the inner surface of the first barrel 230, and the outer surface of the flange portion 205A of the fifth lens 205 may be in contact with the inner surface of the first barrel 230.

The sixth lens 206 may have positive (+) or negative (−) refractive power on the optical axis OA. The sixth lens 206 may have positive (+) refractive power. The sixth lens 206 may include a plastic or glass material. For example, the sixth lens 206 may be provided as a plastic material. The sixth lens 206 may have a convex object-side surface and a convex sensor-side surface on the optical axis. As another example, the sixth lens 206 may have a meniscus shape convex toward the object side, a meniscus shape convex toward the sensor side, or a biconcave shape.

The seventh lens 207 may have positive (+) or negative (−) refractive power on the optical axis OA. The seventh lens 207 may have negative (−) refractive power. The seventh lens 207 may include a plastic or glass material. For example, the seventh lens 207 may be a plastic material. The seventh lens 207 may have a meniscus shape convex toward the object side on the optical axis. Alternatively, the seventh lens 207 may have a meniscus shape convex toward the sensor side on the optical axis OA, or a biconcave shape.

The seventh lens 207 may be a plastic lens closest to the image sensor 230. By arranging the plastic lens closest to the image sensor 212, the optical performance can be improved by the lens surface having an aspherical surface, thereby controlling the effect on the aberration characteristics and resolution. In addition, by arranging the plastic lens closest to the image sensor 212, the lens can be insensitive to the assembly tolerance compared to the glass lens. In other words, being insensitive to the assembly tolerance means that even if the assembly is slightly different from the design during assembly, the optical performance may not be significantly affected. Here, the glass lens can be defined as the first lens group, and the plastic lens(es) may be defined as the second lens group. The optical axis distance of the first lens group is the optical axis distance from the object-side surface of the first lens 201 to the sensor-side surface of the fifth lens 205, and the optical axis distance of the second lens group is the optical axis distance from the object-side surface of the sixth lens 206 to the sensor-side surface of the seventh lens 207.

The second spacer 222 is a member that maintains the gap between the flange portions 202A and 203A of the second and third lenses 202 and 203. The second spacer 222 may be made of a metal or non-metal material, for example, aluminum or copper, or plastic. The inner protrusion P11 of the second spacer 222 may be fitted into a step portion formed around the convex sensor-side surface of the second lens 202. The third spacer 223 may maintain the gap between the flange portions 203A and 205A of the third lens 203 and the fifth lens 205. The third spacer 223 may maintain the gap between the third lens 203 and the cemented lens. The third spacer 223 may be made of a metal or non-metal material, for example, aluminum or copper, or plastic. The third spacer 223 is arranged between the outer surface of the fourth lens 204 and the inner surface of the first barrel 230, and an inner protrusion P12 of the third spacer 223 may support the perimeter of the convex object-side surface of the fourth lens 204.

When the second and third spacers 222 and 223 are made of a metal material, they may conduct heat transferred from the inner lenses to the first barrel 230. That is, they may dissipate heat conducted through the flange portion of the glass lens. When the spacer 221, 222, and 223 is made of a metal material, it may include at least one of In, Ga, Zn, Sn, Al, Ca, Sr, Ba, W, U, Ni, Cu, Hg, Pb, Bi, Si, Ta, H, Fe, Co, Cr, Mn, Be, B, Mg, Nb, Mo, Cd, Sn, Zr, Sc, Ti, V, Eu, Gd, Er, Lu, Yb, Ru, Y, and La. The oxide film may be an oxide material treated with black oxide or brown oxide using copper. Here, the first barrel 230 may be made of a metal or non-metal material, and may be made of, for example, aluminum or copper. Accordingly, if the first barrel 230 is made of a metal material, it can dissipate heat generated from the spacers 221, 222, and 223 and the flange portion of each lens, thereby inhibiting a decrease in reliability of optical characteristics due to temperature changes of the camera module exposed to the outside. The first barrel 230 may have an upper diameter X1 of the inner portion larger than a lower diameter X2. Here, the upper diameter X1 may be the maximum distance of the area facing the outer surface of the flange portion 201A of the first lens 201. The lower diameter X2 may be the maximum distance of the region facing the outer surface of the flange portion 207A of the last lens 207.

In the third embodiment of the invention, a second barrel 240 may be combined within the first barrel 230. Each of the first barrel 230 and the second barrel 240 may have at least one different lens on the inside. Here, the inside of the first barrel 230 may be in contact with the outer surfaces of at least two or more lenses. The inside of the second barrel 240 may be in contact with the outer surfaces of at least one or more lenses. The second barrel 240 may be an inner barrel disposed on a portion of the inside of the first barrel 230. For example, the second barrel 240 may be disposed on the sensor side rather than the object side among the inner regions of the first barrel 230. The second barrel 240 may be disposed closest to the sensor side among the inner regions of the first barrel 230. The second barrel 240 may be disposed on the lower locking protrusion 234 of the first barrel 230. The second barrel 240 may be arranged on the outer circumference of the lower opening 233 of the first barrel 230.

The first barrel 230 may be formed of a first material, and the second barrel 240 may be formed of a second material. The first and second barrels 230 and 240 may be made of different materials. The first and second barrels 230 and 240 may have different thermal expansion coefficients. The second barrel 240 may be made of a material having a higher thermal expansion coefficient than that of the first barrel 230. For example, the first barrel 230 may be made of a metal, such as aluminum, and the second barrel 240 may be made of a non-metal, such as resin or plastic. The first barrel 230 may have a thermal expansion coefficient of less than 30, and the second barrel 240 may have a thermal expansion coefficient of 50 or more. The difference in the thermal expansion coefficients of the first and second barrels 230 and 240 may be 20 or more. The second barrel 240 may have a thermal expansion coefficient difference of 3 or less or 2 or less or the same as that of the plastic lens.

The height Z12 of the second barrel 240 may be less than 50% or 40% or less of the height of the first barrel 230. The height Z12 of the second barrel 240 may be greater than the center thickness of the plastic lenses or the optical axis distance of the second lens group. The height Z12 of the second barrel 240 may be greater than the sum of the center thickness of the plastic lenses and the center distance of the plastic lenses. For example, the height Z12 of the second barrel 240 may be greater than the center thickness of the sixth and seventh lenses 206 and 207, for example, greater than the sum of the center thicknesses of the sixth and seventh lenses 206 and 207 and the center distance between the sixth and seventh lenses 206 and 207. The height Z12 of the second barrel 240 may be higher than an upper end height Z11 of the flange portion 206A of the sixth lens 206. The height Z12 of the second barrel 240 may be smaller than the optical axis distance of the first lens group and larger than the optical axis distance of the second lens group. The height Z12 of the second barrel 240 may be smaller than the optical axis distance from the center of the object-side surface of the fifth lens 205 to the center of the sensor-side surface of the seventh lens 207. The height Z12 of the second barrel 240 may be greater than the optical axis distance of two lenses adjacent to the image sensor and less than the optical axis distance of three lenses. The height Z12 of the second barrel 240 may be 5 mm or more, for example, in the range of 5 mm to 20 mm or 10 mm to 20 mm. If the height Z12 of the second barrel 240 is out of the range, the camera module may become larger or cover the outer surface of the glass lens, which may cause a problem due to temperature change. If it is smaller than the range, the plastic lenses 206 and 207 may not all be covered or it may be difficult to guide the lower periphery of the fifth lens 205 to be aligned on the sixth lens 206. The height of the first barrel 230 is the height from the lower end to the upper end of the first barrel 230 in the optical axis direction.

The lenses that come into contact with the inner surface of the second barrel 240 may be three or four or more lenses made of glass. For example, the lenses that come into contact with the inner surface of the second barrel 240 may be the first to third lenses. The outer surface of the flange portion 205A of the fifth lens 205 may come into contact with the inner surface of the second barrel 240. The lenses that come into contact with the inner surface of the first barrel 230 may be one or two or more lenses. For example, the lenses that come into contact with the inner surface of the first barrel 230 may be the sixth and seventh lenses. The outer surface of the support portion 205B of the fifth lens 205 may come into contact with the inner surface of the first barrel 230.

The fifth lens 205 may come into contact with the inner surface of the first barrel 230 and the inner surface of the second barrel 240. The outer surface of the flange portion 205A of the fifth lens 205 may be in contact with the inner surface of the first barrel 230, and the outer surface of the support portion 205B of the lower circumference may be in contact with the inner surface of the second barrel 240. The outer surface of the flange portion of the cemented lens may be in contact with the outer surface of the first barrel 230, and the outer surface of the support portion 205B mounted on the sixth lens 206 may be in contact with the outer surface of the second barrel 240. The first barrel 230 and the second barrel 240 may be in contact with lenses of different materials. For example, the inner surface 231 of the first barrel 230 may be in contact with the outer surface of lenses made of glass. The inner surface 45 of the second barrel 240 may be in contact with the outer surface of lenses made of plastic. The inner surface 45 of the second barrel 240 may be in contact with the outer surface of the flange portion 206A and 207A of the sixth and seventh lenses 206 and 207. The upper portion of the inner surface 45 of the second barrel 240 may be in contact with the outer surface of the support portion 205B of the fifth lens 205.

The material of the second barrel 240 and the material of the sixth and seventh lenses 206 and 207 may be the same material, for example, a plastic material. The plastic material may expand more than the aluminum material at high temperatures (85 degrees or higher), and the plastic material may shrink less than the aluminum material at low temperatures (i.e., −40 degrees or lower). Accordingly, when the sixth and seventh lenses 206 and 207 expand or contract according to temperature changes, the second barrel 240 can suppress the center misalignment of the sixth and seventh lenses 206 and 207 by expanding or contracting. In other words, the second barrel 240 can minimize the stress and decenter of the plastic lens(es) according to temperature changes. In addition, since the second barrel 240 and the sixth and seventh lenses 206 and 207 have the same coefficient of thermal expansion, the second barrel 240 can flow together to minimize the stress generated when the plastic lens expands at high temperatures, and can minimize the decenter with the glass lens generated when it contracts at low temperatures. This camera module 1002 can minimize the change in resolution according to temperature changes.

The diameters of the plastic material sixth and seventh lenses 206 and 207 are smaller than the diameters of the glass material first, second, third, and fifth lenses 201, 202, 203, and 205. The sixth and seventh lenses 206 and 207 can reduce the amount of expansion due to temperature change by designing the flange length to be short. More precisely, the amount of expansion can be reduced in the direction perpendicular to the optical axis. The linear expansion coefficients of the glass material and the plastic material are different. At high temperatures, the plastic material lens expands more than the glass material lens. Therefore, by designing the diameter of the plastic material lens to be shorter than the diameter of the glass material lens, the amount of expansion of the two different materials at the same temperature change can be adjusted to be similar or the same. More precisely, the diameter length of the plastic material lens and the diameter length of the glass material lens after expansion at high temperatures can be made similar or the same.

As shown in FIG. 22, the lower inner diameter (i.e., the minimum inner diameter) of the second barrel 240 may be the same as the diameter of the seventh lens 207, which is the last lens. The inner diameter of the center of the second barrel 240 may be the same as the outer diameter of the sixth lens 206, which is the lens between the last lens 207 and the fifth lens 205 made of glass. The outer diameter of the seventh lens 207 may be smaller than the outer diameter of the sixth lens 206. Here, the outer diameters of the sixth and seventh lenses 206 and 207 are the outer diameters of the flange portions 206A and 207A. The upper inner diameter of the second barrel 240 may be larger than the outer diameter of the sixth lens 206 and the same as the outer diameter of the support portion 205B of the fifth lens 205. Here, the support portion 205B of the fifth lens 205 has a leg shape and comes into contact with the lower plastic lens 206, so that when the temperature changes, the glass lens 205 can fix the plastic lens 206, thereby suppressing the expansion of the plastic lens 206, and aligning the centers of the fifth and sixth lenses 205 and 206.

Here, as shown in FIGS. 25(A) and 25(B), the second barrel 240 can guide the perimeter of the support portion 205B of the fifth lens 205 so that it can be joined inward after the seventh lens 207 is laminated and the sixth lens 206 is laminated on the seventh lens 207. Accordingly, the support portion 205B of the fifth lens 205 may be inserted into the upper inner side of the second barrel 240 and laminated on the flange portion 206A of the sixth lens 206. By joining the upper portion of the second barrel 240 to the outer side of the support portion 205B of the fifth lens 205, the region between the second barrel 240 and the support portion 205B may be used as a structure for assembling the support portion 205B of the fifth lens 205.

As shown in FIG. 24, the inner surface of the second barrel 240 may include a first vertical contact portion F1 for surface contact with the outer surface of the flange portion 207A of the seventh lens 207, a second vertical contact portion F3 for surface contact with the outer surface of the flange portion 206A of the sixth lens 206, and a third vertical contact portion F5 for surface contact with the outer surface of the support portion 205B of the fifth lens 205. The inner diameters of the first to third contact portions F1, F3, and F5 may have a relationship of first contact portion<second contact portion<third contact portion. The inner surface of the second barrel 240 may include a first non-contact portion F2 extending between the first and second contact portions F1 and F3, and a second non-contact portion F4 extending between the second and third contact portions F3 and F5. The first non-contact portion F2 may include a region inclined in a direction away from the optical axis from the first contact portion F1 toward the second contact portion F2. The second non-contact portion F4 may include a region inclined in a direction away from the optical axis from the second contact portion F3 toward the third contact portion F5. As shown in FIG. 23, the outer surface of the second barrel 240 may have an inclined surface with respect to a vertical straight line Z1 opposite the first non-contact portion F2, the second contact portion F3, and the second non-contact portion F4, and the angle R1 of the inclined surface may be 5 degrees or less. The vertical straight line Z1 may be parallel to a straight line Z2 passing through the upper and lower ends of the outer surface of the second barrel 240, and may be spaced apart from the inner surface 231 of the first barrel 230 by a predetermined distance G0. The outer side between the upper and lower ends of the second barrel 240 may include a space region 245 having the distance G0 from the inner surface 231 of the first barrel 230.

The lower end of the second barrel 240 may be in contact with the inner lower end of the first barrel 230. For example, the second barrel 240 may include a lower protrusion 42 and an outer protrusion 41. The lower protrusion 42 may be seated on a locking protrusion 234 extending in the optical axis direction from the lower end of the first barrel 230 at the lower end of the second barrel 240. A concave lower groove 42A is arranged on the inner periphery of the lower protrusion 42, so as to inhibit a problem of interfering with the joining of the lens due to a structure such as a burr generated during injection. The lower protrusion 42 may be in contact with the lower end of the second barrel 240 by at least 0.2 mm or more, so as to support the lower end of the second barrel 240. The outer protrusion 41 of the second barrel 240 may be spaced apart from the inner surface of the first barrel 230 and may be spaced apart from the inner surface 231 of the first barrel 230 by internal lenses. The outer protrusion 41 may protrude outwardly from the upper portion of the second barrel 240 and may overlap with the support portion 205B of the fifth lens 205 in the horizontal direction. The upper end of the second barrel 240 may be spaced apart from the lower surface of the flange portion 205A of the fifth lens 205, and may be spaced apart at a distance such that the second barrel 240 and the fifth lens 205 do not come into contact even when the plastic lens expands at a high temperature. The outer protrusion 41 of the second barrel 240 has a concave upper groove 41A on the inner circumference, and the upper groove 41A may inhibit a problem that interferes with the bonding with the fifth lens 205 due to a structure such as a burr generated during injection.

If, in the comparative example where the material of the second barrel 240 is plastic and the sixth and seventh lenses 206 and 207 are plastic, and the embodiment where the material of the second barrel 240 is aluminum and the sixth and seventh lenses 206 and 207 are plastic, in the comparative example, when the second barrel 240 is plastic, the sixth and seventh lenses 206 and 207 flow or expand in the horizontal direction or/and the vertical direction when expanded, so that the stress transmitted to the sixth and seventh lenses 206 and 207 can be reduced. In an embodiment, if the second barrel 240 is made of a metal such as aluminum, even if the sixth and seventh lenses 206 and 207 are expanded, the second barrel 240 is supported in a fixed position, so that the stress transmitted to the sixth and seventh lenses 206 and 207 may increase.

Referring to FIGS. 27 to 29, the upper outer protrusion 41 of the second barrel 240 may be spaced apart from the inner surface 231 of the first barrel 230 by a first gap G1. The upper end of the second barrel 240 may be spaced apart from the lower surface of the flange portion 205A of the fifth lens 205 by a second gap G2. The lower protrusion 42 of the second barrel 240 may be spaced apart from the outer surface 231 of the first barrel 230 by a third gap G3. Here, the lower protrusion 42 of the second barrel 240 may extend downwardly in an outward step, or, as in FIG. 26, may have an outer surface with an inclined surface and may extend toward the sensor side. The first gap G1 is a distance that can flow when the plastic lenses expand in the horizontal direction, and may be 0.1 mm or less, for example, in the range of 0.05 mm to 0.1 mm. The first gap G1 may be a maximum gap that can be expanded when the first barrel 230 and the sixth and seventh lenses 206 and 207 are made of plastic material, when thermally expanded in the horizontal direction at a high temperature, that is, in the range of 85 degrees to 205 degrees. The horizontal direction may be a direction orthogonal to the optical axis. The second gap G2 is a distance that can flow when the plastic lenses expand in the vertical direction, and may be 0.2 mm or less, for example, in the range of 0.1 mm to 0.2 mm. This second gap G2 may be the maximum distance that can be expanded when the second barrel 240 and the sixth and seventh lenses 206 and 207 are made of plastic and are thermally expanded in a vertical direction at a high temperature, that is, in a range of 85 degrees to 105 degrees. The vertical direction may be the optical axis direction. The third gap G3 may be larger than the first gap G1 and may be a distance for facilitating the assembly of the second barrel 240. The third gap G3 may be a distance from the middle or bottom of the second barrel 240 to the inner surface 231 of the first barrel 230, and may be less than or equal to the thickness of the second barrel 240, for example, 10% to 50% of the thickness of the second barrel 240. The thickness of the second barrel 240 is a thickness in a horizontal direction at the middle portion.

Referring to FIGS. 27 to 29, the first gap G1 is a distance between the inner diameter of the first barrel 230 and the maximum outer diameter of the second barrel 240, and may be a minimum value in the first and second directions X and Y. The second gap G2 is a distance between the upper height of the second barrel 240 and the lower surface of the flange portion 205A of the fifth lens 205, and may be a maximum separation distance in the optical axis direction. The third gap G3 is a distance between the inner diameter of the first barrel 230 and the lower outer diameter (minimum outer diameter) of the second barrel 240, and may be a separation distance in the first and second axis directions.

The first to third gaps G1, G2, and G3 may be set as follows in the range of room temperature (10 degrees to 40 degrees), high temperature, and low temperature. C1: coefficient of thermal expansion (CTE) of the second barrel made of plastic (PC), C2: coefficient of thermal expansion of the first barrel made of aluminum, T1: tolerance of the second barrel, T2: tolerance of the first barrel, T3: stacking tolerance of the sixth/seventh lens and the fifth lens, D1: outer diameter of the second barrel, i.e., maximum outer diameter, D2: inner diameter of the first barrel, D3: minimum outer diameter of the second barrel, H1: height (Z-axis) of the second barrel, H2: height (Z-axis) of the fifth lens.

The first gap G1 can be initially set at room temperature (25 degrees) as shown in Table 5.

TABLE 5

| Elements | Values (mm) | Elements | Values (mm) |
|---|---|---|---|
| D1 | 15.2 | D2 | 15.4 |
| T1 | 0.01 | T2 | 0.01 |
| C1 | 0.000035 | C2 | 0.000023 |

The first gap G1 can be calculated as shown in Table 6 under the conditions of the following Equations, where the outer diameter change D1′ of the second barrel and the inner diameter change D2′ of the first barrel at high temperature (+ΔT), for example, 85 ° C, are as follows:

TABLE 6

| Equations | Results (mm) |
|---|---|
| D1′ = (D1) + ((D1) × C1 × (+ΔT) | 15.24256 |
| D2′ = (D2) + ((D2) × C2 × (+ΔT) | 15.428336 |
| G1 = {(D2′) − (D1′) − T1 − T2}/2 | 0.0957785 |

In the Equations, the result value of G1 may be greater than 0, and if it is less than 0, a jamming phenomenon may occur between the two barrels. The first gap G1 can be calculated under the conditions of the formula in Table 7 below, such as the change in the outer diameter D1′ of the second barrel and the change in the inner diameter D2′ of the first barrel at a low temperature (−ΔT), for example, −65 °C.

TABLE 7

| Equations | Results (mm) |
|---|---|
| D1′ = (D1) − ((D1) × C1 × (−ΔT) | 15.16542 |
| D2′ = (D2) − ((D2) × C2 × (−ΔT) | 15.376977 |
| G1 = {(D2′) − (D1′) − T1 − T2}/2 | 0.0957785 |

In the Equations, the result value of G1 can be greater than 0, and if it is less than 0, a jamming phenomenon may occur between the two barrels. The second gap G2 can be initially set at room temperature (25 degrees) as shown in Table 8.

TABLE 8

| Elements | Values (mm) | Elements | Values (mm) |
|---|---|---|---|
| H1 | 6.4 | H2 | 6.5 |
| T1 | 0.01 | T2 | 0.01 |
| C1 | 0.000035 | C2 | 0.000023 |

In Table 8, the H2 value is a fixed value, and if it is smaller than the value, it can be fixed by a strong pressure by assembly. The second gap G2 can be calculated as in Table 9 under the conditions of the following Equations, such as the change in height H1′ of the second barrel and the change in height H2′ of the fifth lens at a high temperature (+ΔT), for example, 85 °C

TABLE 9

| Equations | Results (mm) |
|---|---|
| H1′ = (H1) + ((H1) × C1 × (+ΔT) | 6.41792 |
| H2′ = fixed | 6.5 |
| G2 = {(H2′) − (H1′) − T1 − T3} | 0.06208 |

In the Equations, the result value of G2 may be greater than 0, and if it is less than 0, a jamming phenomenon may occur between the second barrel and the fifth lens.

The second gap G2 can be calculated under the conditions of the Equations in Table 10, such as the height change H1′ of the second barrel and the height change H2′ of the fifth lens at low temperature (−ΔT), for example, −65 °C

TABLE 10

| Equations | Results (mm) |
|---|---|
| H1′ = (H1) − ((H1) × C1 × (ΔT) | 6.38544 |
| H2′ = fixed | 6.5 |
| G2 = {(H2′) − (H1′) − T1 − T3} | 0.09456 |

In the Equations, the result value of G2 may be greater than 0, and if it is less than 0, a jamming phenomenon may occur between the second barrel and the fifth lens. The third gap G3 can be initially set at room temperature (25 degrees) as shown in Table 11.

TABLE 11

| Elements | Values (mm) | Elements | Values (mm) |
|---|---|---|---|
| D3 | 14.2 | D2 | 15.4 |
| C1 | 0.000035 | C2 | 0.000023 |

Here, the D3 may be calculated as the sum of the effective diameter of the sixth lens, the effective diameter margin, the length of the flange, and the thickness of the second barrel.

The third gap G3 may be calculated as shown in Table 12 under the conditions of the following Equations, such as the change in the outer diameter of the second barrel D3′ and the change in the inner diameter of the first lens D2′ at a high temperature (+ΔT), for example, 85 °C

TABLE 12

| Equations | Results (mm) |
|---|---|
| D3′ = (D3) + ((D3) × C1 × (+ΔT) | 14.23976 |
| D2′ = (D2) + ((D2) × C2 × (+ΔT) | 15.428336 |
| G2 = {(D2′) − (D1′) − T1 − T2}/2 | 0.594288 |

The third interval G3 may be calculated by the conditions of the formula in Table 13 for the change in the outer diameter D3′ of the second barrel and the change in the inner diameter D2′ of the first lens at a low temperature (−ΔT), for example, −65 °C

TABLE 13

| Equations | Results (mm) |
|---|---|
| D3′ = (D3) − ((D3) × C1 × (−ΔT) | 14.167695 |
| D2′ = (D2) − ((D2) × C2 × (−ΔT) | 15.376977 |
| G2 = {(D2′) − (D1′) − T1 − T2}/2 | 0.604641 |

As described above, considering the inner diameter of the first barrel 230, the inner diameter (maximum, minimum) of the second barrel 240, the coefficient of thermal expansion of each component, the allowable error, etc., the first to third intervals are set as the optical design values at room temperature, high temperature, and low temperature as described above, so that the fifth, sixth, and seventh lenses and the first and second barrels can be coupled to be within the range of the optical design values.

As shown in FIGS. 30(A)-31(D), the second barrel 240 made of plastic is coupled to a lower portion of an inner side of the first barrel 230, and the seventh lens 207 is coupled to a lower portion of an inner side of the second barrel 240 using a pressing jig 701, and then the sixth lens 206 is laminated on the object side of the seventh lens 207 using the pressing jig 701. Thereafter, the fourth and fifth lenses 205, which are cemented lenses, are laminated on the object side of the sixth lens 206 by means of a pressing jig 701, and at this time, the upper portion of the second barrel 240 can guide and couple the perimeter of the support portion 205B (See, FIG. 24) of the fifth lens 205. Thereafter, the third spacer (223) is coupled, and then the third lens 203 is laminated on the fourth lens 204 by means of the pressing jig 701, and then the second spacer 222 is coupled, and then the second lens 202 is laminated on the third lens 203 by means of the pressing jig 701. After that, the first spacer 221 is laminated, and then the first lens 201 is coupled to the object side of the second lens 202, and a cover 250 having an opening 251 on the upper part of the first barrel 230 can be coupled to the outer circumference of the first barrel 230.

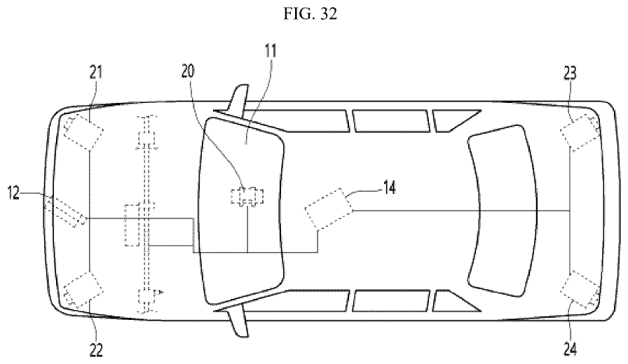

FIG. 32 is an example of a plan view of a vehicle to which a camera module or optical system according to an embodiment of the invention is applied.

Referring to FIG. 32, a vehicle camera system according to an embodiment of the invention includes an image generating unit 11, a first information generating unit 12, a second information generating unit 21, 22, 23, 24, 25, and 26, and a control unit 14. The image generating unit 11 may include at least one camera module 31 disposed in the vehicle, and may capture the front of the vehicle and/or the driver to generate a front image of the vehicle or an interior image of the vehicle. The image generating unit 11 can capture the surroundings of the vehicle in one or more directions as well as the front of the vehicle using the camera module 31 to generate an image of the surroundings of the vehicle. Here, the front image and the surrounding images can be digital images, and can include color images, black and white images, and infrared images. In addition, the front image and the surrounding images can include still images and moving images. The image generating unit 11 provides the driver image, the front image, and the surrounding images to the control unit 14. Next, the first information generating unit 12 can include at least one radar and/or camera arranged in the vehicle, and detects the front of the vehicle to generate first detection information. Specifically, the first information generating unit 12 is arranged in the vehicle, and detects the positions and speeds of vehicles located in front of the vehicle, the presence and positions of pedestrians, and generates first detection information.

By using the first detection information generated by the first information generating unit 12, the distance between the own vehicle and the vehicle in front can be controlled to be maintained constant, and the stability of vehicle operation can be increased in specific preset cases, such as when the driver wants to change the driving lane of the own vehicle or when parking in reverse. The first information generating unit 12 provides the first detection information to the control unit 14. The second information generating unit 21, 22, 23, 24, 25, and 26 detects each side of the own vehicle and generates second detection information based on the front image generated by the image generating unit 11 and the first detection information generated by the first information generating unit 12. Specifically, the second information generating unit 21, 22, 23, 24, 25, and 26 may include at least one radar and/or camera disposed in the own vehicle, and may detect the position and speed of vehicles located on the side of the own vehicle or capture images. Here, the second information generating unit 21, 22, 23, 24, 25, and 26 may be respectively placed at the front two corners, side mirrors, and the rear center and rear two corners of the vehicle.

At least one information generating unit among these vehicle camera systems may be equipped with the optical system and the camera module having the same as described in the above-described embodiment(s), and may provide or process information acquired through the front, rear, each side, or corner region of the vehicle to the user to protect the vehicle and objects from autonomous driving or surrounding safety. The optical system of the camera module according to the embodiment of the invention may be installed in multiple units in the vehicle for safety regulation, reinforcement of autonomous driving function, and increased convenience. In addition, the optical system of the camera module is applied in the vehicle as a component for control such as a lane keeping assistance system (LKAS), a lane departure warning system (LDWS), and a driver monitoring system (DMS). This vehicle camera module can provide a module that can implement stable optical performance even when the ambient temperature changes and is price competitive, thereby ensuring the reliability of vehicle parts.

Features, structures, effects, etc. described in the embodiments above are included in at least one embodiment of the invention, and are not necessarily limited to only one embodiment. Furthermore, the features, structures, and effects illustrated in each embodiment may be combined or modified with respect to other embodiments by those skilled in the art in the field to which the embodiments belong. Therefore, contents related to these combinations and variations should be construed as being included in the scope of the invention. Although described based on the embodiments, this is only an example, this invention is not limited, and it will be apparent to those skilled in the art that various modifications and applications not illustrated above are possible without departing from the essential characteristics of this embodiment. For example, each component specifically shown in the embodiment may be modified and implemented. And the differences related to these modifications and applications should be construed as being included in the scope of the invention as defined in the appended claims.

1. An optical system comprising:
first to seventh lenses aligned along an optical axis from an object side toward a sensor side,
wherein a refractive power of the first lens is negative,
wherein a composite refractive power of the third to seventh lenses is positive,
wherein the first lens has a meniscus shape convex toward the sensor side on the optical axis,
wherein a center thickness of the first lens is greater than a center thickness of each of the second to seventh lenses,
wherein the first to seventh lenses include a plurality of aspherical lenses, and
wherein each of the plurality of aspherical lenses has a meniscus shape convex toward the object side on the optical axis.

2. The optical system of claim 1, wherein an effective diameter of the first lens is greater than effective diameters of the fourth to seventh lenses.

3. The optical system of claim 1, comprising: an aperture stop disposed on a periphery between the second lens and the third lens.

4. The optical system of claim 3, wherein the plurality of aspherical lenses is disposed closer to an image sensor than the aperture stop.

5. The optical system of claim 1, wherein the first to seventh lenses are made of glass,
wherein a number of lenses whose object-side surface and sensor-side surface are spherical is at least twice the number of lenses whose object-side surface and sensor-side surface are aspherical.

6. The optical system of claim 5, wherein the first to fifth lenses are spherical lenses.

7. The optical system of claim 1, wherein a sensor-side surface of the fourth lens and an object-side surface of the fifth lens are bonded.

8. The optical system of claim 1, wherein a center distance between an i-th lens and an i+1 lens is CGi,
wherein a center thickness of the i-th lens is CTi,
wherein a value of CTi/CGi is minimum when i is 2, and
wherein a value of CTi/CGi is maximum when i is 1.

9. The optical system of claim 1, wherein a center thickness of the first lens is CT1,
wherein an optical axis distance from the center of an object-side surface of the first lens to a surface of an image sensor is TTL, and
wherein the following Equation satisfies: 0<CT1/TTL<0.25.

10. The optical system according to claim 1, wherein a center thickness of the first lens is CT1,
wherein a center distance between the second and third lenses is CG2, and
wherein the following Equation satisfies: 2<CT1/CG2<5.

11. A camera module comprising:
an image sensor; and
first to seventh lenses aligned along an optical axis from an object side toward a sensor side;
an aperture stop disposed between spherical lenses of the first to seventh lenses; and
an optical filter disposed between the seventh lens and the image sensor,
wherein the first lens has a meniscus shape convex toward the sensor on the optical axis,
wherein the first and seventh lenses have negative refractive power,
wherein a composite refractive power of the third to seventh lenses is positive,
wherein a cemented lens of the second to seventh lenses is disposed between the aperture stop and the seventh lens and is bonded to each other,
wherein the cemented lens has a convex object-side surface and a concave sensor-side surface on the optical axis,
wherein the first to seventh lenses include a plurality of aspherical lenses,
wherein the plurality of aspherical lenses is disposed closer to the image sensor than is the aperture stop, and
wherein the first to fifth lenses have spherical object-side surfaces and sensor-side surfaces.

12. The camera module of claim 11, wherein the aperture stop is disposed on a periphery between the second lens and the third lens, and
wherein the sixth and seventh lenses have an aspherical object-side surface and a sensor-side surface.

13. A camera module comprising:
a first lens group having a plurality of lenses;
a second lens group having at least one lens;
a first barrel arranged on a periphery of the first lens group;
a second barrel arranged between the first barrel and the second lens group,
wherein the lenses of the first lens group and the lens of the second lens group are aligned in an optical axis,
wherein the first barrel and the second barrel are made of different materials,
wherein a material of the first lens group and a lens material of the second lens group are different from each other, and
wherein the material of the lens of the second lens group is the same material as the material of the second barrel.

14. The camera module of claim 13, wherein the lens material of the second barrel and the second lens group is plastic.

15. The camera module of claim 13, wherein the first barrel is made of aluminum,
wherein the second barrel is made of plastic,
wherein at least two or more lenses disposed on the object side among the lenses arranged inside the first barrel are made of glass, and
wherein the lenses disposed inside the second barrel include two plastic lenses.

16. The camera module of claim 15, comprising a cemented lens disposed between the lenses made of glass and the plastic lenses,
wherein an object-side lens in the cemented lens is spaced apart from an inner surface of the first barrel, and a sensor-side lens is in contact with an inner surface of the second barrel, and
wherein the cemented lens is made of glass.

17. The camera module of claim 11, wherein an effective diameter of the first lens is larger than effective diameters of the fourth to seventh lenses.

18. The camera module of claim 11, wherein the first to seventh lenses are made of glass,
wherein a number of lenses whose object-side surface and sensor-side surface are spherical is at least twice a number of lenses whose object-side surface and sensor-side surface are aspherical.

19. The optical system of claim 11, wherein the first to fifth lenses are spherical lenses.

20. The camera module of claim 11, wherein the cemented lens includes the fourth and fifth lenses, and
wherein the sensor-side surface of the fourth lens and the object-side surface of the fifth lens are bonded.
